(19) United States
(12) Patent Application Publication
(10) Pub. No.: US 2025/0284949 A1
(43) Pub. Date: Sep. 11, 2025

(54) THERMODYNAMIC COMPUTING SYSTEM CONFIGURED TO IMPLEMENT TRANSFORMER BASED ARCHITECTURE

(71) Applicant: Extropic Corp., Austin, TX (US)

(72) Inventors: Christopher Chamberland, Austin, TX (US); Guillaume Verdon-Akzam, San Francisco, CA (US)

(73) Assignee: Extropic Corp., Austin, TX (US)

(21) Appl. No.: 19/068,912

(22) Filed: Mar. 3, 2025

Related U.S. Application Data
(60) Provisional application No. 63/562,565, filed on Mar. 7, 2024.

(51) Int. Cl. G06N 3/065; G06N 3/045; G06N 3/049

(52) U.S. Cl. CPC G06N 3/065; G06N 3/045; G06N 3/049

(57) ABSTRACT

Systems, methods and computer readable media relating to neuro-thermodynamic computers configured to implement one or more components of a transformer neural network architecture, wherein the transformer neural network architecture is configured to perform operations of a transformer neural network. Thermodynamic data may be used as input to one or more thermodynamic chips comprising oscillators, wherein thermodynamic evolution according to one or more energy potentials governing the oscillators enable results of a transformer neural network architecture, or at least intermediate results, to be obtained by respective ones of the oscillators. Furthermore, the results, encoded as thermodynamic data in position degree of freedoms of respective oscillators, of one component may be used as input to another component.

### RELATED APPLICATION

This application claims benefit of priority to U.S. Provisional Application Ser. No. 63/562,565, entitled “Transformer-Based Architectures Using Thermodynamic Computing,” filed Mar. 7, 2024, and which is incorporated herein by reference in its entirety.

### BACKGROUND

### Description of Related Art

Various algorithms, such as machine learning algorithms, often use statistical probabilities to make decisions or to model systems. Some such learning algorithms may use Bayesian statistics, or may use other statistical models that have a theoretical basis in natural phenomena. Also, machine learning algorithms themselves may be implemented using Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

### BRIEF DESCRIPTION OF THE DRAWINGS

FIG. 1 illustrates an encoder block of a transformer neural network that is implemented on one or more thermodynamic chips comprising oscillators, according to some embodiments.

FIG. 2A illustrates an encoder block of a transformer neural network with a multi-head attention layer, wherein the encoder block is implemented on one or more thermodynamic chips comprising oscillators, according to some embodiments.

FIG. 2B illustrates a decoder block of a transformer neural network with a multi-head attention layer, wherein the decoder block is implemented on one or more thermodynamic chips comprising oscillators, according to some embodiments.

FIG. 3A illustrates an analog matrix multiplication gadget implemented on one or more thermodynamic chips comprising oscillators, wherein the matrix and an input vector are encoded by thermodynamic data, according to some embodiments.

FIG. 3B illustrates an analog matrix multiplication gadget implemented on one or

more thermodynamic chips comprising oscillators, wherein an input vector is encoded by thermodynamic data, according to some embodiments.

FIG. 4A illustrates an analog feed forward gadget implemented on one or more thermodynamic chips comprising oscillators, according to some embodiments.

FIG. 4B illustrates the analog feed forward gadget of FIG. 4A, wherein one or more oscillators implementing a linear constraint potential, as part of a feed forward potential, are coupled to input vector oscillators and hidden layer oscillators and thermodynamically evolve, according to some embodiments.

FIG. 4C illustrates the analog feed forward gadget of FIG. 4B, wherein one or more oscillators implementing a non-linear constraint potential, as part of a feed forward potential, are coupled to the hidden layer oscillators and output vector oscillators and thermodynamically evolve, wherein the output vector oscillators thermodynamically obtain an output of a feed forward layer of a transformer neural network, according to some embodiments.

FIG. 5A illustrates an analog dot product gadget implemented on one or more thermodynamic chips comprising oscillators, according to some embodiments.

FIG. 5B illustrates the analog dot product gadget of FIG. 5A, wherein respective ones of the oscillators undergo a first thermodynamic evolution based on one or more potentials of the dot product gadget, according to some embodiments.

FIG. 5C illustrates the analog dot product gadget of FIG. 5B, wherein respective ones of the oscillators undergo a second thermodynamic evolution based on one or more potentials of the dot product gadget, wherein a result of a dot product between two vectors is thermodynamically obtained, according to some embodiments.

FIG. 6 illustrates an analog dot product gadget network implemented on one or more thermodynamic chips comprising oscillators, wherein results of a plurality of dot products are thermodynamically obtained, wherein each dot product share a common input vector with each other, according to some embodiments.

FIG. 7 illustrates an analog masked dot product gadget network implemented on one or more thermodynamic chips comprising oscillators, wherein obtained dot product results of a dot product gadget network are masked using additional oscillators, according to some embodiments.

FIG. 8A is high-level diagram illustrating an energy-based model (EBM) implemented using a thermodynamic chip and an analog sigmoid gadget implemented using a thermodynamic chip, wherein the EBM and analog sigmoid gadget are shown at a first moment in time (e.g. prior to a coupling between oscillators of the sigmoid gadget and oscillators of the EBM), wherein the coupling (performed directly or via relay oscillators) provides input values for a sigmoid function that is performed thermodynamically, according to some embodiments.

FIG. 8B illustrates the EBM and analog sigmoid gadget at a second moment in time, wherein a coupling to thermodynamically transfer an input value to an oscillator of the sigmoid gadget has been performed, according to some embodiments.

FIG. 8C illustrates the EBM and analog sigmoid gadget at a later moment in time, wherein the analog sigmoid gadget has thermodynamically evolved under an engineered potential of the analog sigmoid gadget such that respective oscillators of the analog sigmoid gadget evolve to have a value that encodes the output of the sigmoid function, according to some embodiments.

FIG. 8D illustrates an example configuration wherein a relay oscillator is used to provide an adjustable mass and/or frequency that allows the output oscillator of the EBM to be treated as static when coupled with the analog sigmoid gadget, according to some embodiments.

FIG. 8E illustrates an additional example configuration wherein the output of the EBM is directly coupled to the input of the sigmoid gadget, and wherein a relay gadget is used to receive the result of the sigmoid function, implemented thermodynamically via the analog sigmoid gadget coupled to the EBM, wherein the relay gadget stores an expectation value of the output oscillator of the analog sigmoid gadget, according to some embodiments.

FIG. 8F illustrates another example configuration wherein a relay oscillator is used to provide an adjustable mass and/or frequency that allows the output oscillator of the EBM to be treated as static when coupled with the analog sigmoid gadget, and wherein a relay gadget is used to receive the result of the sigmoid function, implemented thermodynamically via the analog sigmoid gadget coupled to the EBM, wherein the relay gadget stores an expectation value of the respective input/output oscillators of the analog sigmoid gadget, according to some embodiments.

FIG. 8G illustrates another example configuration wherein an additional relay gadget is used to provide one or more adjustable masses and/or frequencies that allow the output oscillator of the EBM to be treated as static when coupled with the analog sigmoid gadget, and wherein a relay gadget is used to receive the result of the sigmoid function, implemented thermodynamically via the analog sigmoid gadget coupled to the EBM, wherein the relay gadget stores an expectation value of the output oscillator of the analog sigmoid gadget, according to some embodiments.

FIG. 9 illustrates an example of an analog sigmoid gadget comprising an input oscillator treated as static and an output oscillator with a dual-well potential, wherein the couplings between the oscillators comprise a two-body coupling, according to some embodiments.

FIG. 10 is a flowchart illustrating a process for implementing a sigmoid function using an analog sigmoid gadget, according to some embodiments.

FIG. 11 illustrates graphs of potentials for a given oscillator, wherein the given oscillator has a dual-well potential. FIG. 11 further illustrates how increasing the coupling strength parameter (e.g., λ₁) in an engineered potential for a gadget causes the walls and intermediate barrier between the two wells of the dual-well potential to be more steep, such that the dual-well oscillator is more likely to evolve to a value of 0 or 1 as required by the engineered potential for the analog gadget, according to some embodiments.

FIG. 12A is high-level diagram illustrating an energy-based model (EBM) implemented using a thermodynamic chip and an analog SoftMax gadget implemented using a thermodynamic chip, wherein the EBM and analog SoftMax gadget are shown at a first moment in time (e.g. prior to a coupling between oscillators of the SoftMax gadget and oscillators of the EBM, wherein the coupling (performed directly or via relay oscillators) provides input values for a SoftMax function that is performed thermodynamically), according to some embodiments.

FIG. 12B illustrates the EBM and analog SoftMax gadget at a second moment in time, wherein the coupling has been performed, according to some embodiments.

FIG. 12C illustrates the EBM and analog SoftMax gadget at a later moment in time, wherein the analog SoftMax gadget, coupled to the EBM, has thermodynamically evolved under an engineered potential of the analog SoftMax gadget such that the oscillators of the analog SoftMax gadget evolve to have values that encode a one-hot vector, which is the output of the SoftMax function when coupled with the output oscillators of the EBM, according to some embodiments.

FIG. 12D illustrates an example configuration wherein relay oscillators are used to provide an adjustable masses and/or frequencies that allow the output oscillators of the EBM to be treated as static when coupled with the analog SoftMax gadget, according to some embodiments.

FIG. 12E illustrates an additional example configuration wherein relay oscillators are used to provide adjustable masses and/or frequencies that allow the output oscillators of the EBM to be treated as static when coupled with the analog SoftMax gadget, and wherein additional relay gadgets are used to receive the result of the SoftMax function, implemented thermodynamically via the analog SoftMax gadget coupled to the EBM, wherein the additional relay gadgets store expectation values of the respective input/output oscillators of the analog SoftMax gadget, according to some embodiments.

FIG. 12F illustrates another example configuration wherein relay gadgets are used to receive the result of the SoftMax function, implemented thermodynamically via the analog SoftMax gadget coupled to the EBM, wherein the relay gadgets capture expectation values of the respective input/output oscillators of the analog SoftMax gadget, according to some embodiments.

FIG. 13A illustrates an example all-to-all coupling that may be used to couple input/output oscillators (¢b;) of the analog SoftMax gadget to one another, according to some embodiments.

FIG. 13B illustrates another example coupling, wherein additional oscillators

$$( {ϕ}_{{a}_{j}^{( l )}} )$$

are used to emulate an an-to-all coupling between input/output oscillators (ϕ_{b}_{ⱼ}) of the analog SoftMax gadget, wherein the input/output oscillators (ϕ_{b}_{ⱼ}) and the additional oscillators

$$( {ϕ}_{{a}_{j}^{( l )}} )$$

have a reduced degree of connectivity as compared to input/output oscillators (ϕ_{b}_{ⱼ}) used in an all-to-all coupling for a similar sized array of input/output oscillators, such as shown in FIG. 13A, according to some embodiments.

FIG. 14 is a flowchart illustrating a process for implementing a SoftMax function using an analog SoftMax gadget, according to some embodiments.

FIG. 15A is high-level diagram illustrating an energy-based model (EBM) implemented using a thermodynamic chip and an analog Swish gadget implemented using a thermodynamic chip, wherein the EBM and analog Swish gadget are shown at a first moment in time (e.g. prior to a coupling between oscillators of the Swish gadget and oscillators of the EBM), wherein the coupling (performed directly or via relay oscillators) provides input values for a Swish function that is performed thermodynamically, according to some embodiments.

FIG. 15B illustrates the EBM and analog Swish gadget at a second moment in time, wherein a coupling to thermodynamically transfer an input value to an oscillator of the Swish gadget has been performed, according to some embodiments.

FIG. 15C illustrates the EBM and analog Swish gadget at a later moment in time, wherein the analog Swish gadget, uncoupled from the EBM, has thermodynamically evolved under an engineered potential of the analog Swish gadget such that respective oscillators of the analog Swish gadget evolve to have a value that encodes the output of the Swish function, according to some embodiments.

FIG. 15D illustrates an example configuration wherein a relay oscillator is used to provide an adjustable mass and/or frequency that allows the output oscillator of the EBM to be treated as static when coupled with the analog Swish gadget, according to some embodiments.

FIG. 15E illustrates an additional example configuration wherein the output of the EBM is directly coupled to the input of the Swish gadget, and wherein a relay gadget is used to receive the result of the Swish function, implemented thermodynamically via the analog Swish gadget coupled to the EBM, wherein the relay gadget stores an expectation value of the output oscillator of the analog Swish gadget, according to some embodiments.

FIG. 15F illustrates another example configuration wherein a relay oscillator is used to provide an adjustable mass and/or frequency that allows the output oscillator of the EBM to be treated as static when coupled with the analog Swish gadget, and wherein a relay gadget is used to receive the result of the Swish function, implemented thermodynamically via the analog Swish gadget coupled to the EBM, wherein the relay gadget stores an expectation value of the respective input/output oscillators of the analog Swish gadget, according to some embodiments.

FIG. 15G illustrates another example configuration wherein an additional relay gadget is used to provide one or more adjustable masses and/or frequencies that allow the output oscillator of the EBM to be treated as static when coupled with the analog Swish gadget, and wherein a relay gadget is used to receive the result of the Swish function, implemented thermodynamically via the analog Swish gadget coupled to the EBM, wherein the relay gadget stores an expectation value of the output oscillator of the analog Swish gadget, according to some embodiments.

FIG. 16 illustrates an example of an analog Swish gadget comprising an input oscillator treated as static, an additional oscillator with a dual-well potential, and an output oscillator with a single-well potential, wherein the couplings between the oscillators comprise a two-body coupling and a three-body coupling, according to some embodiments.

FIG. 17 illustrates another example of an analog Swish gadget comprising an input oscillator treated as static, a first additional oscillator with a dual-well potential, a second additional oscillator with a single-well potential, and an output oscillator with a single-well potential, wherein the couplings between the oscillators comprise a two two-body coupling and a three-body coupling, according to some embodiments.

FIG. 18 is a flowchart illustrating a process for implementing a Swish function using an analog Swish gadget, according to some embodiments.

FIG. 19A illustrates an analog attention gadget implemented on one or more thermodynamic chips comprising oscillators, according to some embodiments.

FIG. 19B illustrates the analog attention gadget of FIG. 19A, wherein respective ones of the oscillators undergo a first thermodynamic evolution based on one or more potentials of the attention gadget, according to some embodiments.

FIG. 19C illustrates the analog attention gadget of FIG. 19B, wherein respective ones of the oscillators undergo a second thermodynamic evolution based on one or more potentials of the attention gadget, wherein a result of an attention layer of a transformer neural network is thermodynamically obtained, according to some embodiments.

FIG. 20 illustrates a self-attention layer architecture of a transformer neural network implemented using one or more thermodynamic chips comprising oscillators, wherein the oscillators thermodynamically evolve according to one or more potentials to obtain an output of a self-attention layer, according to some embodiments.

FIG. 21 illustrates a multi-head attention layer architecture of a transformer neural network implemented using one or more thermodynamic chips comprising oscillators, wherein the oscillators thermodynamically evolve according to one or more potentials to obtain an output of a multi-head attention layer, according to some embodiments.

FIG. 22 illustrates a plot of an example potential used to thermodynamically divide by a variance of input values, according to some embodiments.

FIG. 23 illustrates an analog layer normalization gadget implemented on one or more thermodynamic chips comprising oscillators, according to some embodiments.

FIG. 24A illustrates the analog layer normalization gadget of FIG. 23, wherein respective ones of the oscillators undergo a first thermodynamic evolution, based on one or more potentials of the layer normalization gadget, to obtain a mean value of input oscillator values, according to some embodiments.

FIG. 24B illustrates the analog layer normalization gadget of FIG. 24A, wherein respective ones of the oscillators undergo a second thermodynamic evolution, based on one or more potentials of the layer normalization gadget, to obtain a variance value of input oscillators, according to some embodiments.

FIG. 24C illustrates the analog layer normalization gadget of FIG. 24B, wherein respective ones of the oscillators undergo a third thermodynamic evolution, based on one or more potentials of the layer normalization gadget, to obtain a reciprocal of the variance value of the input oscillators, according to some embodiments.

FIG. 24D illustrates the analog layer normalization gadget of FIG. 24C, wherein respective ones of the oscillators undergo a fourth thermodynamic evolution, based on one or more potentials of the layer normalization gadget, to obtain results of a layer normalization layer of a transformer neural network on output oscillators, according to some embodiments.

FIG. 25 illustrates a plurality of matrix multiplication gadgets thermodynamically obtaining a plurality of matrix multiplication resultant vectors to be provided as input to a dot product gadget network, wherein dot products between one of the plurality of matrix resultant vectors and respective other ones of the plurality of matrix resultant vectors are obtained on output oscillators of the dot product gadget network, according to some embodiments.

FIG. 26 illustrates an add and norm layer of a transformer neural network implemented using one or more thermodynamic chips comprising oscillators, wherein the add and norm layer is performed using output of a multi-head attention layer, according to some embodiments.

FIG. 27 illustrates an encoder block architecture of a transformer neural network implemented using one or more thermodynamic chips comprising oscillators, wherein multiple head attention layers, two add and norm layers and a feed forward layer are utilized, according to some embodiments.

FIG. 28A illustrates additional details of a relay gadget implemented using a thermodynamic chip, wherein the relay gadget is configured to relay thermodynamic information between a first energy-based model (EBM) and a second energy-based model

(EBM), such as an analog Swish gadget, according to some embodiments.

FIG. 28B is a high-level diagram similar to FIG. 28A, wherein the relay gadget does not include a bias oscillator, according to some embodiments.

FIG. 29 is a high-level flowchart illustrating a process of relaying thermodynamic information between an output oscillator, such as of a first energy-based model (EBM), and an input oscillator, such as of an analog Swish gadget, according to some embodiments.

FIG. 30A is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

FIG. 30B is a high-level diagram illustrating a spatial analogue relay gadget, wherein respective ones of relay oscillators of a group of relay oscillators are configured to store respective sample values of an output oscillator, according to some embodiments.

FIG. 30C is a high-level diagram illustrating a temporal analogue relay gadget comprising two relay oscillators, according to some embodiments.

FIG. 30D is a high-level diagram illustrating a series analogue relay gadget, wherein a group of relay oscillators comprises a plurality of relay oscillators arranged in series, according to some embodiments.

FIG. 31A illustrates example couplings between visible neurons of an energy-based model (EBM), according to some embodiments.

FIG. 31B illustrates example couplings between visible neurons and non-visible neurons (e.g., hidden neurons) of an energy-based model (EBM), according to some embodiments.

FIG. 32 is a high-level diagram illustrating a process of determining weights and biases to be used in an energy-based model (EBM), wherein the weights and biases are determined using measurement values for synapse oscillators, according to some embodiments.

FIG. 33 is a high-level diagram illustrating a process of determining weights and biases to be used in an energy-based model (EBM), wherein the weights and biases are computed using a classical computing device, according to some embodiments.

FIG. 34 is high-level diagram illustrating an example neuro-thermodynamic computer comprising a thermodynamic chip (e.g., that implements one or more energy-based models (EBMs), an analog Swish gadget, and a relay gadget) included in a dilution refrigerator and coupled to a classical computing device in an environment external to the dilution refrigerator, according to some embodiments.

FIG. 35 is high-level diagram illustrating an example neuro-thermodynamic computer comprising a thermodynamic chip (e.g., that implements one or more energy-based models (EBMs), an analog Swish gadget, and a relay gadget) included in a dilution refrigerator and coupled to a classical computing device that is also included in the dilution refrigerator, according to some embodiments.

FIG. 36 is high-level diagram illustrating an example neuro-thermodynamic computer comprising one or more thermodynamic chips (e.g., that implement one or more energy-based models (EBMs), an analog Swish gadget, and a relay gadget) coupled to a classical computing device in an environment other than a dilution refrigerator, according to some embodiments.

FIG. 37 is a high-level diagram illustrating oscillators included in a substrate of a thermodynamic chip and a mapping of the oscillators to logical neurons or synapses of the thermodynamic chip, according to some embodiments.

FIG. 38 is an additional high-level diagram illustrating oscillators included in a substrate of a thermodynamic chip mapped to logical neurons, weights, and biases (e.g., synapses) of a neuro-thermodynamic computing system, according to some embodiments.

FIG. 39 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems and an apparatus for performing computer operations using a thermodynamic chip and more specifically to an analog implementation of a transformer neural network (NN). For example, oscillators comprising superconducting elements may be arranged on one or more thermodynamic chips in a configuration that enables the one or more thermodynamic chips to implement operations of a transformer NN. Thermodynamic data may include position, mass, or frequency degree of freedoms of one or more oscillators. For example, tokens of a machine learning task may be embedded into a degree of freedom of one or more oscillators. One or more potentials governing the dynamics of the oscillators may enable the thermodynamic chip to process the thermodynamic input data and provide inference results, training results, or results of other machine learning tasks of a machine learning model. For example, oscillators may be coupled to one another in one or more configurations that correspond to one or more engineered potentials, wherein the coupling and thermodynamic evolution of the oscillators according to the engineered potential implements a transformer NN architecture or at least one or more components of the transformer NN architecture.

In some embodiments, one or more thermodynamic chip may implement one or more components of a transformer NN. For example, a component may comprise one or more engineered potentials, wherein thermodynamic evolution of one or more oscillators according to the one or more engineered potentials may cause an expectation value of a position degree of freedom of one or more oscillators to obtain an output of a layer or operation of a transformer NN. For example, a non-exhaustive list of layers of a transformer NN that may be implemented using one or more thermodynamic chips include input embedding, self-attention, add and layer normalization (e.g., “layer norm”), feed forward, encoder block, decoder block, multi-head attention, and masked multi-head attention. A non-exhaustive list of operations that may be implemented using one or more thermodynamic chips include matrix multiplication, vector dot product, sigmoid function, SoftMax function, Swish function, and other activation functions.

In some embodiments, output thermodynamic data (e.g., analog data) of a given layer of a transformer NN may be used as input thermodynamic data for a next layer of the transformer NN. In some embodiments, output oscillators of the given layer may be directly coupled to input oscillators of the next layer. In some embodiments, one or more relay oscillators or a relay gadget may be placed between the output and input oscillators to transfer (e.g., relay) thermodynamic data (e.g., analog data) between layers of a transformer NN. More generally, an energy based model (EBM) may comprise oscillators that are coupled to each other, wherein the coupling implements one or more engineered potentials. One or more thermodynamic evolutions of the oscillators of the EBM, according to the engineered potentials, enables processing of thermodynamic data of the oscillators. The oscillators may undergo thermodynamic evolution such that, once thermal equilibrium is approximately reached, respective ones of the oscillators may represent a result of an analog function or operation. A layer or another operation of the transformer NN may be an example of an EBM. Furthermore, relay oscillators or relay gadgets may be used to hold the position degree of freedom values of the output oscillators of the other EBM to be approximately static during the thermal evolution of the analog function or operation.

In some embodiments, a transformer NN implemented using thermodynamic chips may comprise the following. A plurality of self-attention layers may form multi-head attention. Thermodynamic data may correspond to embedded tokens which are provided to and received by the multi-head attention layer. The multi-head attention layer may include an analog dot product gadget network, an analog SoftMax gadget, and attention layer gadget, wherein each gadget thermodynamically processes input thermodynamic data according to respective engineered potentials. Thermodynamic output of the attention layers may then undergo an analog add and layer normalization layer. Subsequently, a feed forward layer and another add and layer normalization layer may process the thermodynamic data.

Relay oscillators and relay gadgets communicate thermodynamic information (e.g., data) in an analog manner. This can be contrasted with other approaches to communicate information that involve reading out thermodynamic information, such as using a classical computing device, and then relaying the information in classical form. For example, the ability to relay thermodynamic information directly between components in a neuro-thermodynamic computer (e.g., components/layers of a transformer NN) avoids issues associated with readout to a classical computing device, such as read-out error, loss of information, and/or delays associated with performing readout. Moreover, if the information is to be used by another component of a neuro-thermodynamic computing device, relay of the information in a thermodynamic state avoids other delays such as would be incurred if required to initialize a receiving component to have an initial state corresponding to a state of the thermodynamic information that was read out from another component, wherein the relayed information is not already in a thermodynamic state. In some embodiments, such relay techniques as described herein may be used to relay thermodynamic information between energy-based models (EBMs). Such energy-based models (EBMs) may include trained models that evolve according to Langevin dynamics, and which may be used to generate inferences, such as machine learning (ML) inferences. For example, an ML model used to generate an ML inference may be physically implemented as a trained energy-based model (EBM). For example, an analog SoftMax gadget as described herein may be one such EBM, configured with an engineered potential that implements the SoftMax function. Furthermore, an analog SoftMax gadget may be generalized to a plurality of layers and operations of a transformer NN such as listed above and described further herein.

Multiple types of computations, (e.g., such as input embedding, self-attention, add and layer normalization (e.g., “layer norm”), feed forward, encoder block, decoder block, multi-head attention, and masked multi-head attention, matrix multiplication, vector dot product, sigmoid function, SoftMax function, Swish function, and other activation functions) can be greatly accelerated when implemented on a thermodynamic processor, where the individual components of such models are oscillators implemented on superconducting circuit elements. However, in many applications (e.g., transformer NN), the desired operations need to be performed on circuits with multiple components (with each component performing a particular computation), which can add significant constraints on the selection of parameters for each of the oscillator of the thermodynamic chip. For example, if frequency or mass differentials (or combinations of both) between oscillators are used to cause thermodynamic information flow to move analog information between components in a desired manner, there are a limited number of easily achievable frequency and mass combinations of oscillators. Thus, the complexity of such systems quickly becomes self-limiting due to the inability to achieve thermodynamic information flow when primarily relying on mass and/or frequency differentials between oscillators to guide information flow. For example, in order to achieve thermodynamic information flow, it may be necessary that a value of mass times frequency squared of a sending oscillator is much greater than a corresponding value of mass times frequency squared of a receiving oscillator. As such, having the ability to modularize large circuits, with each modular component responsible for a particular task, such as performing SoftMax operations, is needed for implementing such models using thermodynamic processors. In such a modularized approach, mass and/or frequency differentials can be used within a given model, but a relay gadget can be used to relay information between modules, without a need to consider oscillator parameters of a given module when selecting oscillator parameters of another module. This modularization greatly simplifies the selection of oscillator parameters when designing a transformer NN architecture for example.

In some embodiments, a transformer NN architecture may thermodynamically train, at least in part, a transformer NN. For example, mean field forwards and backwards propagation techniques may be used to train metrics of a transformer NN. In some embodiments, a classical computer may perform one or more operations to train the transformer NN, wherein the transformer NN architecture implemented using one or more thermodynamic chips comprising oscillators may be updated in hardware.

As described herein, a relay gadget provides a solution to controlling thermal information flow without having to rely on varying mass and frequency combinations between components to drive the thermodynamic information flow. For example, a relay gadget includes a relay oscillator that has a controllably adjustable mass and/or frequency that can be used to couple to oscillators belonging to other modules. This allows controlled thermodynamic information flow without having to worry about relative mass and/or frequency sizing between oscillators of the components (e.g., such as oscillators of an input EBM and oscillators of a destination EBM). For example, using a relay oscillator reduces the required constraints on the selection of parameters for oscillators belonging to different modules. The relay oscillator can also be used to obtain samples from various degrees of freedom of an oscillator. Such samples can be used to do Gibbs sampling.

Broadly speaking, classes of algorithms that may benefit from implementation using a thermodynamic chip include those algorithms that involve probabilistic inference. Such probabilistic inferences (which otherwise would be performed using a CPU or GPU) may instead be delegated to the thermodynamic chip for a faster and more energy efficient implementation. At a physical level, the thermodynamic chip harnesses electron fluctuations in superconductors coupled in flux loops to model Langevin dynamics. In some embodiments, architectures such as those described herein may resemble a partial self-learning architecture, wherein classical computing device(s) (e.g., a FPGA, ASIC, etc.) may be relied upon only to perform simple tasks such as summing measured values and performing other non-compute intensive operations in order to implement a learning algorithm.

Note that in some embodiments, electro-magnetic or mechanical (or other suitable) oscillators may be used. A thermodynamic chip may implement neuro-thermodynamic computing and therefore may be said to be neuromorphic. For example, the neurons implemented using the oscillators of the thermodynamic chip may function as neurons of a neural network that has been implemented directly in hardware. Also, the thermodynamic chip is “thermodynamic” because the chip may be operated in the thermodynamic regime, wherein thermodynamic effects cannot be ignored. For example, some thermodynamic chips may be operated within the milli-Kelvin range, and/or at 2, 3, 4, etc. degrees Kelvin. The term thermodynamic chip also indicates that the thermal equilibrium dynamics of the neurons are used to perform computations. In some embodiments, temperatures less than 15 Kelvin may be used. Though other temperatures ranges are also contemplated. For example, some suitable types of oscillators may operate around room temperature. Neuro-thermodynamic computing, in some contexts, may be referred to as analog stochastic computing. In some embodiments, the temperature regime and/or oscillation frequencies used to implement the thermodynamic chip may be engineered to achieve certain statistical results. For example, the temperature, friction (e.g., damping) and/or oscillation frequency as well as masses, may be controlled variables that ensure the oscillators evolve according to a given dynamical model, such as Langevin dynamics. In some embodiments, temperature may be adjusted to control a level of noise introduced into the evolution of the neurons. As yet another example, a thermodynamic chip may be used to model energy models that require a Boltzmann distribution. Also, a thermodynamic chip may be used to solve variational algorithms and perform learning tasks and operations.

In some embodiments, a transformer NN architecture can be implemented on a thermodynamic processor where data is encoded in the state of one or more oscillators consisting of superconducting circuit elements. For example, a self-attention layer gadget may be a component of transformer based NN architectures. Implementation of transformers on thermodynamic processors may enable significantly faster inference and training times by taking advantage of the fast equilibrium times of superconducting elements.

In some embodiments, mean-field forward and backward propagation methods can be used to train a mean-field NN, wherein the output expectation value of one energy based model (EBM) block serves as the input to the next. Furthermore, in some embodiments, such methods may be used to implement a transformer architecture within a mean-field NN framework. For example, EBM potential energy functions may be engineered as well as the neuron couplings for each component of the transformer architecture, ensuring that the output expectation values align with those produced by a transformer block implemented on a classical post-processing device.

For example, some topics discussed herein include the following. Reviewing the key components of transformer NN architectures. Discussing a matrix-multiplication gadget used to obtain a key, query, and value vectors, as well as the implementation of a feed forward layer with EBMs. Introducing the dot product gadget network architecture, which encodes dot products between the key and query vectors into the positional degrees of freedom of oscillators. Introducing an example EBM potential for implementing a sigmoid activation function. Presenting a method to construct a potential that implements a SoftMax function, a component of the self-attention layer. Describing a SoftMax architecture with low-degree connectivity, which may be easier to realize in superconducting hardware. Providing an implementation of the Swish activation function, frequently used in transformer architectures. Demonstrating how the outputs from the dot product gadget network architecture and SoftMax gadget can be combined to compute the required columns of a self-attention matrix. Describing how ancillary oscillators enable efficient layer normalization with minimal measurements. Explaining how skip connections (also known as add layers) are implemented and presenting the complete architecture for the self-attention mechanism.

### Transformer Attention Layers

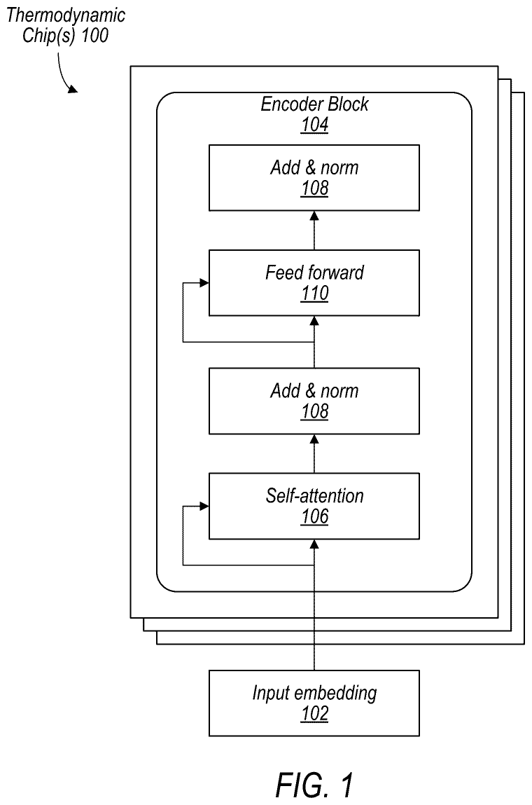

FIG. 1 illustrates an encoder block of a transformer neural network that is implemented on one or more thermodynamic chips comprising oscillators, according to some embodiments.

For example, an attention block, also referred to as an encoder block 104, may be implemented on one or more thermodynamic chip(s) 100. Encoder block 104 may begin with input embedding 102, which can be precomputed in software before clamping input neurons to the data. Next, the self-attention 106 layer is applied, followed by a skip connection that adds the input to the self-attention output. Layer normalization is then performed (e.g., add & norm 108). The resulting output of add & norm 108 is passed through a feed forward 110 network, and another skip connection and a subsequent layer normalization step are applied (e.g., add & norm 108). Each layer may be performed using couplings between oscillators of the thermodynamic chip(s) 100.

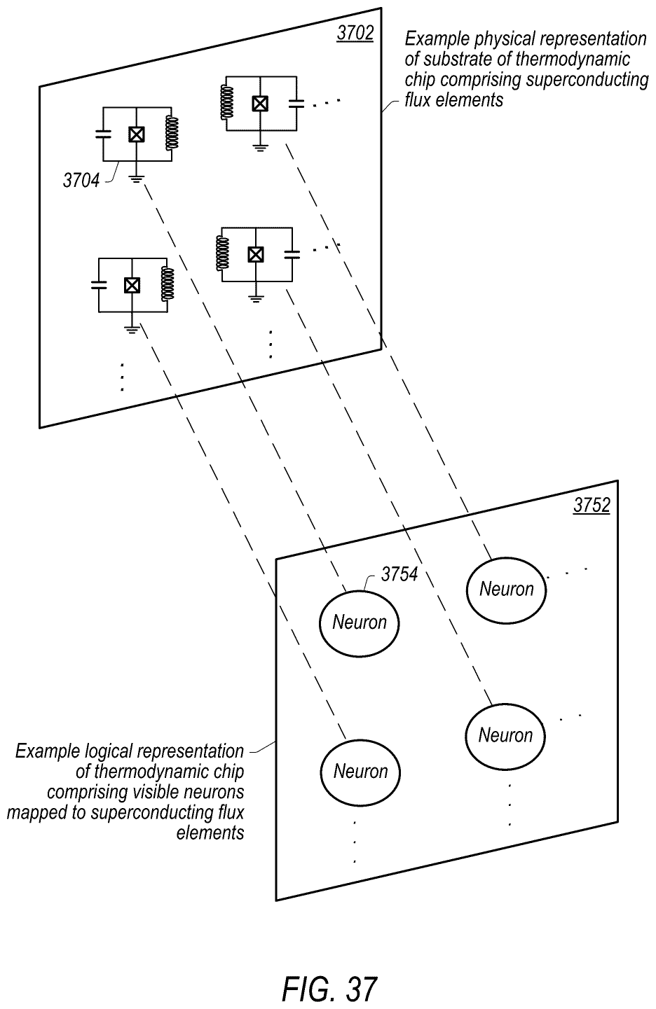

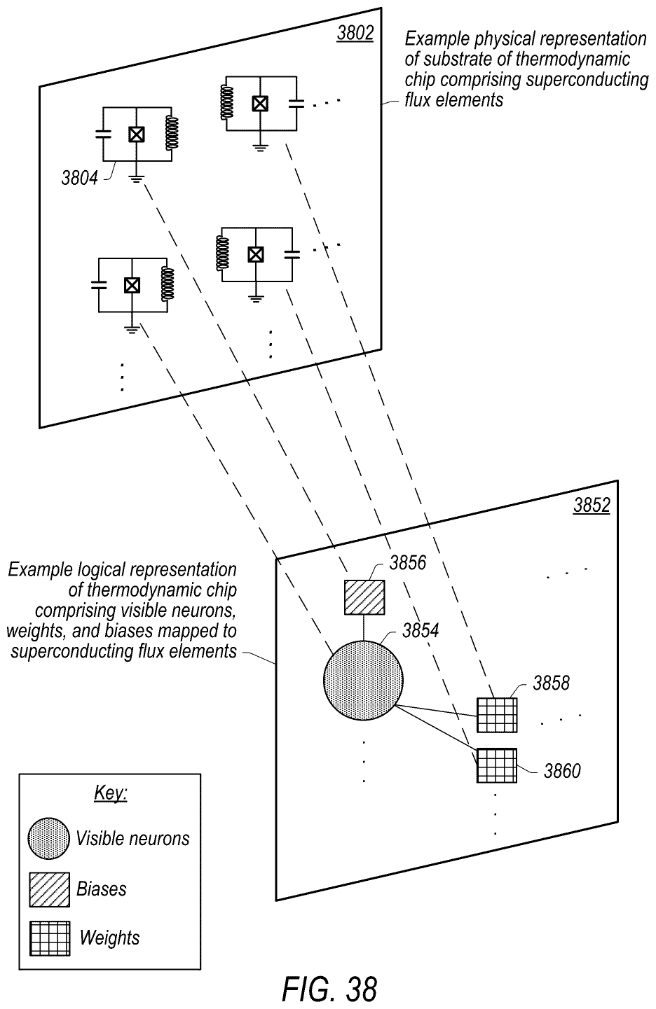

In some embodiments, thermodynamic chip(s) 100 may include oscillators implemented using superconducting flux elements as shown in FIGS. 37-38. For example, physical elements of a thermodynamic chip may be used to physically model evolution according to Langevin dynamics. For example, in some embodiments, a thermodynamic chip includes a substrate comprising oscillators implemented using superconducting flux elements. The oscillators may be mapped to neurons (visible or hidden) that “evolve” according to Langevin dynamics. For example, the oscillators of the thermodynamic chip may be initialized in a particular configuration and allowed to thermodynamically evolve. As the oscillators “evolve,” degrees of freedom of the oscillators may be sampled. Values of these sampled degrees of freedom may represent, for example, vector values for neurons that evolve according to Langevin dynamics.

In some embodiments, a thermodynamic chip(s) 100 includes superconducting flux elements arranged in a substrate, wherein the thermodynamic chip is configured to modify magnetic fields that couple respective ones of the oscillators with other ones of the oscillators. In some embodiments, non-linear (e.g., anharmonic) oscillators are used that have dual-well potentials. These dual-well oscillators may be mapped to neurons of a given model that the thermodynamic chip is being used to implement. Also, in some embodiments, at least some of the oscillators may be harmonic oscillators with single-well potentials. The single-well oscillators may be mapped to non-visible (or hidden) neurons that are not mapped to input variables or output variables, but instead represent other relationships in the model, such as those that are not readily visible. In some embodiments, oscillators may be implemented using superconducting flux elements with varying amounts of non-linearity. In some embodiments, an oscillator may have a single well potential, a dual-well potential, or a potential somewhere in a range between a single-well potential and a dual-well potential. In general, a plurality of shapes of potentials may also be implemented such as a cubic shaped potential. In some embodiments, both visible and non-visible neurons may be mapped to oscillators having a single well potential, a dual-well potential, or a potential somewhere in a range between a single-well potential and a dual-well potential.

Components of a transformer architecture are described below. In some embodiments, a transformer block comprises four main operations: a self-attention 106 layer, a feed forward 110 neural network layer, layer normalization, and skip connections (also known as add layers) (e.g., add & norm 108 layer). One goal of the transformer may be to learn relationships between tokens that represent the input data. These tokens are first converted into embeddings, which transform discrete, symbolic data (e.g., words, image, etc.) into continuous vectors that can be processed by the neural network.

### Self-Attention Mechanism

In some embodiments, each embedding may have a dimension d where d may be any real number like a positive integer. Tokens are fed into the network sequentially, with the presentation time of the t-th token denoted as t, wherein there may be many tokens. The embedding corresponding to the t-th token is represented by the vector xₜ∈ [symbol] . For example, there may be d dimensions used to embed a given token (e.g., string of text or an image). These embeddings can be combined into a single matrix given by

$$X = [ \begin{matrix}\vert & \vert & & \vert \\ {x}_{1} & {x}_{2} & ⋯ & {x}_{N} \\ \vert & \vert & & \vert\end{matrix} ] ∈ {R}^{d \times N} \qquad ( eq . 1 )$$

The next step is to convert each vector in eq. 1 to a key, query and value vector via the parameter matrices W_{K}, W_{Q}∈ [symbol] and W_{V}∈ [symbol] . D is the internal size of the attention operation, and the parameters of the matrices W_{K}, W_{Q} and W_{V} are learned during training. The key, value, and query vectors are respectfully represented by

$${k}_{t} = {W}_{K} {x}_{t} , \qquad ( eq . 2 )$$

$${v}_{t} = {W}_{V} {x}_{t} , \qquad ( eq . 3 )$$

$${q}_{t} = {W}_{Q {x}_{t}} \qquad ( eq . 4 )$$

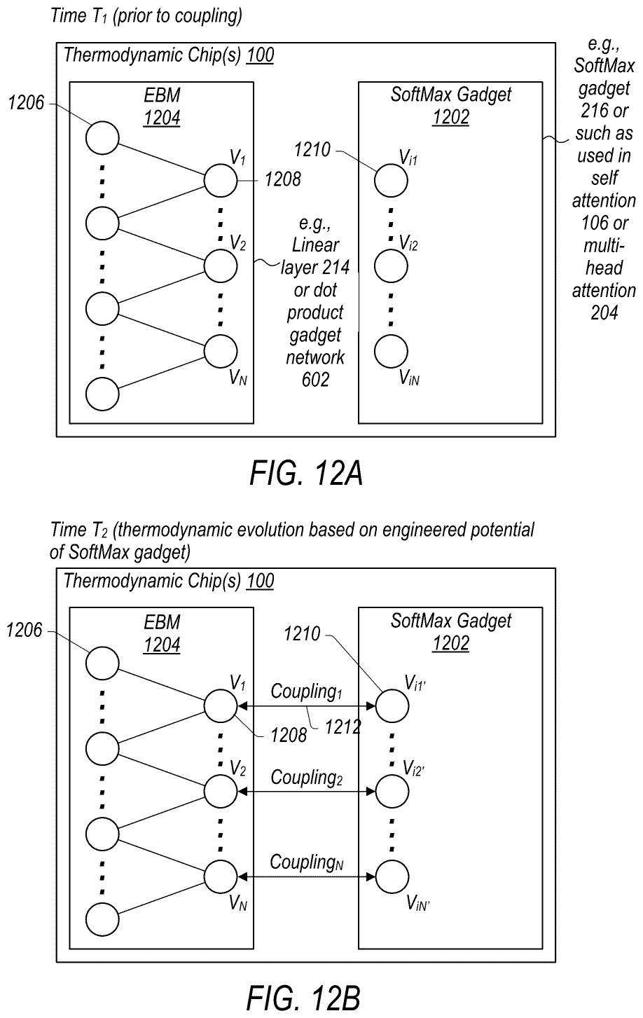

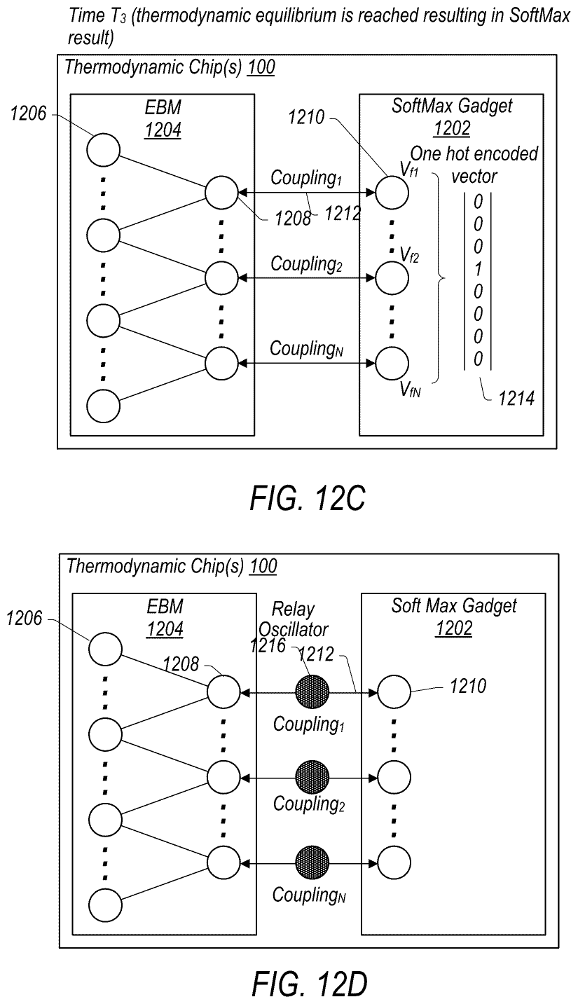

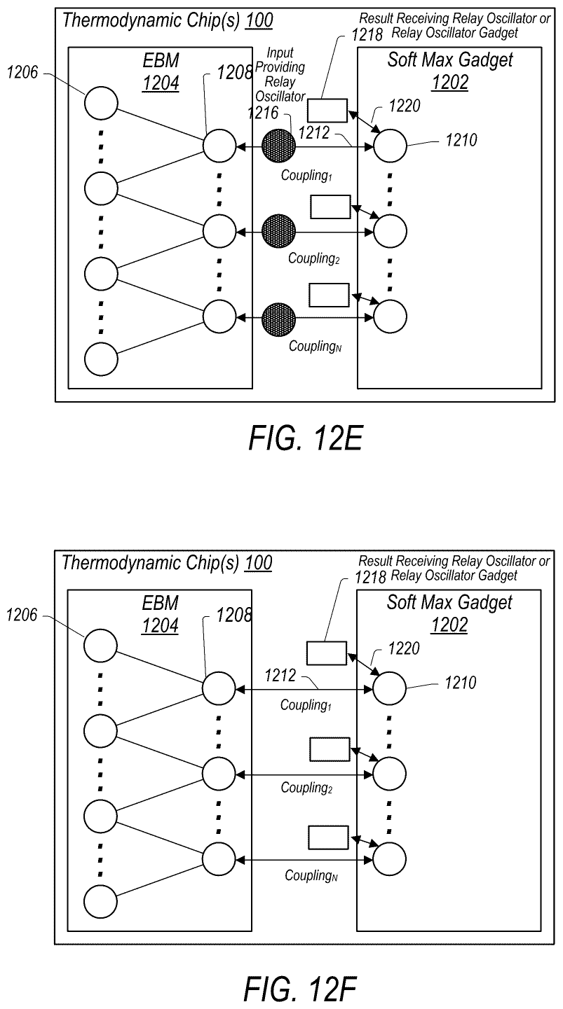

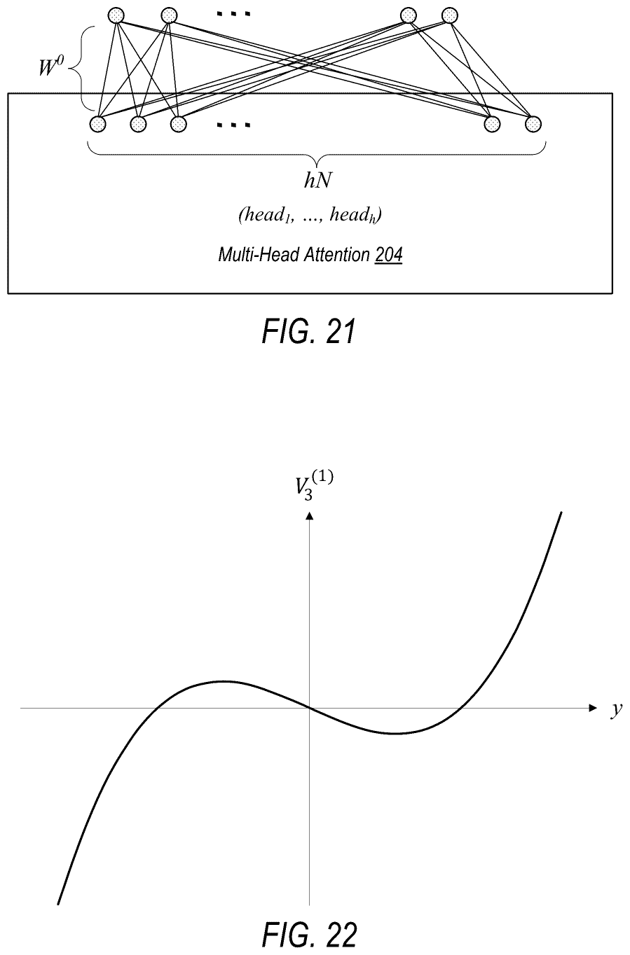

The next step is to perform the self-attention operation (e.g., self-attention 106). See FIGS. 20-21 for more details on implementing self-attention 106 using oscillators. Such an operation allows the exchange of information between the tokens. The self-attention matrix SelfAttn(X) may be a d×N matrix which contains information about all the pairwise interactions between tokens. A component of the self-attention matrix is the SoftMax function. FIGS. 12-14 discuss implementing a SoftMax function thermodynamically. The t-th column of the self-attention matrix by attn(t) may be written as

$$attn ( t ) = {\sum }_{i = 1}^{N} {α}_{i} ( t ) {v}_{i} \qquad ( eq . 5 )$$

$${α}_{i} ( t ) = \frac{{e}^{{k}_{i}^{T {q}_{t}}}}{{\sum }_{j = 1}^{N} {e}^{{k}_{j}^{T {q}_{t}}}} . \qquad ( eq . 6 )$$

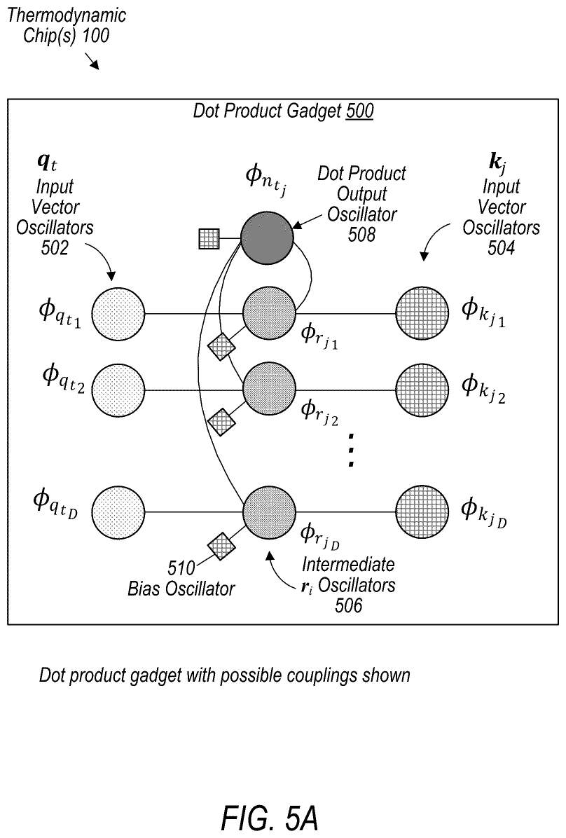

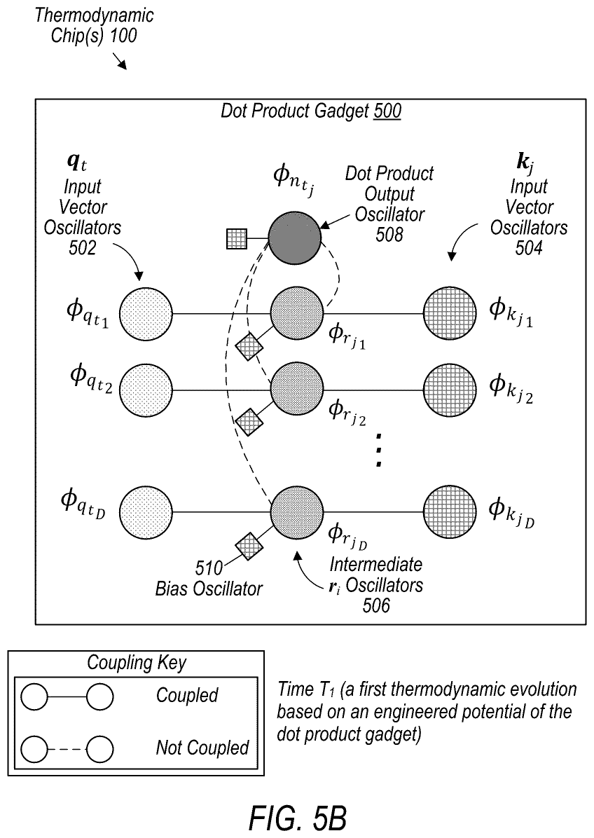

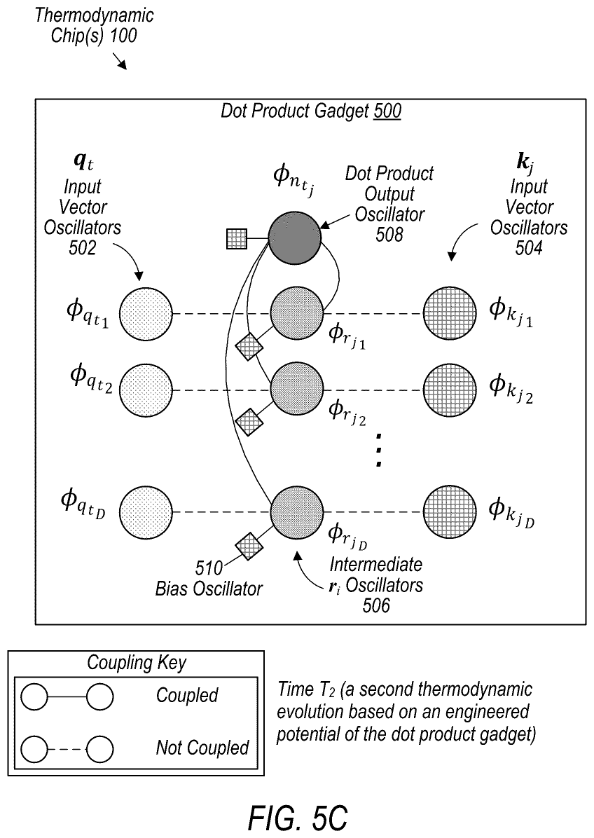

Using eq. 6, SelfAttn(X) may be written as

$$SelfAttn ( X ) = V Softmax ( \frac{{K}^{T} Q}{\sqrt{D}} ) , \qquad ( eq . 7 )$$

where the SoftMax normalization may be performed along each column of K^{T} Q and the superscript T indicates a transposition. Note that in eq. 7, a scaled self-attention is performed by dividing the dot product terms in the SoftMax by \sqrt{D}. Adding the scaling factor can help prevent the dot products from getting large values in magnitude which can result in very small gradients. See FIGS. 5-7, 12-14, and 19A-C for additional details on implementing such components thermodynamically.

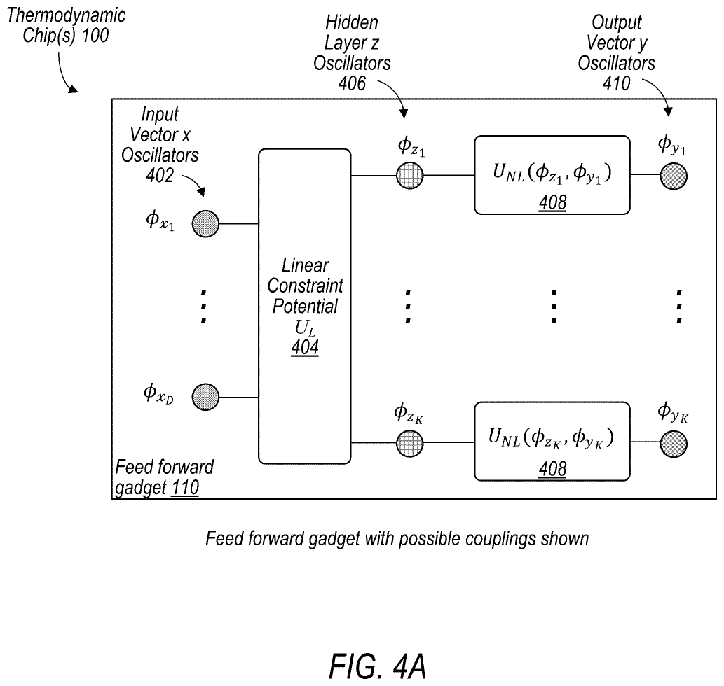

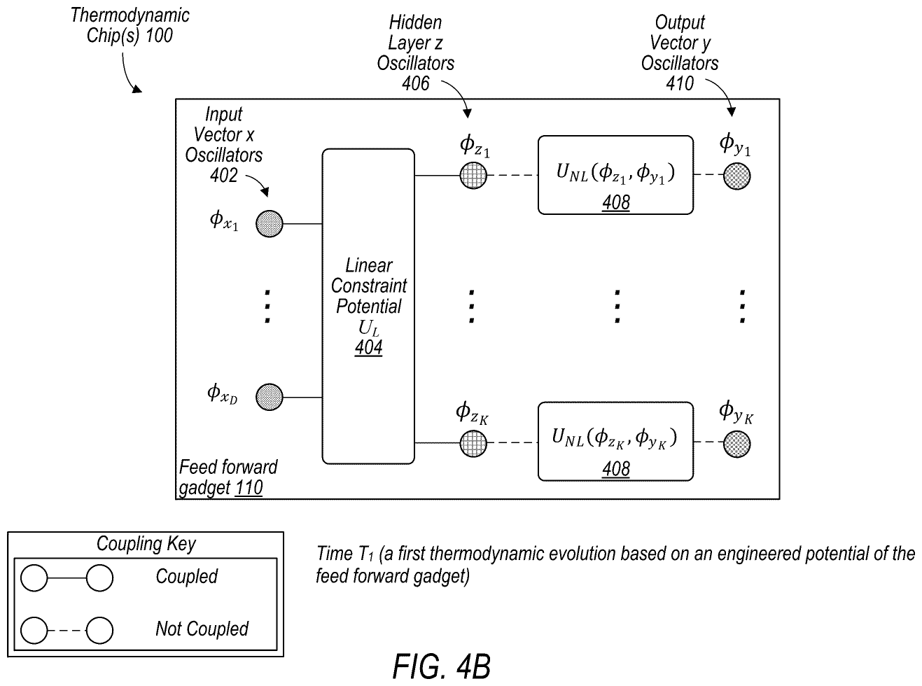

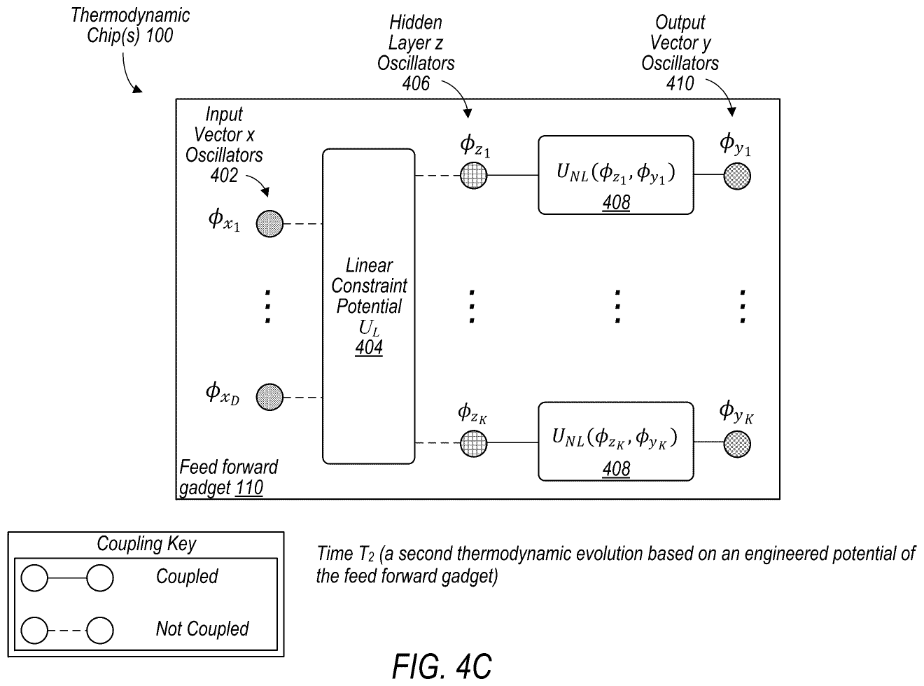

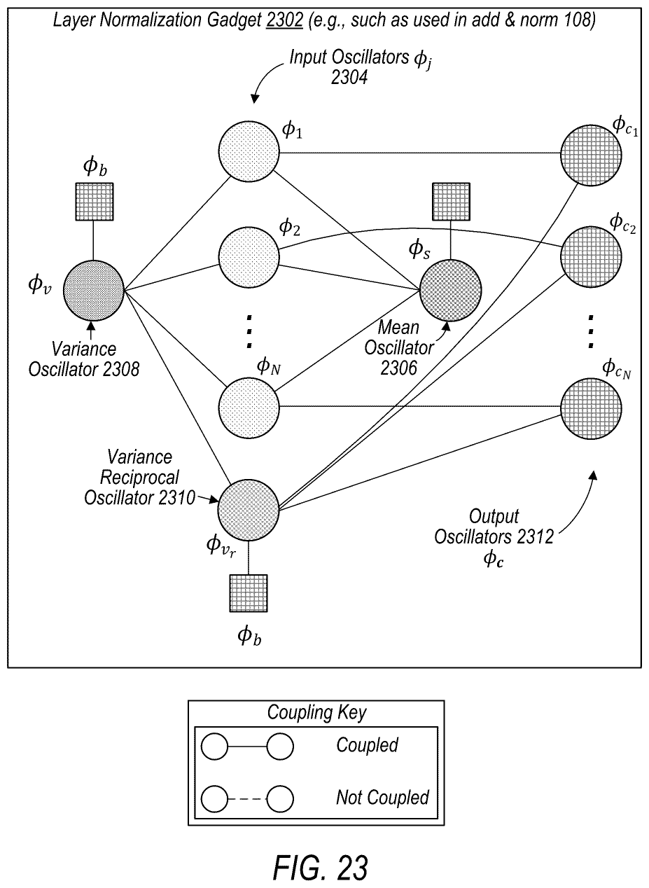

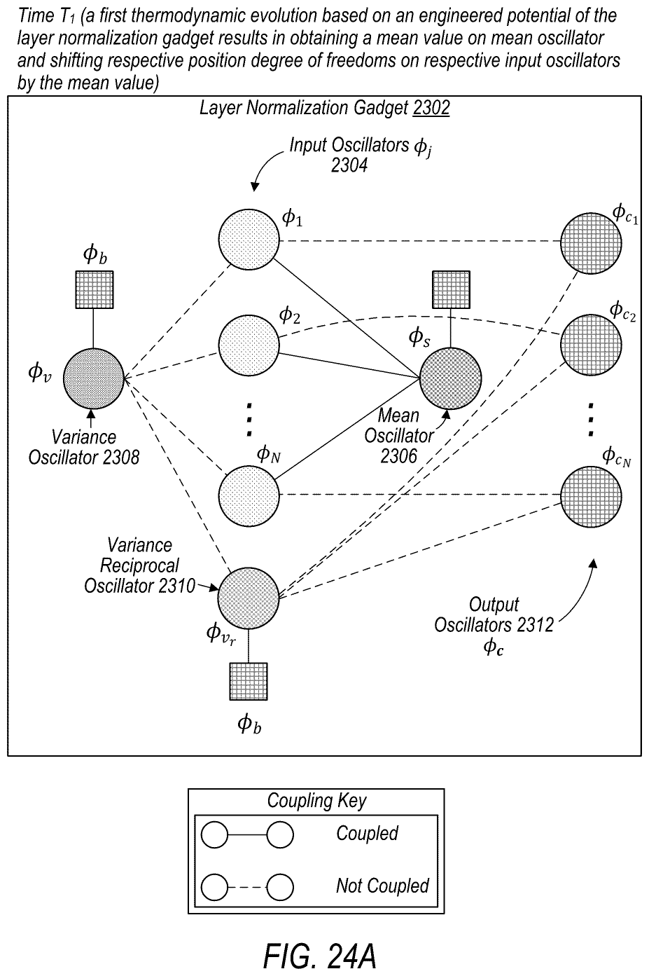

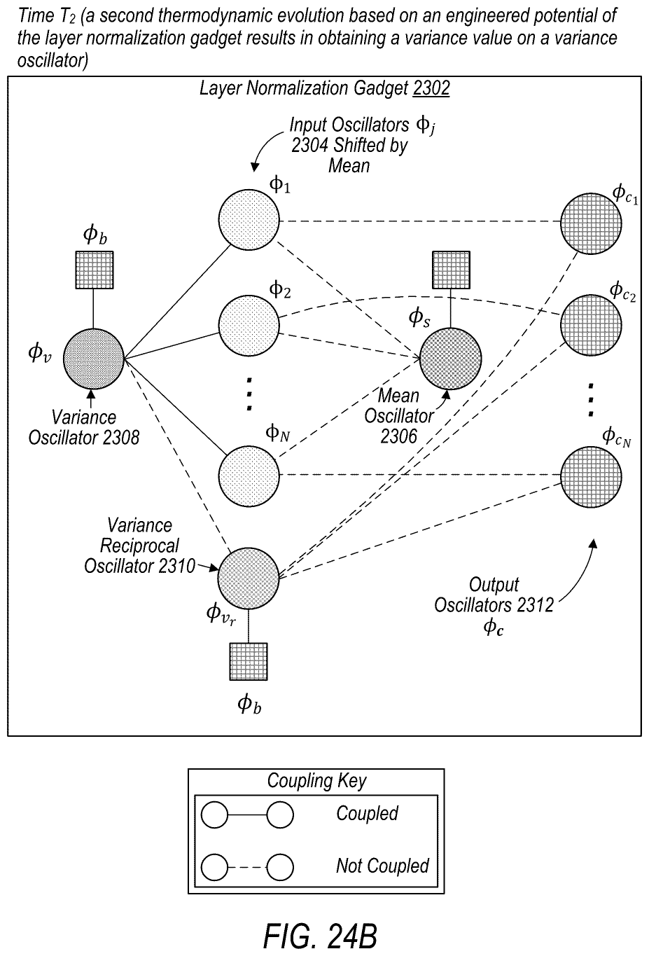

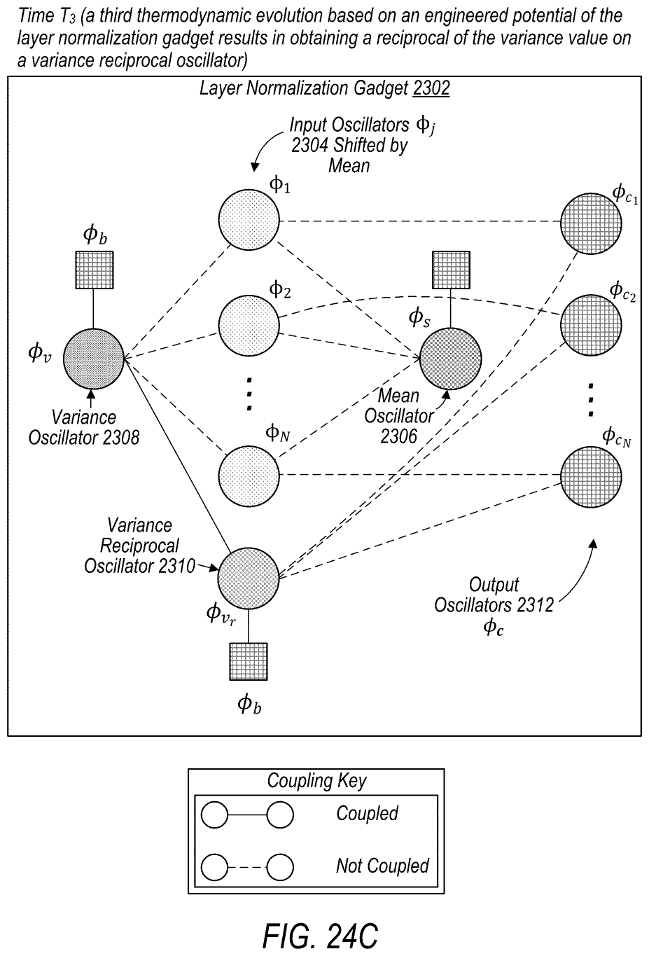

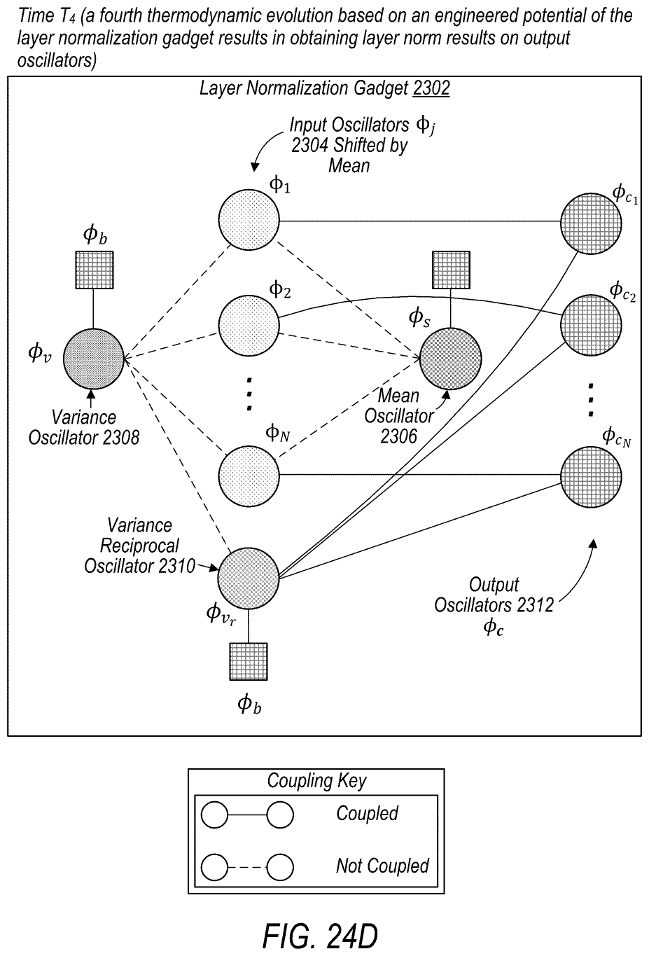

The next step is to add the vectors xₜ to the vectors in SelfAttn(X) via skip connections. Afterwords, the LayerNorm step is performed, which scales each token by its mean and variance. See FIGS. 23-24D for more details on a thermodynamic implementation of layer normalization. Lastly, each embedded token is then passed to a feed forward neural network (FFN). See FIGS. 4A-C for more details on a thermodynamic implementation of the feed forward layer.

### Multi-Head Attention

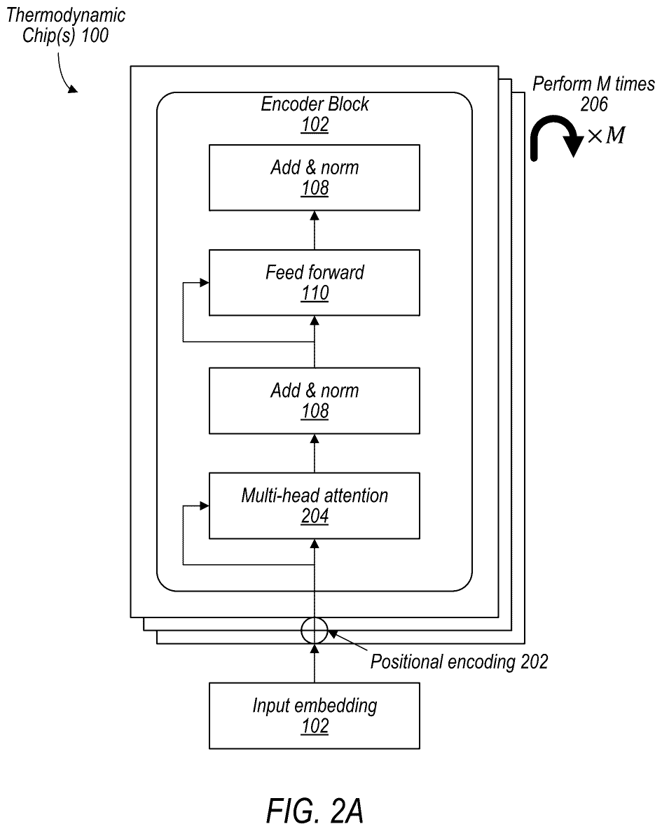

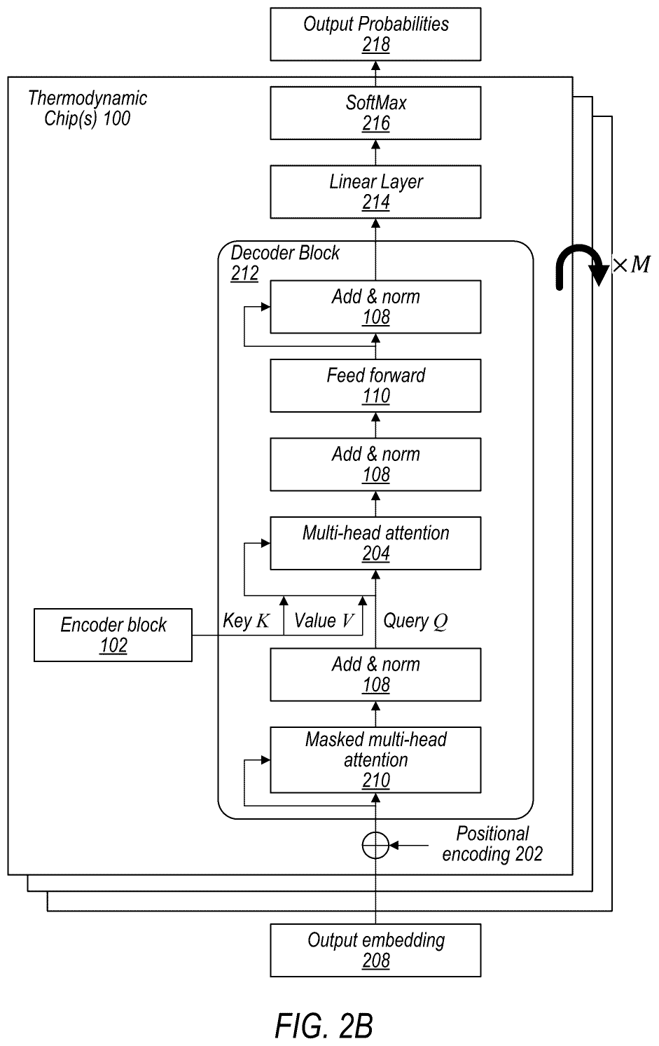

For some embodiments, the multi-head attention mechanism is described below, wherein the multi-head mechanism extends the self-attention mechanism by performing it h times in parallel (wherein h may represent an integer number). See FIGS. 2A-B, 21, and 26-27 for more details on a thermodynamic implementation of multi-head attention 204. The outputs of these h self-attention operations are then concatenated to form the final result.

For example, a given head may be defined by

$${head}_{i} ( X ) = {V}_{i} Softmax ( \frac{{K}_{i}^{T} {Q}_{i}}{\sqrt{D}} ) , \qquad ( eq . 8 )$$

where the columns of the Vᵢ, Kᵢ and Qᵢ matrices are given by

$${k}_{t}^{( i )} = {W}_{K}^{( i )} {x}_{t} , \qquad ( eq . 9 )$$

$${v}_{t}^{( i )} = {W}_{V}^{( i )} {x}_{t} , \qquad ( eq . 10 )$$

$${q}_{t}^{( i )} = {W}_{Q}^{( i )} {x}_{t} . \qquad ( eq . 11 )$$

In other words, head; has its own set of parameter matrices W_{K}⁽ⁱ⁾, W_{V}⁽ⁱ⁾ and W_{Q}⁽ⁱ⁾, and performs the SelfAttn computation in eq. 7. Given a total of h heads, the multi-head attention may be given by

$$multiHead ( X ) = {W}^{O} Concat ( {head}_{1} ( X ) , ⋯ , {head}_{h} ( X ) ) , \qquad ( eq . 12 )$$

where Concat outputs a matrix where the t'th column of the matrix is obtained by concatenating the t'th columns of each of the h heads. The output is then multiplied by another parameter matrix W^{O}∈ [symbol] .

FIG. 2A illustrates an encoder block of a transformer neural network with a multi-head attention layer, wherein the encoder block is implemented on one or more thermodynamic chips comprising oscillators, according to some embodiments.

In some embodiments, an encoder block in a transformer architecture includes a multi-head attention 204 mechanism, followed by a skip connection and layer normalization (add & norm 108 layer). The output is then passed through a feed forward 110 network, followed by another skip connection and layer normalization (add & norm 108). The encoder block 102 may be repeated repeated M times, with each repetition using an independent set of weights. Initially, raw input tokens are converted into vectors via an embedding layer and combined with fixed positional encoding 202 vectors (non-learnable parameters in this work). For subsequent repetitions, the output of the previous encoder block 102 serves as the input to the next.

FIG. 2B illustrates a decoder block of a transformer neural network with a multi-head attention layer, wherein the decoder block is implemented on one or more thermodynamic chips comprising oscillators, according to some embodiments.

In some embodiments, a decoder block 212 begins with a masked multi-head attention 210 layer during training to ensure it only attends to tokens that have already been seen. The query (Q) matrix for the second multi-head attention 204 layer is obtained from the output of the masked self-attention 210 layer, while the key (K) and value (V) matrices are derived from output of an encoder block 102. Similar to the encoder block 102, the decoder block 212 is repeated M times, with each repetition using an independent set of weights. The final output of the decoder block is passed through a linear 214 layer and a SoftMax 216 function to compute output probabilities 218.

### Add and Norm

After obtaining the Self-Attention matrix (e.g., output of self-attention 106 layer), the next operation performed in a transformer block is the add and norm layer. The add layer consists of adding the input embedding vectors to the outputs of the Self-Attention layer. Afterwords, a layer normalization step may be performed. See FIGS. 23-24C for a thermodynamic implementation of layer normalization. Consider an add and norm layer applied to a vector x of size N. The layer norm step performs the following operation

$${x}_{i} \to \frac{{x}_{i} - μ}{\sqrt{{σ}^{2} + ϵ}} , \qquad ( eq . 13 )$$

for all components (e.g., each component i) of the vector x. In eq. 13, ϵ is a small positive constant to avoid division by zero, and a mean and variance are respectively

$$μ = \frac{1}{N} {\sum }_{j = 1}^{N} {bx}_{j} , \qquad ( eq . 14 )$$

$$and$$

$${σ}^{2} = \frac{1}{N} {\sum }_{j = 1}^{N} {( {x}_{j} - μ )}^{2} . \qquad ( eq . 15 )$$

In layer normalization, each component of the input vector x is first centered by subtracting the mean and then scaled by dividing by the square root of the variance plus a small constant to prevent division by zero. This technique is used in deep learning to stabilize training by ensuring that activations within a layer remain within a manageable range, preventing excessively large gradient steps during backpropagation. As a result, the activations are normalized to have a small range centered around zero.

### Encoder Block

Example embodiments of encoder block 102, which includes a multi-head attention 204 mechanism, is illustrated in FIG. 2A Positional encoding 202 vectors are added to the input embedding vectors to incorporate information about the relative or absolute positions of tokens in the input sequence. In other embodiments, various approaches exist for constructing positional encodings, including learnable parameters.

In a transformer architecture, the encoder block 102 is typically repeated M times. The output of each encoder block serves as the input to the next, with each repetition using a new set of weights for the multi-head attention and feedforward layers.

### Decoder Block

Example embodiments of a decoder block 212 consists of two multi-head attention mechanisms and a feedforward layer. The first multi-head attention block employs masked self-attention during training (e.g., masked multi-head attention 210). Masking ensures that the model does not use information from future tokens that have not yet been seen. This is achieved by adding a masking matrix Mₐ, where the columns corresponding to seen tokens are set to zero, and all other columns are assigned −∞. The masked self-attention operation is given by

$$MaskedSelfAttn ( X ) = VSoftmax ( \frac{{K}^{T} Q}{\sqrt{D}} + {M}_{a} ) . \qquad ( eq . 16 )$$

The output of the first masked self-attention block is then used to compute the query (Q) matrix for the second multi-head attention block. The key (K) and value (V) matrices for the second attention block may be obtained from the output of the encoder block.

In some embodiments, similar to the encoder block, the decoder block is repeated M times. After the M-th iteration, the output of the feedforward layer is passed to a linear layer, which computes y=Wx+b where x is the input vector, and W and b are the weight and bias parameters respectively. Finally, the output of the linear layer is fed into a Softmax gadget 216 to produce probabilities. An illustration of the decoder block is provided in FIG. 2B.

### Matrix Multiplication Gadget and Feed Forward Network

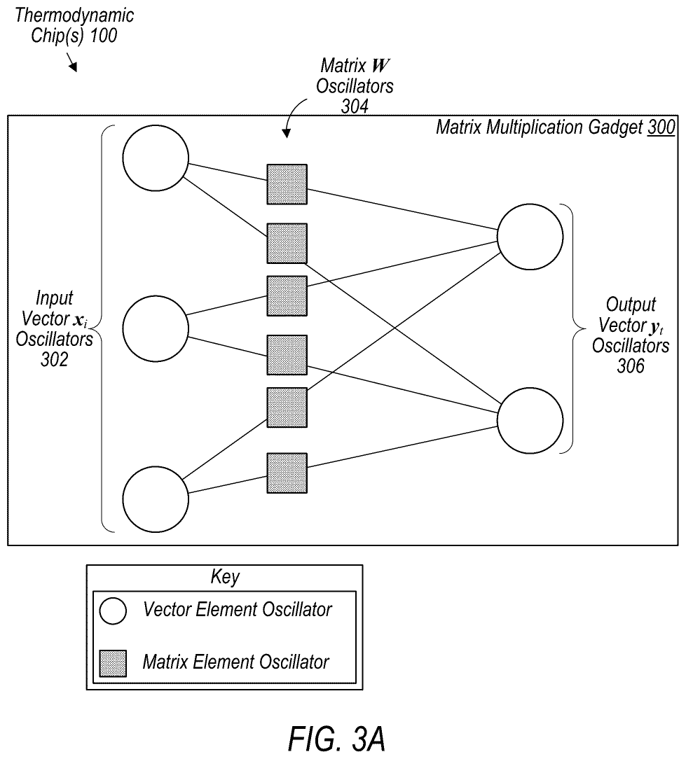

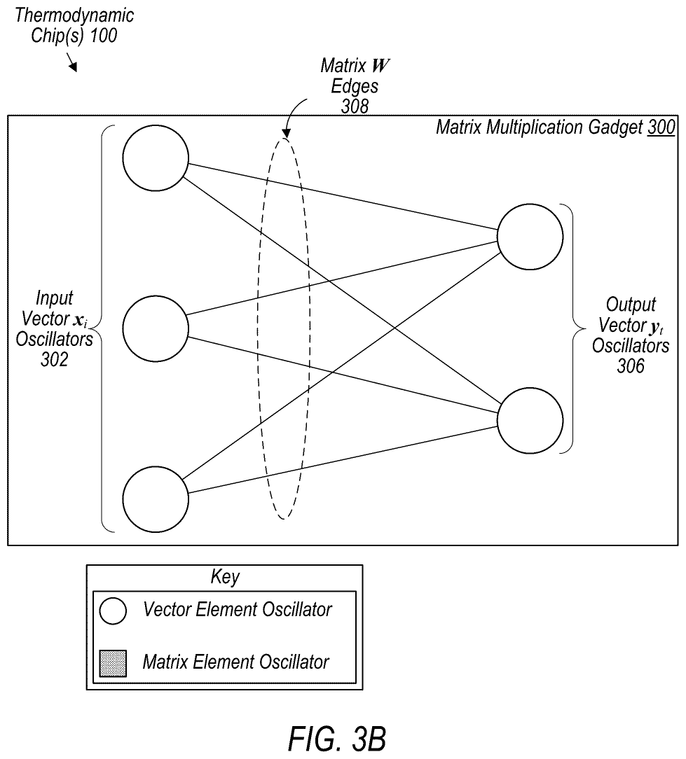

FIG. 3A illustrates an analog matrix multiplication gadget implemented on one or more thermodynamic chips comprising oscillators, wherein the matrix and an input vector are encoded by thermodynamic data, according to some embodiments.

An example embodiment of architecture for the Matrix Vector Product (MVP) gadget (also known as matrix multiplication gadget) is provided in FIG. 3A. Matrix multiplication gadget 300 may be implemented using one or more thermodynamic chip(s) 100. Nodes in the first layer (e.g., input vector xₜ oscillators 302) are represented by oscillators clamped to the desired input vector xₜ. The nodes in the last layer (e.g., output vector yₜ oscillators 306) are also represented by oscillators. The edges representing the couplings between the input 302 and output 306 nodes can also be represented by matrix W oscillators 304 which are clamped to the relevant matrix elements of W, where W is the matrix used to compute a matrix vector product y=Wx. The matrix elements may also be updated in software, resulting in a two-body coupling (see FIG. 3B) potential instead of a three-body coupling (see FIG. 3A) potential. For the case where oscillators are used to represent the edges, such oscillators 304 may be represented by squares. After reaching equilibrium, the expectation value of the oscillators in the output layer (e.g., output vector yₜ oscillators 306) will correspond to the vector yₜ.

### Matrix Multiplication Gadget

In some embodiments, a component of a transformer neural network architecture may comprise a matrix multiplication gadget. The matrix multiplication gadget may comprise a set of oscillators of thermodynamic chips configured to perform matrix multiplication. Such oscillators may comprise input vector component oscillators 302, matrix component oscillators 304 (nevertheless, some embodiments may not have matrix components represented as oscillators, wherein matrix components are implemented in hardware), and output vector component oscillators 302. To perform the matrix multiplication, the set of oscillators may be configured to obtain thermodynamic data on the input vector component oscillators 302 and perform one or more couplings of respective ones of the input vector component oscillators 302 with respective ones of the output vector component oscillators 306. Such a coupling may implement an engineered potential, wherein the engineered potential thermodynamically implements the matrix multiplication. Then one or more thermodynamic evolutions based on the engineered potential may be performed. The one or more thermodynamic evolutions based on the engineered potential may causes the output vector component oscillators 306 to obtain results of the matrix multiplication encoded as thermodynamic data based on the thermodynamic data provided to the input vector component oscillators 302. More details such as examples of the engineered potential are given below.

In some embodiments, matrix multiplications are used in transformer networks. The following presents a matrix vector product (MVP) architecture to perform matrix multiplications (e.g., used to perform matrix multiplication in eq. 2, eq. 4, and eq. 12). Furthermore, it is shown how a feed forward 110 network can be implemented, which is required by an encoder block 104 as can be seen in FIG. 1.

Consider the computation aₜ=Wxₜ. Since the oscillators 302 for the input layer and matrix W (oscillators 304) are clamped, a potential energy function for all of the oscillators 306 in the output layer may be written as

$$V = {\sum }_{j} \frac{1}{2} {m}_{j} {ω}_{j}^{2} {ϕ}_{j}^{2} + {\sum }_{j} {λ}_{j} {\sum }_{k ∈ {ℰ}_{j}} {W}_{k j} {x}_{t}^{k} {ϕ}_{j} , \qquad ( eq . 17 )$$

where ϕⱼ corresponds to the position degrees of freedom of the j'th oscillator with mass mⱼ and frequency ωⱼ in the output layer (oscillators 306). Thus, one term of an engineered potential may correspond to a potential energies of output oscillators and another term may indicate couplings of the output oscillators to respective thermodynamic data. The oscillators 302 in the input layer, as well as the weight matrix oscillators 304 (if oscillators are used for the matrix elements) may be treated as constants since they are clamped to elements of xₜ and W. In eq. 17, εⱼ represents the set of all edges incident to the j'th oscillator in the output layer. Lastly, λⱼ corresponds to the coupling coefficient which controls the strength of the coupling terms. An illustration of the coupling described by eq. 17 is shown in FIG. 3A.

At thermal equilibrium, the expectation value for ϕⱼ (e.g., oscillators 306) may be written as

$$\begin{matrix}{〈 {ϕ}_{j} 〉}_{eq} = \frac{\int d {ϕ}_{j} {ϕ}_{j} {e}^{- β V}}{\int d {ϕ}_{j} {e}^{- β V}} \\ = - \frac{{λ}_{j}}{{m}_{j} {ω}_{j}^{2}} {\sum }_{k ∈ {ℰ}_{j}} {W}_{kj} {x}_{t}^{k} ,\end{matrix} \qquad ( eq . 18 )$$

where in eq. 18, the potential V is taken from eq. 17. From eq. 18, and by setting λⱼ=−mⱼ², wⱼ², [symbol] ϕⱼ [symbol] _{eq}=Σ_{k∈ε}_{ⱼ}Wₖⱼxₜ^{k} which is exactly the result of the j'th element of the vector aₜ=Wxₜ. For example, the coupling strength may be chosen so that respective elements of the MVP may be stored in expectation values of respective oscillators 306. Thus, at thermal equilibrium, components of a resultant vector of matrix multiplication may be obtained on output oscillators 306 using matrix multiplication gadget 300.

For the case where the inputs xₜ^{k} are treated as oscillators

$${ϕ}_{{x}_{t}^{k}}$$

which are clamped to xₜ^{k}, the potential energy function can be written as

$$V = {\sum }_{j} \frac{1}{2} {m}_{j} {ω}_{j}^{2} {ϕ}_{j}^{2} + {\sum }_{k} \frac{1}{2} {m}_{x} {{ω}_{x}^{2} ( {ϕ}_{{x}_{t}^{k}} - {x}_{t}^{k} )}^{2} + {\sum }_{j} {λ}_{j} {\sum }_{k ∈ {ℰ}_{j}} {W}_{kj} {ϕ}_{{x}_{t}^{k}} {ϕ}_{j} . \qquad ( eq . 19 )$$

In this case, the expectation value of a given oscillator may be

$${〈 {ϕ}_{j} 〉}_{eq} = - \frac{{m}_{x} {ω}_{x}^{2} {λ}_{j} {\sum }_{k ∈ {ℰ}_{j}} {W}_{kj} {x}_{t}^{k}}{{m}_{j} {ω}_{j}^{2} {m}_{x} {ω}_{x}^{2} - {λ}_{j}^{2} {\sum }_{k ∈ {ℰ}_{j}} {W}_{kj}^{2}} . \qquad ( eq . 20 )$$

In the limit where mⱼωⱼ²mₓωₓ²>>λⱼ²Σ_{k∈ε}_{ⱼ}Wₖⱼ², eq. 20 may be reduced to

$${〈 {ϕ}_{j} 〉}_{eq} \approx - \frac{{λ}_{j}}{{m}_{j} {ω}_{j}^{2}} {\sum }_{k ∈ {ℰ}_{j}} {W}_{kj} {x}_{t}^{k} , \qquad ( eq . 21 )$$

which is identical to eq. 18. Setting λⱼ=−mⱼωⱼ², it may be chosen that

$${m}_{x} {ω}_{x}^{2} >> {m}_{j} {ω}_{j}^{2} {\sum }_{k ∈ {ℰ}_{j}} {W}_{kj}^{2} , \qquad ( eq . 22 )$$

which is consistent with the condition that the oscillators

$${ϕ}_{{x}_{t}^{k}}$$

are clamped to xₜ. For example, in some embodiments, a potential energy function (e.g., eq. 19) governing oscillators on a thermodynamic chip and respective coupling strengths between oscillators (e.g., see above) may both be engineered such that the expectation value of respective output oscillators correspond to respective components of the MVP. For example, input oscillators may correspond (e.g., be clamped) to input values of a given input vector, respective matrix component oscillators may correspond (e.g., be clamped) to respective matrix values of a given matrix, wherein respective output oscillators corresponding to respective MVP components are coupled with other oscillators (e.g., input oscillators or matrix component oscillators or both) such that the thermodynamic evolution of the system results in the expectation values of output oscillators corresponding to components of the MVP of the given input vector and the given matrix. Furthermore, strengths of the coupling parameters may correspond to a product of mass and frequency squared of respective output oscillators. For example, each output oscillator may have a same product of mass and frequency squared or each output oscillator may have a different product of mass and frequency squared. Furthermore, the product of mass and frequency squared of the input oscillator may be much larger than the product of mass, frequency squared, and the sum of corresponding matrix components squared.

FIG. 3B illustrates an analog matrix multiplication gadget implemented on one or more thermodynamic chips comprising oscillators, wherein an input vector is encoded by thermodynamic data, according to some embodiments.

In some embodiments, matrix elements may be encoded in matrix edges 308 instead of oscillators. This may reduce the number of oscillators needed to implement the matrix multiplication gadget 300.

### Feed Forward Gadget

FIG. 4A illustrates an analog feed forward gadget implemented on one or more thermodynamic chips comprising oscillators, according to some embodiments.

In some embodiments, a feed forward 110 gadget may comprise input oscillators 402, linear constraint potential 404, one hidden layer 406, non-linear constraint potential 408 and output vector oscillators 410, wherein the feed forward 110 gadget is implemented on thermodynamic chip(s) 100. The linear constraint potential 404 U_{L} may be used to minimize a linear constraint such as the linear constraint in eq. 24. Next, the nonlinear constraint potential 408 U_{NL} (an example of which is given in eq. 26) may be applied element-wise to each output oscillator 406 of U_{L} to implement the constraint imposed by the non-linear function ƒ. For example, each oscillator 406 may couple to the non-linear constraint potential one by one or in parallel. In some embodiments, only a linear constraint potential 404 may be utilized, wherein a non-linear constraint potential 408 is not enforced.

In some embodiments, a feed forward 110 gadget may obtain input thermodynamic data onto input vector oscillators 402. Oscillators 402 may be part of the feed forward 110 gadget or oscillators of a linear constraint potential 404 may be coupled to output oscillators of a previous layer or relay oscillators or relay gadget to obtain the input thermodynamic data. Such thermodynamic data may represent an input vector to the feed forward 110 layer. In general, the input thermodynamic data may be used as input to a linear constraint potential 404, wherein oscillators may thermodynamically evolve according to the linear constraint potential 404 to obtain analog results of the linear constraint on one or more oscillators (e.g., such as hidden oscillators 406). See FIG. 4B. A number of thermodynamic data instances resulting from the linear constraint may be larger than, smaller than or the same as a number of thermodynamic data instances used as input to the linear constraint potential. In some embodiments, the resultant thermodynamic data may be used as input to another EBM or layer of a transformer NN. In other embodiments, a non-linear constraint potential may further process thermodynamic data. See FIG. 4C. For example, one or more oscillators of a non-linear constraint potential may couple to hidden layer oscillators 406 and output vector oscillators 410, wherein the oscillators thermodynamically evolve according to engineered potentials. Such an engineered potential may implement a non-linear constraint element wise to thermodynamic data provided by each hidden layer oscillator. A result of the operation may be encoded in position degree of freedoms for respective output oscillators 410.

For a given input x (e.g., an input with one or more dimensions), a feed forward network with a single hidden layer may perform a computation of the form y=ƒ(z) with z=Ax+b and ƒ is a function that is applied element-wise to z. Below describes an example embodiment of a gadget that conditionally samples from y conditioned on the input X.

For a deterministic function y=ƒ(x), a distance ε(x, y)=D(y, ƒ(x)) may be minimized and Gibbs states may be defined as

$$p ( x , y ) = \frac{1}{Z} {e}^{- ℰ ( x , y )} . \qquad ( eq . 23 )$$

For the feed forward network, the distance for the linear constraint may be defined as

$$D = {( z - A x - b )}^{T} ( z - A x - b ) . \qquad ( eq . 24 )$$

A potential energy function whose minima corresponds to the minima of D can be chosen as

$${U}_{L} ( {ϕ}_{x} , {ϕ}_{z} ) = \frac{1}{2} {ϕ}_{x}^{T} {M}_{in} {ϕ}_{x} + \frac{1}{2} {ϕ}_{z}^{T} {M}_{out} {ϕ}_{z} + {ϕ}_{z}^{T} {M}_{c} {ϕ}_{x} + {ϕ}_{x}^{T} {ϕ}_{{b}_{in}} + {ϕ}_{z}^{T} {ϕ}_{{b}_{out}} , \qquad ( eq . 25 )$$

where ϕₓ and ϕ_{z} denote position degrees of freedom of oscillators which encode the vectors x and z. Parameters for Mᵢₙ, Mₒᵤₜ, M_{c}, bᵢₙ and bₒᵤₜ may be chosen to fit eq. 24. The bias terms involve bias oscillators (e.g., ϕ_{b}) which are coupled to the input and output oscillators x and z (e.g., oscillators ϕₓ, and ϕ_{z}). Sampling from the input or output spaces can then be achieved by clamping the input or output oscillators and sampling from a potential such as the potential defined in eq. 25.

Depending on the non-linear function ƒ, a potential may be chosen that implements the non-linearity. For example, one non-linear function which is natural to implement in hardware is

$${U}_{NL} ( {ϕ}_{{y}_{i}} , {ϕ}_{{z}_{i}} ) = g {ϕ}_{{y}_{i}} {ϕ}_{{z}_{i}} + L ( {ϕ}_{{y}_{i}}^{2} + 2 ρ cos {ϕ}_{{y}_{i}} ) , \qquad ( eq . 26 )$$

which acts element-wise to each component of the vectors y and z. Other potentials may be used to implement different choices for the function ƒ.

The total potential for the feed forward layer is then

$${U}_{T} ( {ϕ}_{x} , {ϕ}_{z} , {ϕ}_{y} ) = {U}_{L} ( {ϕ}_{x} , {ϕ}_{z} ) + {\sum }_{i = 1}^{D} {U}_{NL} ( {ϕ}_{{y}_{i}} , {ϕ}_{{z}_{i}} ) . \qquad ( eq . 27 )$$

An illustration of the circuit is shown in FIGS. 4A-C.

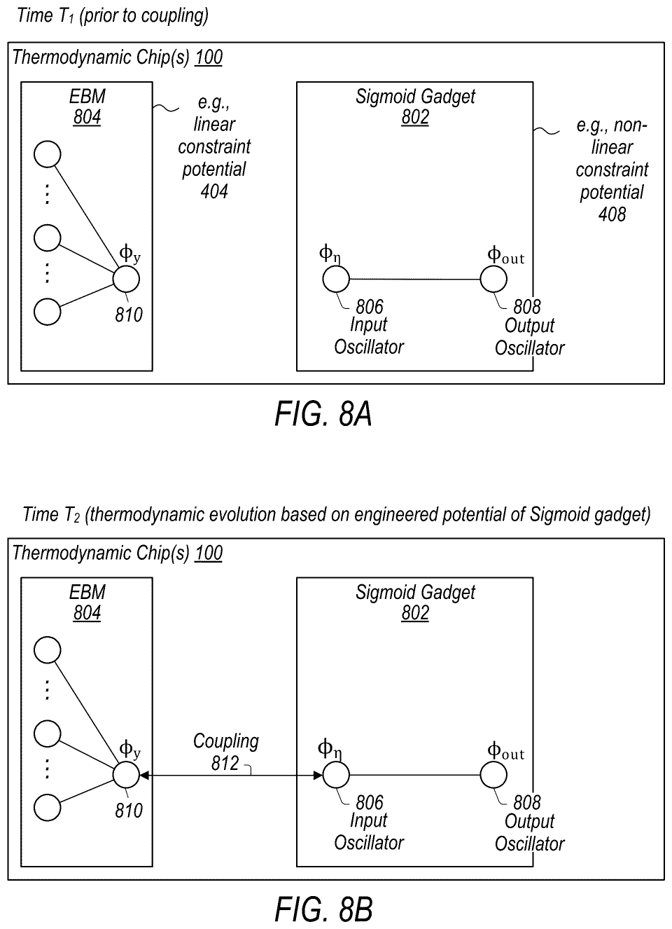

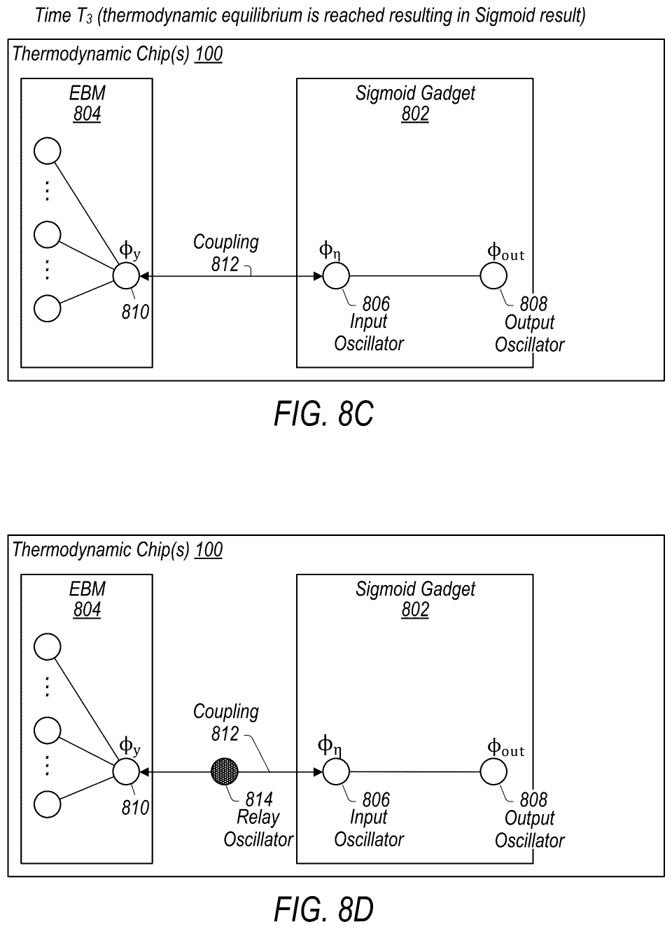

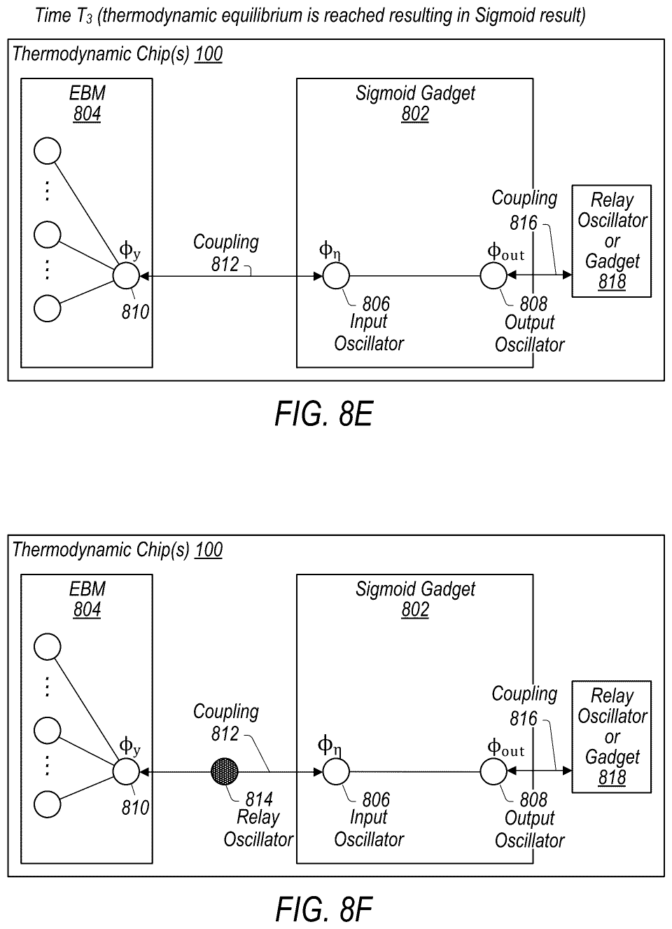

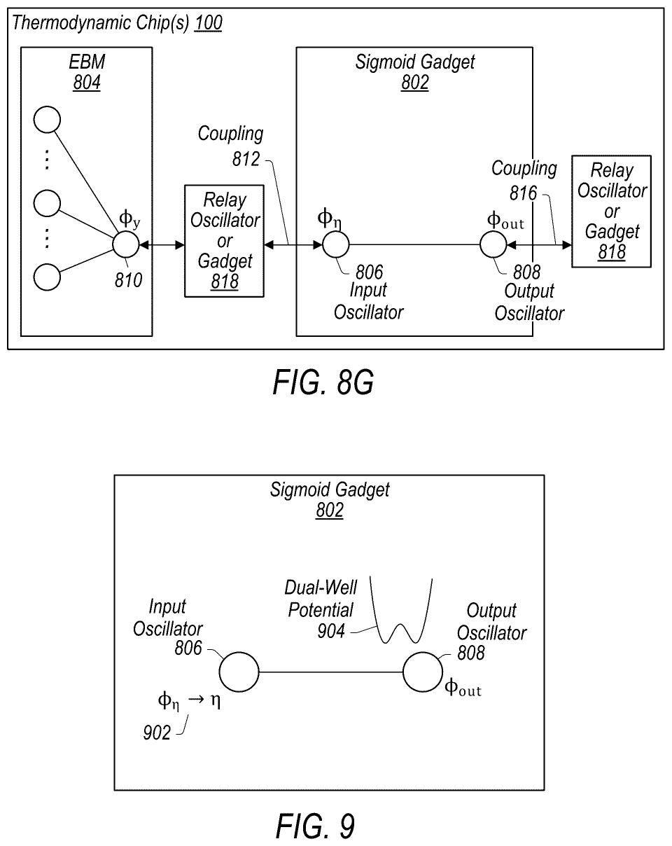

An example for the potential U_{NL} which implements the sigmoid activation function is described in FIGS. 8A-11.

FIG. 4B illustrates the analog feed forward gadget of FIG. 4A, wherein one or more oscillators implementing a linear constraint potential, as part of a feed forward potential, are coupled to input vector oscillators and hidden layer oscillators and thermodynamically evolve, according to some embodiments.

FIG. 4C illustrates the analog feed forward gadget of FIG. 4B, wherein one or more oscillators implementing a non-linear constraint potential, as part of a feed forward potential, are coupled to the hidden layer oscillators and output vector oscillators and thermodynamically evolve, wherein the output vector oscillators thermodynamically obtain an output of a feed forward layer of a transformer neural network, according to some embodiments.

### Dot Product Gadget Network Architecture

Below introduces an architecture, for some embodiments, for performing all relevant dot products required in a multi-head attention layer, for example computing kᵢ^{T}qₜ for αᵢ(t) in eq. 6. As in some embodiments, what is described below demonstrates how dot products can be calculated using systems of oscillators, and below describes the dot product gadget network architecture, which efficiently computes all dot products needed for the Self-Attention layer in eq. 7. By using multiple instances of the gadgets presented here, a complete multi-head attention layer can be constructed. Additionally, below explains how the Dot product gadget network can be adapted to implement a masked multi-head attention layer.

Forming a Dot Product from Coupled Oscillators

FIG. 5A illustrates an analog dot product gadget implemented on one or more thermodynamic chips comprising oscillators, according to some embodiments.

In some embodiments, components of a transformer neural network architecture comprise a dot product gadget 500. The dot product gadget 500 may comprise a set of oscillators of one or more thermodynamic chips configured to perform a dot product. The set of oscillators may include vector component oscillators (e.g., oscillators 502), additional vector component oscillators (e.g., oscillators 504), intermediate oscillators 506, and an output oscillator 508. To perform the dot product, the set of oscillators may be configured to obtain thermodynamic data, corresponding to a vector, on the vector component oscillators 502 and obtain additional thermodynamic data, corresponding to another vector, on the additional vector component oscillators 504. Then, the oscillators may couple to each other to implement an engineered potential, wherein the engineered potential thermodynamically implements the dot product between the vector component oscillators 502 and the other set of vector component oscillators 504. For example, the oscillators may thermodynamically evolve based on the engineered potential, wherein the thermodynamic evolution based on the engineered potential causes the output oscillator 508 to obtain a result of the dot product based on the thermodynamic data provided to the vector component oscillators and the additional thermodynamic data provided to the other vector component oscillators.

For example, input vector oscillators 502 and input vector oscillators 504 may each obtain thermodynamic data that corresponds to respective vectors. Coupling oscillators of corresponding components of the vectors to an intermediate oscillator may enable the intermediate oscillator to thermodynamically obtain a multiplication of the two vector component values such as in an intermediate step in computing a dot product. See

FIG. 5B. Subsequently, once all products are obtained on respective intermediate oscillators for each component, the intermediate oscillators 506 may couple to a dot product output oscillator 508 and thermodynamically evolve according to an engineered potential, wherein, once thermal equilibrium is reached, the dot product output oscillator 508 may obtain the resulting value of a dot product between the two vectors. See FIG. 5C.

The resulting value may be encoded as a positional degree of freedom of the dot product output oscillator. Optionally, bias oscillators, such as bias oscillator 510, may be used to stabilize corresponding intermediate oscillators 506.

In some embodiments, dot product gadget 500 may be used to obtain the dot product kⱼ^{T}qₜ. The vector kⱼ is encoded by the position degrees of freedom

$${ϕ}_{{k}_{{j}_{1}}} to {ϕ}_{{k}_{{j}_{D}}}$$

of input vector oscillators 504. Similarly, the vector qₜ is encoded by the position degrees of freedom

$${ϕ}_{{q}_{{t}_{1}}} to {ϕ}_{{q}_{{t}_{D}}}$$

of input vector oscillators 502. The dot product can be transferred to the position degree of freedom of the oscillator ϕ_{ηt}_{ⱼ} (e.g., dot product output oscillator 508) by generating a coupling of the form λ_{d}(ϕ_{ηt}_{ⱼ}−αΣᵢ₌₁^{D}ϕᵣ_{ᵢ})² where ϕᵣ_{ᵢ} is a set of intermediate oscillators that are coupled as

$${{λ}_{r} ( {ϕ}_{{r}_{i}} - α {ϕ}_{{q}_{{t}_{i}}} {ϕ}_{{k}_{{j}_{i}}} )}^{2} .$$

Optional bias oscillators 510 (represented by squares) may be used in an estimator oscillator (EO) (also referred to as relay oscillator) protocol.

In some embodiments, in order to obtain an attention head using coupled oscillators, a gadget that generates the dot product between the vectors kⱼ^{T}qₜ is implemented. In doing so, the values of the kⱼ vector are encoded in the position degrees of freedom

$${ϕ}_{{k}_{{j}_{i}}}$$

and the values of the qₜ vector are encoded in the position degrees of freedom

$${ϕ}_{{q}_{{t}_{i}}} .$$

Then the dot product value may be encoded into the position degree of freedom of the oscillator

$${ϕ}_{{η}_{{t}_{j}}} .$$

In some embodiments, a Hamiltonian describing the coupling between an estimator oscillator (EO) (also referred to as relay oscillators

$${ϕ}_{{k}_{{j}_{i}}} and {ϕ}_{{q}_{{t}_{i}}}$$

for each i∈{1, . . . , D} is utilized. For example, a Hamiltonian may be engineered to be

$${H}_{{r}_{i}} = \frac{{π}_{{r}_{i}}^{2}}{2 {m}_{r}} + \frac{{π}_{b}^{2}}{2 {m}_{b}} + \frac{{π}_{{q}_{{t}_{i}}}^{2}}{2 {m}_{q}} + \frac{{π}_{{k}_{{j}_{i}}}^{2}}{2 {m}_{k}} + \frac{1}{2} {m}_{r} {ω}_{r}^{2} {ϕ}_{{r}_{i}}^{2} + \frac{1}{2} {m}_{b} {ω}_{b}^{2} {ϕ}_{b}^{2} + \frac{1}{2} {m}_{q} {{ω}_{q}^{2} ( {ϕ}_{{q}_{{t}_{i}}} - {q}_{{t}_{i}} )}^{2} + \frac{1}{2} {m}_{k} {{ω}_{k}^{2} ( {ϕ}_{{k}_{{j}_{i}}} - {k}_{{j}_{i}} )}^{2} + {λ}_{r} ( t ) {( {ϕ}_{{r}_{i}} - α {ϕ}_{{q}_{{t}_{i}}} {ϕ}_{{k}_{{j}_{i}}} )}^{2} + {λ}_{b} {ϕ}_{{r}_{i}} {ϕ}_{b} . \qquad ( eq . 28 )$$

for some constant α which ensures that

$$α {ϕ}_{{q}_{{t}_{i}}} {ϕ}_{{k}_{{j}_{i}}}$$

has dimensions of position. Thus, a Hamiltonian may include kinetic energy terms of respective oscillators, potential energy terms of respective oscillators (wherein the potential may or may not be shifted to correspond to a given value), coupling terms (indicating coupling between respective oscillators) with corresponding coupling parameters, and optional bias oscillator terms. Note that the bias term λ_{b}ϕᵣ_{ᵢ}ϕ_{b} in eq. 28 is optional since depending on the parameters of the EO protocol a bias oscillator may not be needed. The potentials for

$${ϕ}_{{q}_{{t}_{i}}} and {ϕ}_{{k}_{{j}_{i}}}$$

may be written as

$$\frac{1}{2} {m}_{q} {{ω}_{q}^{2} ( {ϕ}_{{q}_{{t}_{i}}} - {q}_{{t}_{i}} )}^{2} and \frac{1}{2} {m}_{k} {{ω}_{k}^{2} ( {ϕ}_{{k}_{{j}_{i}}} - {k}_{{j}_{i}} )}^{2}$$

in eq. 28 instead of writing their coupling with the clamped input data as in eq. 17. Such a simplification will not change the resulting equilibrium dynamics of the ϕᵣ_{ᵢ} oscillators that is shown to be obtained below. An EO protocol with a coupling strength λᵣ(t) is used. Using the Hamiltonian in eq. 28 and assuming that the oscillators

$${ϕ}_{{q}_{{t}_{i}}} and {ϕ}_{{k}_{{j}_{i}}}$$

are strongly clamped to qₜ_{ᵢ} and kⱼ_{ᵢ}, may result in

$$〈 {ϕ}_{{r}_{i}} 〉 = \frac{2 α {λ}_{r} {q}_{{t}_{i}} {k}_{{j}_{i}}}{2 {λ}_{r} + {m}_{r} {ω}_{r}^{2}} . \qquad ( eq . 29 )$$

Setting λᵣ>>mᵣωᵣ² and α=1, eq. 29 simplifies to

$$〈 {ϕ}_{{r}_{i}} 〉 \approx {q}_{{t}_{i}} {k}_{{j}_{i}} . \qquad ( eq . 30 )$$

Furthermore, the expectation value of the square of the oscillator may be

$$〈 {ϕ}_{{r}_{i}}^{2} 〉 \approx \frac{1}{2 β {λ}_{r}} + {q}_{{t}_{i}}^{2} {k}_{{j}_{i}}^{2} , \qquad ( eq . 31 )$$

so that the variance

$$Var ( {ϕ}_{{r}_{i}} ) \approx \frac{1}{2 β {λ}_{r}} , \qquad ( eq . 32 )$$

is small if k_{B}T/(2λᵣ)<<1. An example process may start with mᵣ²ωᵣ²<<λᵣ and increase mᵣωᵣ² after decoupling ϕᵣ_{ᵢ} from

$${ϕ}_{{q}_{{t}_{i}}} {ϕ}_{{k}_{{j}_{i}}}$$

to ensure that ϕᵣ_{ᵢ} remains nearly static at the equilibrium value in eq. 30.

To obtain the dot product, an oscillator ϕ_{ηt}_{ⱼ} may be coupled to each EO ϕᵣ_{ᵢ} with i∈{1, . . . , D}. The potential for such a coupling may be engineered to be

$${V}_{{η}_{{t}_{j}}} = \frac{1}{2} {m}_{η} {ω}_{η}^{2} {ϕ}_{{η}_{{t}_{j}}}^{2} + {{λ}_{d} ( {ϕ}_{{η}_{{t}_{j}}} - α {\sum }_{i = 1}^{D} {ϕ}_{{r}_{i}} )}^{2} , \qquad ( eq . 33 )$$

for some constant α. In eq. 33 the EO's ϕᵣ_{ᵢ} may be treated as static at their equilibrium values in eq. 30. In this case the equilibrium value of

$${ϕ}_{{η}_{{t}_{j}}}$$

is given by

$$〈 {ϕ}_{{η}_{{t}_{j}}} 〉 = \frac{2 {λ}_{d} α {\sum }_{i = 1}^{D} {q}_{{t}_{i}} {k}_{{j}_{i}}}{2 {λ}_{d} + {m}_{η} {ω}_{η}^{2}} . \qquad ( eq . 34 )$$

Setting λ_{d}>>m_{η}ω_{η}² and α=1/\sqrt{D}, eq. 34 simplifies to

$$〈 {ϕ}_{{η}_{{t}_{j}}} 〉 \approx \frac{{\sum }_{i = 1}^{D} {q}_{{t}_{i}} {k}_{{j}_{i}}}{\sqrt{D}} , \qquad ( eq . 35 )$$

where the factor of 1/\sqrt{D} comes from eq. 8. An illustration of the architecture described above is shown in FIG. 5A.

FIG. 5B illustrates the analog dot product gadget of FIG. 5A, wherein respective ones of the oscillators undergo a first thermodynamic evolution based on one or more potentials of the dot product gadget, according to some embodiments.

FIG. 5C illustrates the analog dot product gadget of FIG. 5B, wherein respective ones of the oscillators undergo a second thermodynamic evolution based on one or more potentials of the dot product gadget, wherein a result of a dot product between two vectors is thermodynamically obtained, according to some embodiments.

### Dot Product Gadget Network

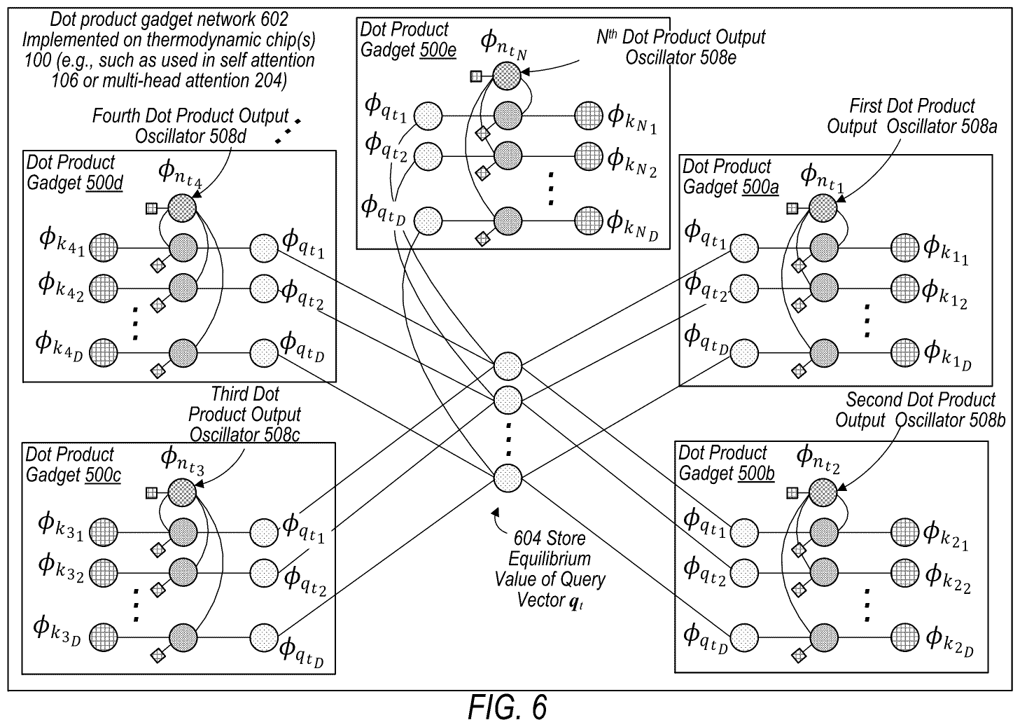

FIG. 6 illustrates an analog dot product gadget network implemented on one or more thermodynamic chips comprising oscillators, wherein results of a plurality of dot products are thermodynamically obtained, wherein each dot product share a common input vector with each other, according to some embodiments.

In some embodiments, a plurality of dot products may need to be thermodynamically evaluated, wherein each dot product that is to be evaluated share a common input vector encoded in one or more oscillators. For example, dot product gadget 500a may obtain a dot product between input vector k₁ (e.g., implemented on oscillators

$${ϕ}_{{k}_{{1}_{1}}}$$

through

$${ϕ}_{{k}_{{1}_{D}}} )$$

and input vector qₜ (e.g., implemented on oscillators

$${ϕ}_{{q}_{{t}_{1}}}$$

through

$${ϕ}_{{q}_{{t}_{D}}} ) ,$$

wherein dot product output oscillator 508a

$${ϕ}_{{η}_{{t}_{1}}}$$

obtains the result of the dot product. See FIGS. 5A-C for details of implementing a dot product gadget 500). Furthermore, dot product gadget 500b may obtain a dot product between input vector k₂ (e.g., implemented on oscillators

$${ϕ}_{{k}_{{2}_{1}}}$$

through

$${ϕ}_{{k}_{{2}_{D}}} )$$

and input vector qₜ (e.g., implemented on oscillators

$${ϕ}_{{q}_{{t}_{1}}}$$

through

$${ϕ}_{{q}_{{t}_{D}}} ) ,$$

wherein dot product output oscillator 508b

$${ϕ}_{{η}_{{t}_{2}}}$$

obtains the result of the dot product. For a given dot product gadget network, there may be a total of N dot product outputs needed (e.g., dot product output oscillators 508a-508e) wherein each dot product uses input vector qₜ as one of the input vectors (e.g., a shared query vector). In some embodiments, a dot product gadget network 602 (e.g., such as used in self attention 106 or multi-head attention 204) may include a set of oscillators that store equilibrium value of query vector qₜ 604 as thermodynamic data, wherein the set of oscillators may be accessed by each dot product gadget 500a-e. In some embodiments, each dot product gadget 500a-e may access, in parallel, the set of oscillators 604 that store equilibrium value of query vector qₜ. In some embodiments, each dot product gadget 500a-e may access, one at a time, the set of oscillators 604 that store equilibrium value of query vector qₜ.

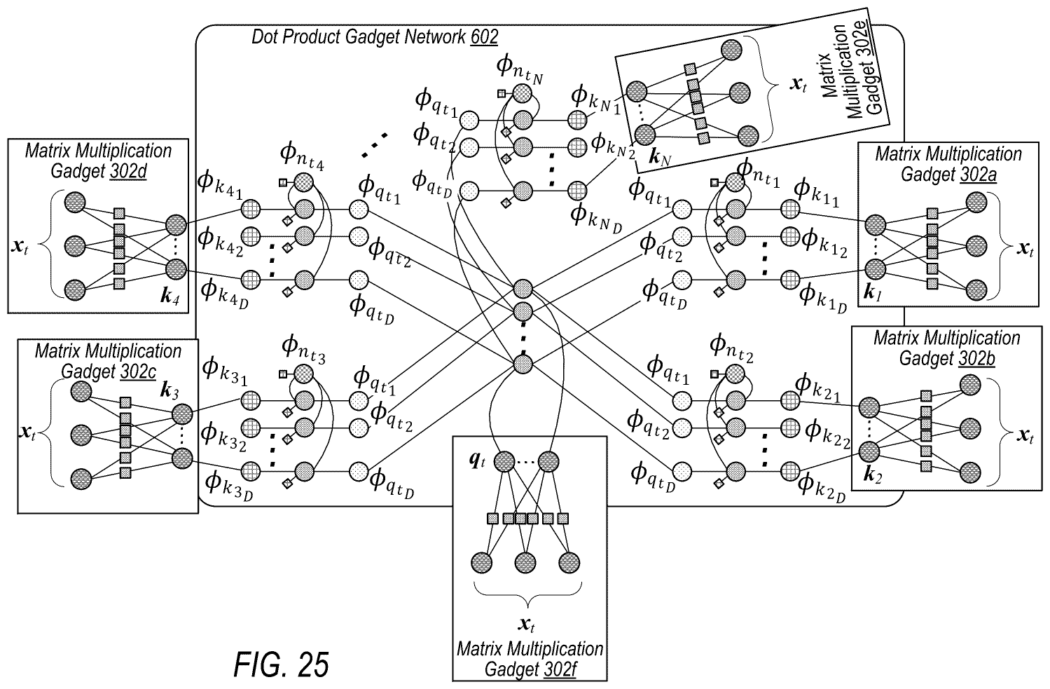

In some embodiments, each respective dot product gadget 500a-e may obtain thermodynamic data related to another input vector, wherein the other input vector sis unique to the dot product gadget (e.g., key vector k₁ for dot product gadget 500a and key vector k₂ for dot product gadget 500b and so on). For example, see FIG. 25 wherein matrix multiplication gadgets 302a-e may provide thermodynamic data as input to respective dot product gadgets of dot product gadget network 602. In some embodiments, there may be at least one dot product gadget network 602 for each input embedding t from t=1, 2, 3, . . . , N (e.g., there may be N total dot product gadget networks 602) for a given head.

In some embodiments, the dot product gadget network 602 comprises N blocks of dot product gadgets 508a-508e (e.g., one block for each attention layer). Each dot product gadget block may contain a plurality of oscillators representing key vectors {k₁ . . . k_{N}} (e.g., a number D of oscillators for a given key vector) and a plurality of oscillators (e.g., a number D of oscillators) representing query vector qₜ. In a given dot product block (e.g., the i-th block), oscillators corresponding to an i-th key vector kᵢ and an attention t query vector qₜ are coupled to EOs. These EOs are further coupled to an oscillator with positional degree of freedom

$${ϕ}_{{η}_{{t}_{i}}} ,$$

encoding the dot product between kᵢ^{T}qₜ (see dot product gadget illustrated in FIG. 5A-C). Since each dot product gadget for a given dot product gadget network 602 may use a same query vector as a given input vector, central EOs may store the equilibrium values of query vector qₜ 604, which may be propagated to corresponding input oscillators of each dot product gadget. Bias oscillators (e.g., represented by squares coupled to EOs) may be optional.

In some embodiments, to compute the t-th attention layer (t∈{1, . . . , N}) (e.g., for N total attention layers), dot products kⱼ^{T}qₜ for each j∈{1, . . . , N} (e.g., for N key vectors) may be needed. The dot product gadget network 602 architecture, illustrated in FIG. 6, is designed to perform this computation. It consists of N blocks, each corresponding to the dot product gadget shown in FIG. 5. The j-th dot product gadget (e.g., dot product gadget 500a-e) computes the dot product kⱼ^{T}qₜ. To construct attention layers for all t, N copies of the dot product gadget network 602 are needed, each corresponding to a unique t (e.g., attention layer). As discussed below, a SoftMax gadget 1202 (e.g., SoftMax gadget 216 or such as used in self-attention 106 or multi-head attention 204) may use the computed

$${ϕ}_{{η}_{{t}_{j}}}$$

values to derive the αᵢ(t) values in eq. 6. Notably, the

$${ϕ}_{{η}_{{t}_{j}}}$$

oscillators (dot product) output oscillators 508a-e in FIG. 6) encoding the dot product values can function as EOs, simplifying the parameter constraints required for implementing the SoftMax gadget 1202. For example, a product of mass and frequency squared may be tuned for each dot product oscillator 508a-e.

In some embodiments, a number of dot product gadget networks needed for a Multi-Head attention layer may be considered. To implement one head of a Multi-Head attention layer, N dot product gadget networks 602 are required. For h heads, this scales to hN (e.g., h times N) dot product gadget networks 602. In an encoder block 102, which may be repeated M times, these hN gadgets can be reused across repetitions. This is because the output of each encoder block 102 serves as the input to the next, allowing the matrix multiplication gadgets 300 to be reapplied with updated weights for each repetition. It is important to note that h is a hyperparameter, so the hardware may accommodate potentially larger h values (e.g., as specified by a user), necessitating additional oscillators for scalability.

In some embodiments, in a decoder block 212, a masked multi-head attention 210 layer and a multi-head attention 204 layer can have h₁ and h₂ heads, respectively, which are independent of h. Thus, the number of heads of the masked multi-head attention 210 layer may be different from the number of heads of the multi-head attention 204. The h₁N (e.g., a product of h₁ and N) dot product gadget networks required for the masked multi-head attention 210 layer can be reused for the multi-head attention 204 layer. Consequently, the total number of dot product gadget networks required for the decoder is max (h₁, h₂) N. For example, if h₁ is larger than h₂, h₁ may be selected and multiplied by the number of attention layers N. However, since h₁ and h₂ are hyperparameters, the hardware may include additional oscillators to support flexibility in selecting larger values of h₁ and h₂.

### Dot Product Gadget Network for Masked Multi-Head Attention Unit

In some embodiments, dot product gadget network 602 may be used in a masked multi-head attention layer leading to masked dot product gadget network 702 (e.g., such as used in masked multi-head attention 210). In a masked protocol, additional oscillators

$${ϕ}_{{m}_{{t}_{j}}}$$

(e.g., mask oscillators 704a-e) may be used and may be coupled to the corresponding

$${ϕ}_{{η}_{{t}_{j}}}$$

oscillators (e.g., dot product output oscillators 508a-e) as described herein. The coupling strength can take on two possible values, depending on whether the dot product output oscillator

$${ϕ}_{{η}_{{t}_{j}}}$$

508a-e needs to be masked or not. Note that the use of bias oscillators (represented by squares coupled to estimator oscillators (EOs)) is optional.

Below describe the implementation of the dot product gadget network architecture for a masked multi-head attention unit (e.g., dot product gadget network 602 or masked dot product gadget network 702). Suppose an embedding contains N tokens, resulting in an embedding matrix of dimensions d×N. In a decoder block 112, it may be assumed that the first j tokens have been processed (i.e., the output embedding 208 in FIG. 2B contains the first j tokens). To enforce causality, dot products of later tokens of the form kⱼ^{T}qₜ for j>t are masked (i.e., set to a value close to −∞) using mask oscillators 704a-e.

In some embodiments, one head of a multi-head attention layer may comprise N dot product gadget networks 602 or masked dot product gadget networks 702, wherein each gadget corresponds to a specific token t, and the t-th gadget 602 or 702 computes the dot products kⱼ^{T}qₜ (e.g., via dot product gadgets 500) for all j∈{1, . . . , N}. To achieve masking, for the t-th dot product gadget network 602 or masked dot product gadget network 702, the following condition may apply. If j>t,

$${ϕ}_{{η}_{{t}_{j}}}$$

dot product output oscillators 508a-e should encode a large negative value. Otherwise (J≤t),

$${ϕ}_{{η}_{{t}_{j}}}$$

dot product output oscillators 508a-e should encode the dot product kⱼ^{T}qₜ. Below, two example schemes for implementing this behavior are provided.

In some embodiments, example scheme 1 comprises at least one dot product gadget network 602 and a classical control with energy potential initialization. In this scheme, a classical controller decouples

$${ϕ}_{{η}_{{t}_{j}}}$$

dot product output oscillators 508a-e from the intermediate EOs (such as decoupling dot product output oscillator 508 from intermediate oscillators 506 in FIG. 5A) shown in FIG. 6 and initializes it to-c, where c>>1. The initialization uses a potential of the form:

$$\frac{1}{2} {m}_{η} {{ω}_{η}^{2} ( {ϕ}_{{η}_{{t}_{j}}} + c )}^{2} , \qquad ( eq . 36 )$$

where dot product output oscillator 508 ϕ_{ηt}_{ⱼ} (or 508a-e) is centered at −c. Note that this approach requires dynamically adjusting the center of the potential to 0 (for j≤t, e.g., not masked) or −c (for j>t, e.g., masked), depending on whether masking is required.

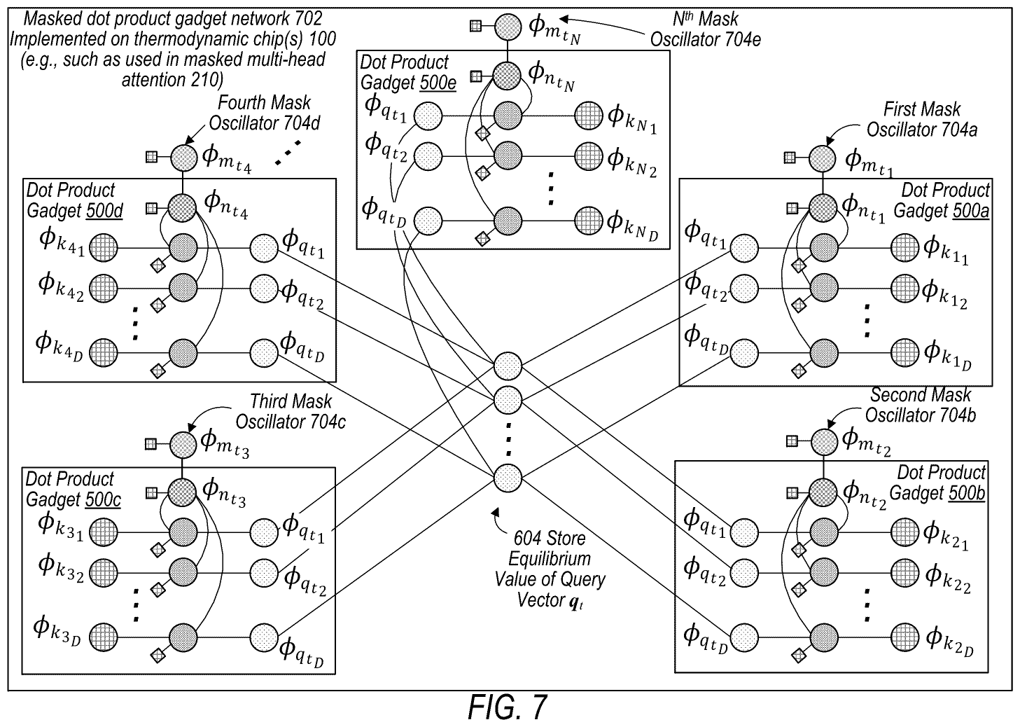

FIG. 7 illustrates an analog masked dot product gadget network implemented on one or more thermodynamic chips comprising oscillators, wherein obtained dot product results of a dot product gadget network are masked using additional oscillators, according to some embodiments.

In some embodiments, one or more dot product output values stored as thermodynamic data of a dot product gadget network 602 may need to be masked. For example, a masked dot product output may encode a large negative value in a thermodynamic degree of freedom of an oscillator representing the dot product. For example, a masked dot product output may not be utilized for further processing in a subsequent layer of a transformer neural network since the large negative value may prevent the masked oscillator from relaying thermodynamic data. In some embodiments, an auxiliary mask oscillator 704a-e may be coupled to a corresponding dot product output oscillator 508a-e. For example, dot product output oscillator 508a

$${ϕ}_{{η}_{{t}_{1}}}$$

may be coupled to first mask oscillator 704a

$${ϕ}_{{m}_{{t}_{1}}}$$

for a first dot product gauger 500a. In the case wherein thermodynamic data for dot product output of dot product gadget 500a is to be masked, a coupling strength between the dot product output oscillator 508a and the first mask oscillator 704a may be similar in value to half of a product of mass and frequency squared of the first mask oscillator. Thus, two times the coupling strength may be approximate to properties of the first mask oscillator. In the case wherein thermodynamic data for dot product output of dot product gadget 500a is to not be masked, a coupling strength between the dot product output oscillator 508a and the first mask oscillator 704a may be larger in value to half of the product of mass and frequency squared of the first mask oscillator. Thus, two times the coupling strength may be approximately large as compared to properties of the first mask oscillator.

In some embodiments, the output of a masked dot product gadget network 702 may include thermodynamic data stored in respective mask oscillators 704a-e. Such an output may be used as input to another layer of a transformer neural network architecture. For example, a SoftMax function may be applied thermodynamically to the dot product values. See FIG. 20.

In some embodiments, example scheme 2 comprises at least one masked dot product gadget network 702, wherein dot product output oscillators 508a-e are coupled with corresponding auxiliary mask oscillators 704a-e. This scheme avoids the need to adjust potential centers dynamically. For example, during initialization, each dot product output oscillator 508

$${ϕ}_{{η}_{{t}_{j}}}$$

is initialized to zero and coupled to the intermediate oscillators 506 EOs. After reaching thermal equilibrium, each dot product output oscillator 508 (or 508a-e)

$${ϕ}_{{η}_{{t}_{j}}}$$

is further coupled to an auxiliary mask oscillator 704a-e

$${ϕ}_{{m}_{{t}_{1}}} ,$$

with mass mₘ and frequency ωₘ. For the coupling potential, the coupling between a given dot product output oscillator 500

$${ϕ}_{{η}_{{t}_{j}}}$$

and a given auxiliary mask oscillator 704

$${ϕ}_{{m}_{{t}_{j}}}$$

is described by

$${{λ}_{ma}^{( j )} ( {ϕ}_{{η}_{{t}_{j}}} - {ϕ}_{{m}_{{t}_{j}}} )}^{2} . \qquad ( eq . 37 )$$

During the coupling, the given dot product output oscillator 500

$${ϕ}_{{η}_{{t}_{j}}}$$

acts as an EO, approximately static at its equilibrium value kᵢ^{T}qₜ. The equilibrium value of the given auxiliary mask oscillator 704

$${ϕ}_{{m}_{{t}_{j}}}$$

may be:

$$〈 {ϕ}_{{m}_{{t}_{j}}} 〉 = \frac{2 {λ}_{ma}^{( j )} {k}_{j}^{T} {q}_{t}}{2 {λ}_{ma}^{( j )} + {m}_{m} {ω}_{m}^{2}} . \qquad ( eq . 38 )$$

To mask such as described above, for j≤t (e. g., not masked), the coupling may be set to λₘₐ^{(j)}>>mₘωₘ², ensuring

$$〈 {ϕ}_{{m}_{{t}_{j}}} 〉 \approx {k}_{j}^{T} {q}_{t} .$$

For j>t (e. g., masked), the coupling may be set to λₘₐ^{(j)}=−(mₘωₘ²/2)+ϵ, where ϵ<<mₘωₘ². This ensures a thermal equilibrium value of the given auxiliary mask oscillator

$$〈 {ϕ}_{{m}_{{t}_{j}}} 〉$$

encodes a large negative value, effectively masking the dot product. An illustration of these couplings is shown in FIG. 7.

If the dot product gadget networks used for the masked multi-head attention 210 layer are reused in the multi-head attention layer 204 of the decoder block 212, the coupling between dot product output oscillator 508a-e

$${ϕ}_{{η}_{{t}_{j}}}$$

and corresponding auxiliary mask oscillator 704a-e

$${ϕ}_{{m}_{{t}_{j}}}$$

is disabled. Only the dot product output oscillators 508a-e

$${ϕ}_{{η}_{{t}_{j}}}$$

may be used, bypassing the masking mechanism.

### Activation Function Potentials

In some embodiments, several potentials for commonly used activation functions in transformer architectures are described below.

### Sigmoid Gadget

FIG. 8A is high-level diagram illustrating an energy-based model (EBM) implemented using a thermodynamic chip and an analog sigmoid gadget implemented using a thermodynamic chip, wherein the EBM and analog sigmoid gadget are shown at a first moment in time (e.g. prior to a coupling between oscillators of the sigmoid gadget and oscillators of the EBM), wherein the coupling (performed directly or via relay oscillators) provides input values for a sigmoid function that is performed thermodynamically, according to some embodiments.

In some embodiments, a sigmoid gadget may comprise a set of oscillators of the oscillators of the one or more thermodynamic chips configured to perform a sigmoid function. The set of oscillators may comprise an input oscillator and an output oscillator.

To perform the sigmoid function, the set of oscillators may be configured to obtain thermodynamic information on the input oscillator, couple to each other to implement an engineered potential, wherein the engineered potential thermodynamically implements the sigmoid function, and thermodynamically evolve based on the engineered potential. Thee thermodynamic evolution based on the engineered potential may be configured to cause the output oscillator to obtain a result of the sigmoid function based on input provided to the input oscillator.

In some embodiments, a sigmoid function is implemented by configuring oscillators of a thermodynamic chip according to an engineered potential that implements the sigmoid function. The oscillators configured with the engineered potential may be referred to herein as an analog sigmoid gadget 802 (which may be used as non-linear constraint potential 408). The analog sigmoid gadget 802 is configured to be coupled to oscillators, such as output oscillators 810 of an energy-based model (e.g. EMB 804 which may also be linear constraint potential 404) or relay oscillators (or other oscillators) coupled to output oscillators of the EBM, wherein the EBM may be another component of a transformer neural network architecture. The output oscillators 808 of the analog sigmoid gadget may evolve under the influence of the engineered potential of the analog sigmoid gadget such that, once thermal equilibrium is reached (while the analog sigmoid gadget is coupled to the output oscillators of the EBM), the input/output oscillators of the analog sigmoid gadget represent the sigmoid function evaluated at the output of the EBM 804. Also, relay oscillators may be used to relay thermodynamic information (e.g., that is the output of another energy-based model) as input thermodynamic information that is to be processed by the analog sigmoid gadget. For example, relay oscillators may be used to hold the position degree of freedom values of the output oscillators of the other EBM to be approximately static during the thermal evolution of the analog sigmoid gadget.

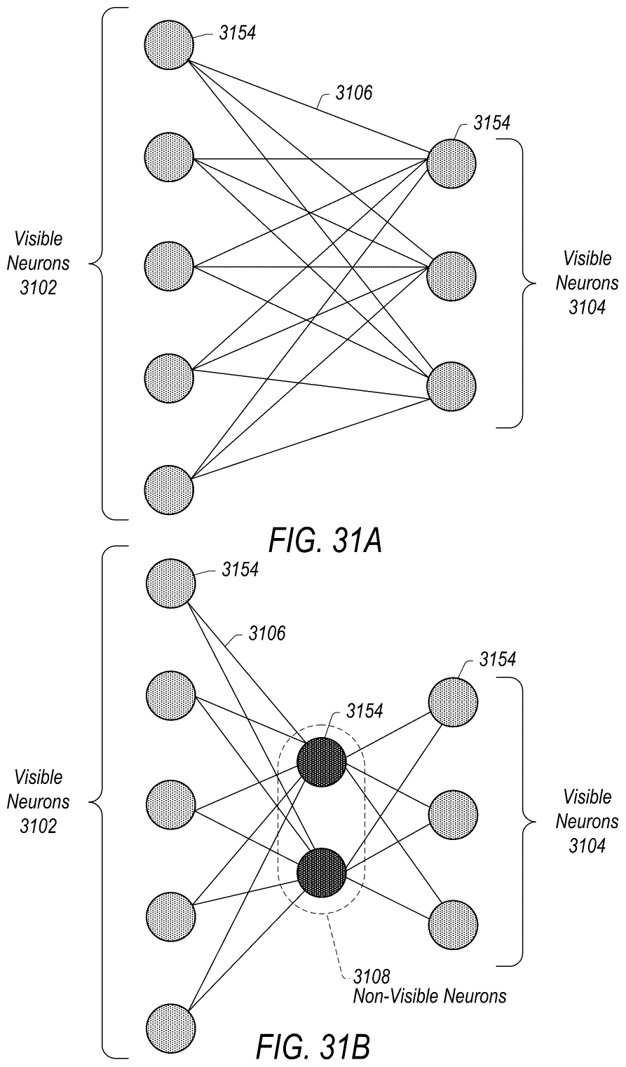

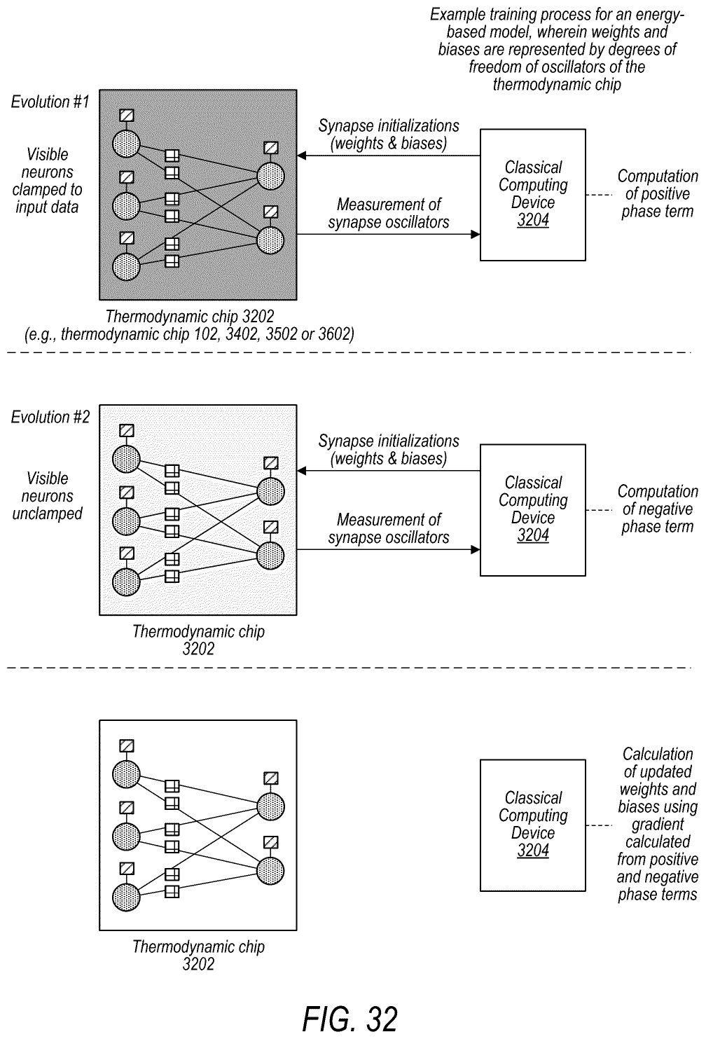

Thermodynamic chips 100, which may be a single thermodynamic chip or a set of connected thermodynamic chips, include oscillators that implement an energy-based model and an analog sigmoid gadget. For example, thermodynamic chip 100 implements energy-based model 804 that includes input oscillators and output oscillators 810. There may also be hidden neurons (e.g., oscillators coupled to both the inputs and outputs, and which are coupled amongst each other) as shown in FIG. 31B. Also, thermodynamic chip 100 implements analog sigmoid gadget 802 that includes input oscillators 806 and output oscillators 808. While not shown, in some embodiments, energy-based model 804 may implement a component of a transformer neural network and may include additional oscillators, such as non-visible neurons 3108 as shown in FIG. 31B. Also, energy-based model 804 may include synapse oscillators (e.g. weights and bias oscillators), such as shown in FIGS. 32, 33, and 38.

The input oscillators 806 and output oscillators 808 of analog sigmoid gadget 802 are configured, and initialized, in accordance with the engineered potential described below that ensures the output oscillators 808 are dual well oscillators (e.g., with well minima at zero and one).

For example, inductor parameters, Josephson junction parameters, and capacitance parameters of the respective inductors, Josephson junctions and capacitors used to implement the respective input/output oscillators may be adjusted. For example, additional details regarding the components used to implement a respective oscillator, such as a respective oscillators of the analog sigmoid gadget 802 are further discussed in FIG. 37.

The energy-based model 804 may thermodynamically evolve at time Ti prior to being coupled to analog sigmoid gadget 802. For example, input data may be provided to energy-based model 804 via input oscillators and the energy-based model may thermodynamically evolve such that output oscillators 810 represent an output of the energy-based model 804.

FIG. 8B illustrates the EBM and analog sigmoid gadget at a second moment in time, wherein a coupling to thermodynamically transfer an input value to an oscillator of the sigmoid gadget has been performed, according to some embodiments.

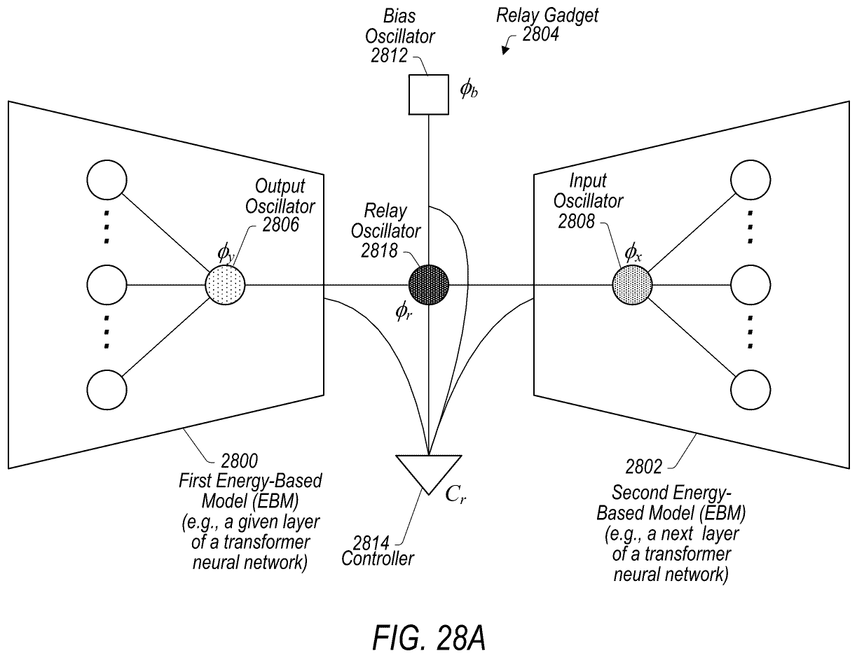

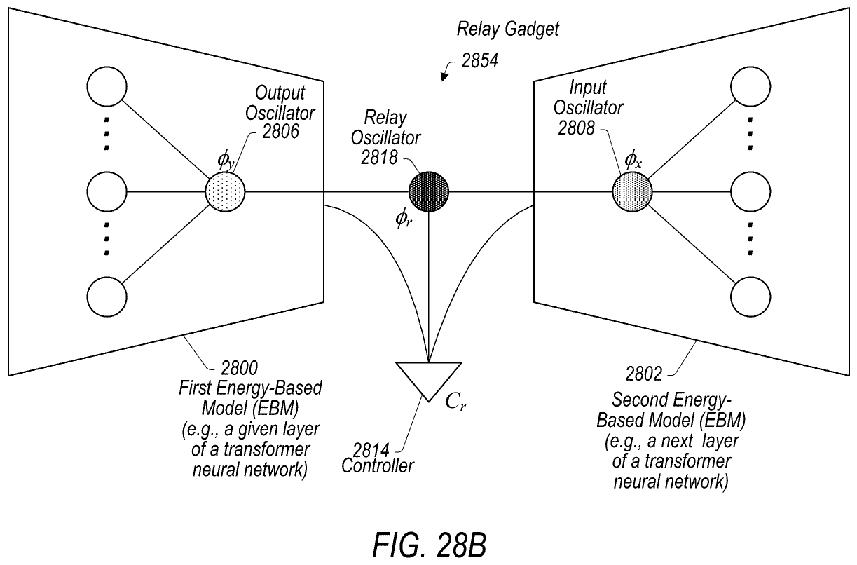

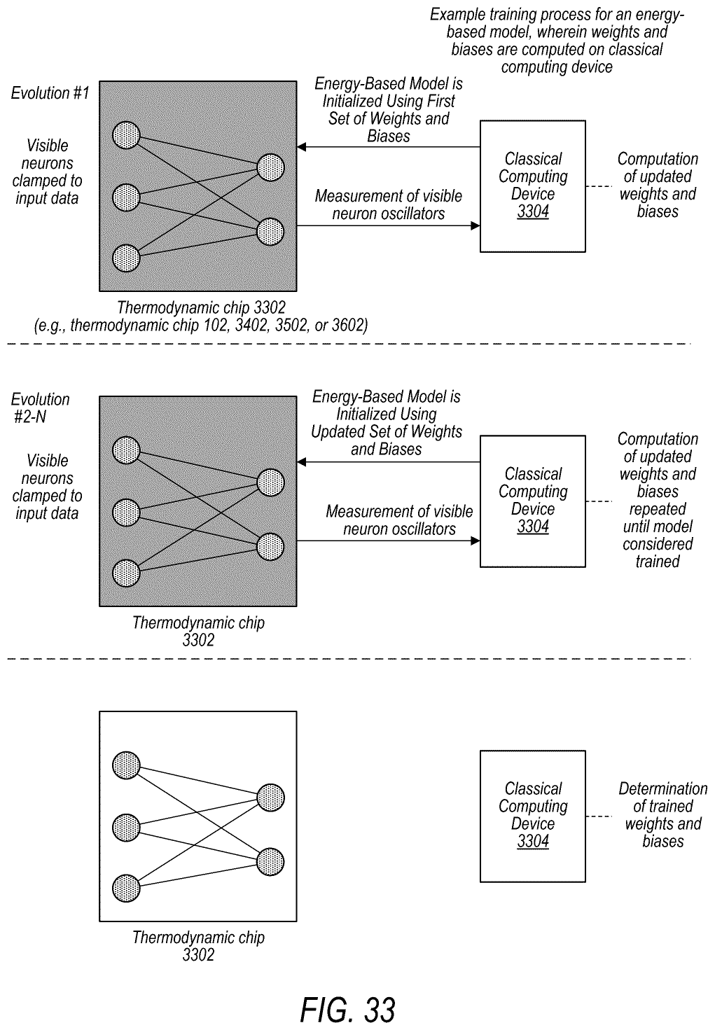

At time T₂ the output oscillators 810 of energy-based model 804 may be coupled to the input oscillator 806 of the analog sigmoid gadget 802, for example via coupling 814. Also, in some embodiments, relay oscillators may be used to relay the output values of energy-based model 804 to the input oscillator 806 of sigmoid gadget 802. For example, FIG. 8D shows an arrangement with relay oscillators 814. In such embodiments, the relay oscillators 814 may first be coupled to output oscillator 810 of energy-based model 804, such that output values of the energy-based model are relayed to the relay oscillator 814. The relay oscillator 814 may then be coupled to the input oscillator 806 of analog sigmoid gadget 802. For example, the coupling 812 may be coupling between relay oscillator 814 and input oscillator 806 (instead of coupling between output oscillator 810 and input oscillator 806). Coupling 812 provide the input values, e.g. η, wherein the analog sigmoid gadget 802 takes the argument l encoded as position degrees of freedom (ϕ_{η}) of the output oscillator 810 (or alternatively relay oscillator 814) and returns the sigmoid result of this input argument, e.g. σ(η), in expectation value. Additional details regarding relay oscillator operation is provided below with regard to FIGS. 28-30D. Also, additional details regarding how to determine synapse parameters (e.g., weights and biases) of an energy-based model, such as energy-based model 804 are provided below with regard to FIGS. 32-33.

FIG. 8C illustrates the EBM and analog sigmoid gadget at a later moment in time, wherein the analog sigmoid gadget has thermodynamically evolved under an engineered potential of the analog sigmoid gadget such that respective oscillators of the analog sigmoid gadget evolve to have a value that encodes the output of the sigmoid function, according to some embodiments.

At time T₃ the oscillators of the analog sigmoid gadget 802 have reached thermal equilibrium after evolving based on the input thermodynamic information and the engineered potential that implements the sigmoid function. The oscillators (e.g., oscillators 806 and 808) of the analog sigmoid gadget 802 evolve based on the engineered potential which causes the output oscillator 808 of the sigmoid gadget to obtain the result of the sigmoid function. Thus, the measured expectation values of the output oscillator 808 yield the result of the sigmoid function at thermal equilibrium. For example, the final value of the output oscillator 808 encodes the result of the sigmoid function in its position degree of freedom, and measuring an expectation value of the output oscillators 808 over a period of time at thermal equilibrium returns the sigmoid function result for a given input provided to the analog sigmoid gadget 802.

FIG. 8D illustrates an example configuration wherein a relay oscillator is used to provide an adjustable mass and/or frequency that allows the output oscillator of the EBM to be treated as static when coupled with the analog sigmoid gadget, according to some embodiments.

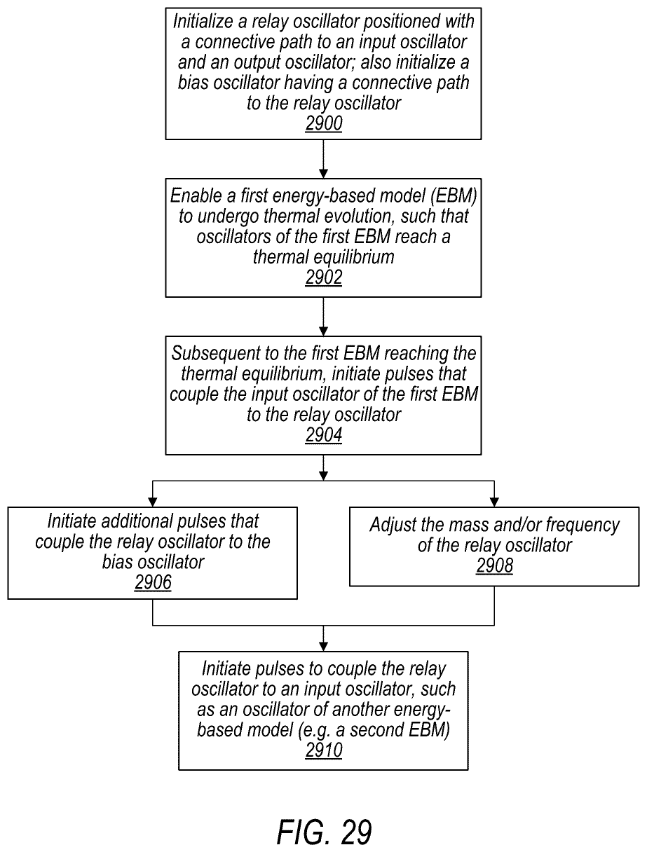

As mentioned above, in some embodiments, input providing relay oscillator 814 may be used to relay thermodynamic information to input oscillator 806 of analog sigmoid gadget 802. Additional details regarding the use of relay oscillators are provided in FIGS. 28-29. It should be understood that in some embodiments, the second energy-based model shown in FIGS. 28-29 could be analog sigmoid gadget 802. For example, the input providing relay oscillator 814 may be used to hold output values of the output oscillator 810 of EBM 804 static. For example, input providing relay oscillator 814 may be coupled to output oscillator 810 with a small product of mass times frequency squared, such that input providing relay oscillator 814 takes on a position degree of freedom value of output oscillator 810. The mass and/or frequency values of the input providing relay oscillator 814 may then be tuned to a larger value, such that the input providing relay oscillator 814 holds the relayed position degree of freedom value at a near static value while coupled to input oscillator 806 of the analog sigmoid gadget 802.

FIG. 8E illustrates an additional example configuration wherein the output of the EBM is directly coupled to the input of the sigmoid gadget, and wherein a relay gadget is used to receive the result of the sigmoid function, implemented thermodynamically via the analog sigmoid gadget coupled to the EBM, wherein the relay gadget stores an expectation value of the output oscillator of the analog sigmoid gadget, according to some embodiments.

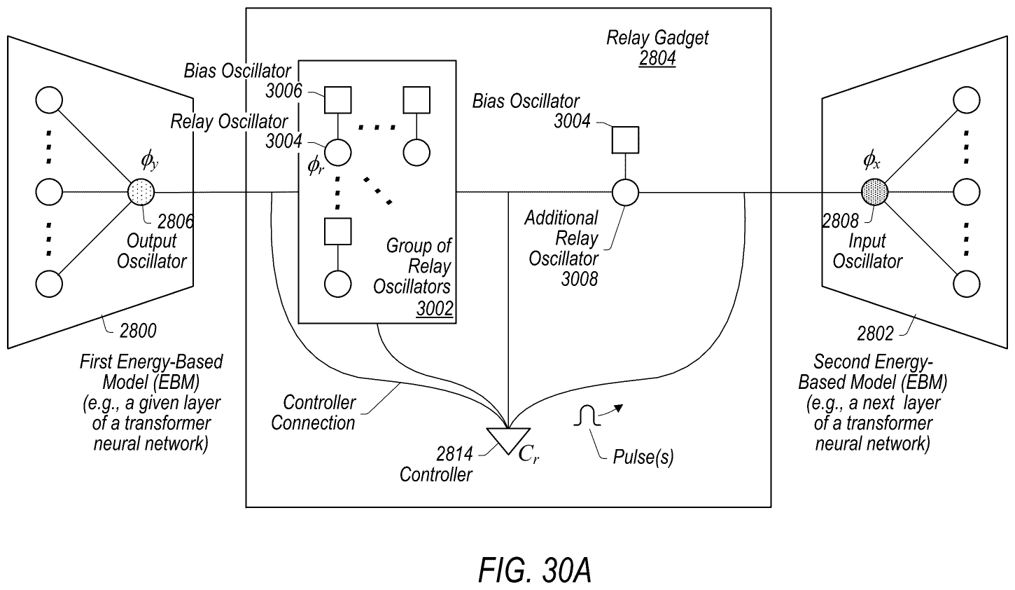

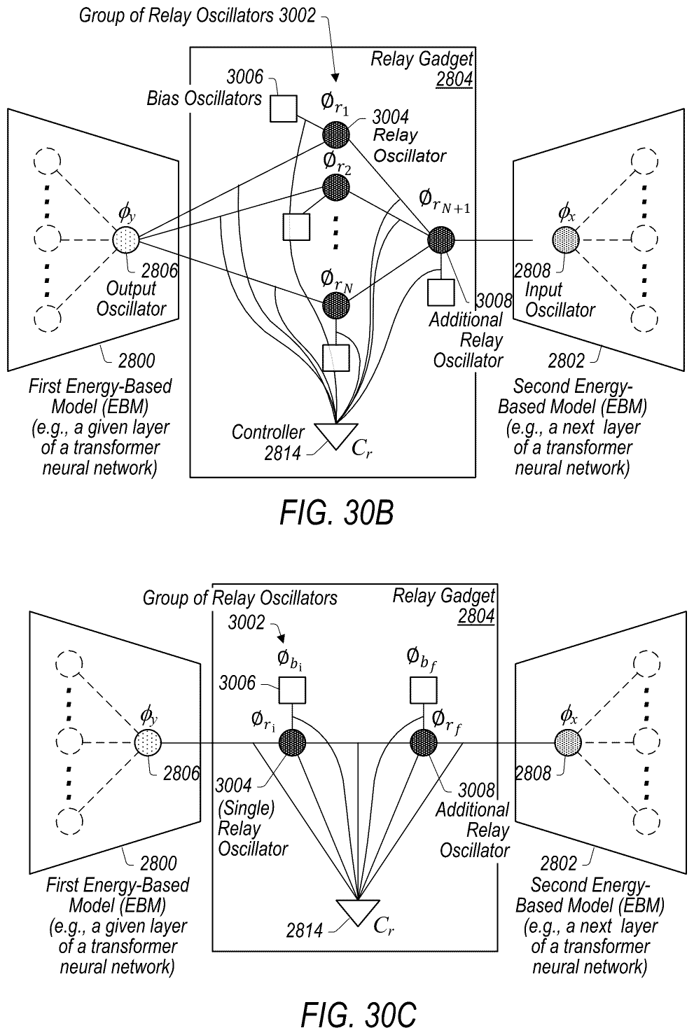

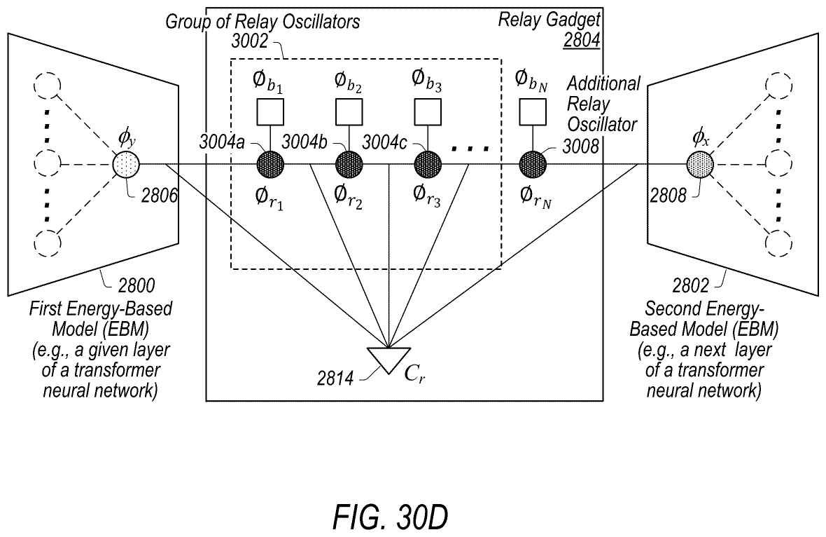

In some embodiments, other relay oscillators may be used to accept the outputs of output oscillator 808 of the analog sigmoid gadget 802. For example, single relay oscillators or relay gadgets comprising groups of relay oscillators (e.g., relay oscillator or gadget 818) may be coupled via couplings 816 to output oscillators 808 of analog sigmoid gadget 802. For example, arrangements using single relay oscillators are shown in FIGS. 28-29. It should be understood that the first energy-based model discussed in FIGS. 28-29 could be an analog sigmoid gadget 108, in some embodiments. In some embodiments, wherein the result receiving relay oscillator 818 is a single relay oscillator, it may be used to sample the output oscillator 808. In some embodiments, wherein the result receiving relay gadget 818 is used, the result receiving relay gadget may include a group of relay oscillators configured to store expectation values of output oscillator 808 of analog sigmoid gadget 802. For example, various configurations of relay gadgets are shown in FIGS. 30A-D and may be used as relay gadget 818. It should be understood that in some embodiments, the first energy-based model discussed in FIGS. 30A-D may be an analog sigmoid gadget 802.

FIG. 8F illustrates another example configuration wherein a relay oscillator is used to provide an adjustable mass and/or frequency that allows the output oscillator of the EBM to be treated as static when coupled with the analog sigmoid gadget, and wherein a relay gadget is used to receive the result of the sigmoid function, implemented thermodynamically via the analog sigmoid gadget coupled to the EBM, wherein the relay gadget stores an expectation value of the respective input/output oscillators of the analog sigmoid gadget, according to some embodiments.

Also, it should be noted that in some embodiments, relay oscillators or relay gadgets may be used to store output samples or expectation values of the output oscillator 810 of EBM 804, using a relay oscillator 814 such as shown in FIG. 1F or without necessarily needing to use input providing relay oscillator 814, such as shown in FIG. 1E.

FIG. 8G illustrates another example configuration wherein an additional relay gadget is used to provide one or more adjustable masses and/or frequencies that allow the output oscillator of the EBM to be treated as static when coupled with the analog sigmoid gadget, and wherein a relay gadget is used to receive the result of the sigmoid function, implemented thermodynamically via the analog sigmoid gadget coupled to the EBM, wherein the relay gadget stores an expectation value of the output oscillator of the analog sigmoid gadget, according to some embodiments.

Also, it should be noted that in some embodiments, relays or relay gadgets may be used to store output samples or expectation values of the output oscillator 808 of analog sigmoid gadget 802, using a relay gadget 818, instead of relay oscillator 814 as in FIGS. 1D and 1F.

FIG. 9 illustrates an example of an analog sigmoid gadget comprising an input oscillator treated as static and an output oscillator with a dual-well potential, wherein the couplings between the oscillators comprise a two-body coupling, according to some embodiments.

In some embodiments, the potential which implements the commonly used sigmoid activation function may be utilized. For example, the function

$$σ ( η ) = \frac{1}{1 + {e}^{- η}} , \qquad ( eq . 39 )$$

may be implemented using a thermodynamic chip comprising oscillators. To do so, the following potential may be engineered to the thermodynamic chip.

$${V}_{sig} ( {ϕ}_{s} , η ) = {λ}_{1} {{ϕ}_{s}^{2} ( {ϕ}_{s} - 1 )}^{2} + {λ}_{2} {ϕ}_{s} η , \qquad ( eq . 40 )$$

where the input oscillator 806 ϕ_{η} is approximately static at the equilibrium value 902 η. The expectation value of the ϕₛ oscillator (e.g., output oscillator 808 ϕₒᵤₜ) at thermal equilibrium is equal to σ(η) when the coupling parameter λ₁ is large. To see this, the expectation value may be computed as

$$\begin{matrix}〈 {ϕ}_{S} 〉 = \frac{\int d {ϕ}_{s} {ϕ}_{s} {e}^{- β ( {λ}_{1} {{ϕ}_{s}^{2} ( {ϕ}_{s} - 1 )}^{2} + {λ}_{2} {ϕ}_{s} η )}}{\int d {ϕ}_{s} {e}^{- β ( {λ}_{1} {{ϕ}_{s}^{2} ( {ϕ}_{s} - 1 )}^{2} + {λ}_{2} {ϕ}_{s} η )}} \\ \approx \frac{0 + ( 1 ) {e}^{- β {λ}_{2} η}}{1 + {e}^{- β {λ}_{2} η}} , \\ = \frac{1}{1 + {e}^{- η}} ,\end{matrix} \qquad ( eq . 41 )$$

where in going from the first to the second line, the concept that for large λ₁, the exponential is non-zero for values of ϕₛ close to zero and one is utilized. When going from the second to the third line, the coupling parameter is set to λ₂=−1/β.

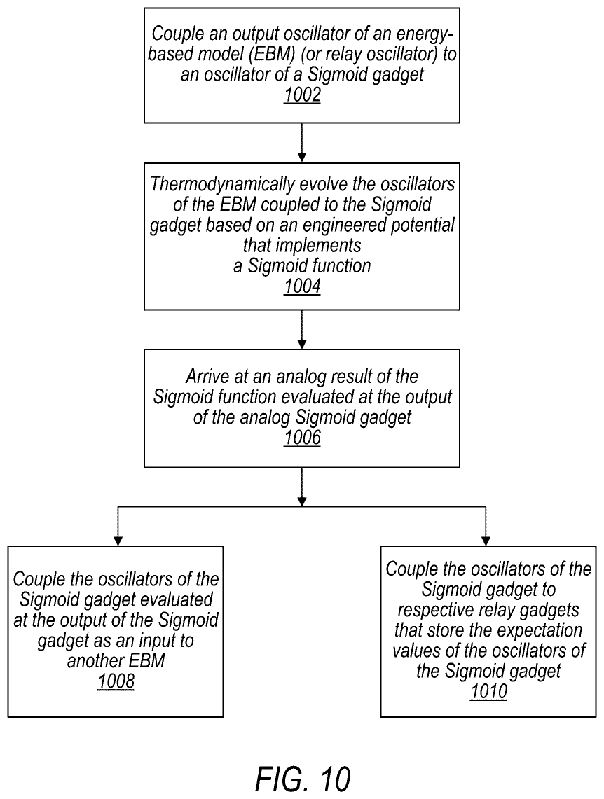

FIG. 10 is a flowchart illustrating a process for implementing a sigmoid function using an analog sigmoid gadget, according to some embodiments.

At block 1002, an output oscillator of an energy-based model (or relay oscillator) is coupled to an input oscillator of an analog sigmoid gadget. Then, at block 1004, the oscillators (including the input oscillator, output oscillator) are allowed to thermally evolve, e.g. to reach a thermal equilibrium. This evolution is performed based on an engineered potential for the analog sigmoid gadget which creates energetic penalties that drive the oscillators to thermodynamically evolve to the output of the sigmoid function (e.g., an output oscillator having a thermodynamic information corresponding to the output of the sigmoid function). For example, at block 1006 (after the thermal evolution) the output oscillator of the analog sigmoid gadget arrives at an analog result of the sigmoid function.

At block 1008, the output oscillator of the analog sigmoid gadget is coupled to another EBM or other device that is to receive the result of the sigmoid function. This could be another EBM, relay oscillators, measurement, etc.

As another alternative, at block 1010 the output oscillator of the analog sigmoid gadget is coupled to a relay gadget, such as shown in FIGS. 8E, 8F and 8G, wherein the relay gadget can have any of the configurations shown in FIGS. 30A-D. The relay gadget stores respective expectation values of the output oscillator of the analog sigmoid gadget.

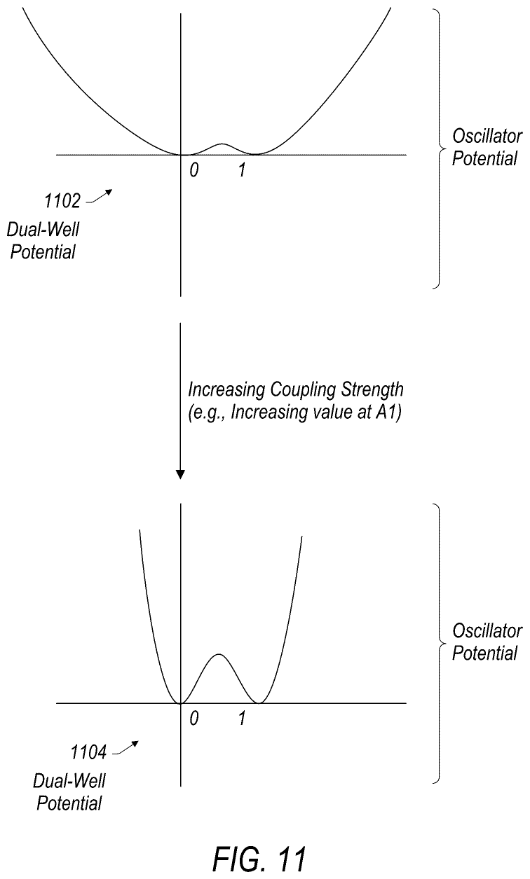

FIG. 11 illustrates graphs of potentials for a given oscillator, wherein the given oscillator has a dual-well potential. FIG. 11 further illustrates how increasing the coupling strength parameter (e.g., λ₁) in an engineered potential for a gadget causes the walls and intermediate barrier between the two wells of the dual-well potential to be more steep, such that the dual-well oscillator is more likely to evolve to a value of 0 or 1 as required by the engineered potential for the analog gadget, according to some embodiments.

The output oscillator 808 of the analog sigmoid gadget 802 may be implemented using dual-well potential oscillators. Furthermore, selecting an appropriate coupling value λ₁ that is large creates an energetic penalty for values other than zero or one. This is illustrated in FIG. 4, wherein increasing the coupling value of λ₁ increases the well walls and the barrier between the wells, such that the minima of each of the wells is at zero or one.

### SoftMax Gadget

FIG. 12A is high-level diagram illustrating an energy-based model (EBM) implemented using a thermodynamic chip and an analog SoftMax gadget implemented using a thermodynamic chip, wherein the EBM and analog SoftMax gadget are shown at a first moment in time (e.g. prior to a coupling between oscillators of the SoftMax gadget and oscillators of the EBM, wherein the coupling (performed directly or via relay oscillators) provides input values for a SoftMax function that is performed thermodynamically), according to some embodiments.

In some embodiments, a SoftMax gadget may comprise a first set of oscillators of one or more thermodynamic chips, and a second set of oscillators of the one or more thermodynamic chips. In some embodiments, the second set of oscillators may be configured to perform a SoftMax function. To perform the SoftMax function, the second set of oscillators may couple to the first set of oscillators, wherein the first set of oscillators have a first set of respective values, and thermodynamically evolve based on a given engineered potential for the second set of oscillators, wherein the given engineered potential thermodynamically implements the SoftMax function.

In some embodiments, and described herein, a SoftMax layer can be implemented on a thermodynamic processor. For example, let ηⱼ^{(t)}=kⱼ^{T}qₜ. Furthermore, the SoftMax layer may be written as

$$Softmax ( {η}_{j}^{( t )} ) = \frac{{e}^{{η}_{j}^{( t )}}}{{\sum }_{i = 1}^{K} {e}^{{η}_{i}^{( t )}}} . \qquad ( eq . 42 )$$

The SoftMax layer is a crucial component in computing the self-attention matrix as described in eq. 5.

In some embodiments, a potential may be engineered to represent the following potential

$${V}_{s} ( {ϕ}_{b} , {ϕ}_{{η}_{t}} ) = {λ}_{s} {\sum }_{j = 1}^{N} {ϕ}_{{b}_{j}} {ϕ}_{{η}_{{t}_{j}}} , \qquad ( eq . 43 )$$

where the vector of oscillators ϕ_{b}∈ [symbol] is a vector of oscillators that is constrained to be [symbol] an element of the standard basis of [symbol] (or one-hot encoded vectors). For instance, if N=3, then the possible values for the three oscillators are ϕ_{b}_{₁}=(1,0,0), ϕ_{b}_{₂}=(0,1,0) and ϕ_{b}_{₃}=(0,0,1). Thus, for example, the oscillators may be coupled in such a way that the vector ϕ_{b} is constrained to take on values of the standard basis for [symbol] (e.g., see the potential below that achieves this goal). In some embodiments, it may be assumed that the

$${ϕ}_{{η}_{{t}_{j}}}$$

oscillators in eq. 43 can be treated as static (which can be done if a EO is used to encode the state of

$${ϕ}_{{η}_{{t}_{j}}} ) .$$

Now since the oscillators ϕ_{b} are constrained to one-hot encoded vectors, at equilibrium, the expectation value of the j'th oscillator may be given by

$$\begin{matrix}{〈 {ϕ}_{{b}_{j}} 〉}_{th} = {\sum }_{b} {ϕ}_{{b}_{j}} \frac{{e}^{- β {V}_{s} ( {ϕ}_{b} , {ϕ}_{{η}_{t}} )}}{{Σ}_{{b}^{′}} {e}^{- β {V}_{s} ( {ϕ}_{{b}^{′}} , {ϕ}_{{η}_{t}} )}} \\ = \frac{{e}^{- β {λ}_{s} {ϕ}_{{η}_{{t}_{j}}}}}{{\sum }_{i = 1}^{N} {e}^{- β {λ}_{s} {ϕ}_{{η}_{{t}_{i}}}}} ,\end{matrix} \qquad ( eq . 44 )$$

wherein for one of the b vectors, ϕ_{b}_{ⱼ}=1 and equals zero for all others. Note that the sum over b is a sum over all one-hot encoded vectors of size N. By choosing λₛ=−1/β, the average of the j'th component of b as computed in eq. 44 is the desired SoftMax result.

The next step is to specify the potential which generates the one-hot encoding for the vector ϕ_{b}. In particular, whenever ϕ_{b}_{ᵢ}=1, all other components of the vector should be zero. An example potential which can achieve this result is given by

$$V ( {ϕ}_{{b}_{1}} , … , {ϕ}_{{b}_{N}} ) = {A}_{1} {\sum }_{j = 1}^{N} {{ϕ}_{{b}_{j}}^{2} ( {ϕ}_{{b}_{j}} - 1 )}^{2} + {{A}_{2} ( {\sum }_{j = 1}^{N} {ϕ}_{{b}_{j}} - 1 )}^{2} , \qquad ( eq . 45 )$$

where the position degree of freedom of the j'th oscillator is denoted by ϕ_{b}_{ⱼ}. For large A₁, the first term in eq. 45 adds a penalty whenever the position degrees of freedom of the oscillators take on values which are not 0 or 1. For large A₂, the second term in eq. 45 adds a penalty if the position degrees of freedom ϕ_{b}_{ⱼ} do not sum to 1.

In some embodiments, a potential which is the sum of the potential given in eq. 45 may be engineered and implemented as well as the coupling term described in eq. 43. At thermal equilibrium, the expectation value for (ϕ_{b}_{ⱼ}) is given by

$$\begin{matrix}{〈 {ϕ}_{{b}_{j}} 〉}_{th} = \frac{\int db {ϕ}_{{b}_{j}} {e}^{- β V ( {ϕ}_{b} )} {e}^{- β {V}_{s} ( {ϕ}_{b} , {ϕ}_{{η}_{t}} )}}{\int {db}^{′ {e}^{{- β V ( {ϕ}_{{b}^{′}} )}^{} {e}^{- β {V}_{s} ( {ϕ}_{{b}^{′}} , {ϕ}_{{η}_{t}} )}}}} \\ \approx \frac{{e}^{- β V ( {e}_{j} )} {e}^{- β {V}_{s} ( {e}_{j} , {ϕ}_{{η}_{t}} )}}{{\sum }_{i = 1}^{N} {e}^{- β V ( {e}_{i} )} {e}^{- β {V}_{s} ( {e}_{i} , {ϕ}_{{η}_{t}} )}} \\ = \frac{{e}^{- β {V}_{s} ( {e}_{j} , {ϕ}_{{η}_{t}} )}}{{\sum }_{i = 1}^{N} {e}^{- β {V}_{s} ( {e}_{i} , {ϕ}_{{η}_{t}} )}} ,\end{matrix} \qquad ( eq . 46 )$$

where in eq. 46 eⱼ may be used to denote the j'th standard basis vector of [symbol] . In going from the first to the second line, e^{-βV(ϕ}^{_{b}}⁾ is approximately non-zero only for of ϕ_{b} which are one-hot encoded vectors. Furthermore, since the exponential is multiplied by ϕ_{b}_{ⱼ}, the resulting integral will be non-zero only when ϕ_{b}=eⱼ. In going from the second to third line, symmetry of the potential in eq. 45 is used which ensures that e^{-βV(e}^{ᵢ}⁾=e^{-βV(e}^{ⱼ}⁾ for all i, j∈{1, . . . , N}. As such, the exponential e^{-βV(e}^{ⱼ}⁾ in the numerator cancels with the exponential terms in the denominator of the form e^{-βV(e}^{ᵢ}⁾.

In deriving eq. 46, the

$${ϕ}_{{η}_{{t}_{j}}}$$

oscillators may are treated as a constant. Another treatment may integrate out the

$${ϕ}_{{η}_{{t}_{j}}}$$

system while taking into account the potential in eq. 33. In what follows, label

$${\sum }_{i = 1}^{D} {ϕ}_{{k}_{{j}_{i}}} {ϕ}_{{q}_{{t}_{i}}} ≡ {η}_{{t}_{j} ,} \qquad ( eq . 47 )$$

and set m and ω to be the mass and frequency of the

$${ϕ}_{{η}_{{t}_{j}}}$$

oscillators. This leads to

$$\begin{matrix}{〈 {ϕ}_{{b}_{j}} 〉}_{th} = \frac{\int d {ϕ}_{η} d {ϕ}_{b} {ϕ}_{{b}_{j}} {e}^{- β V ( {ϕ}_{b} ) - β {V}_{s} ( {ϕ}_{b} , , {ϕ}_{{η}_{t}} )} {e}^{- β {V}_{η}}}{\int d {ϕ}_{η} d {ϕ}_{b} {e}^{- β V ( {ϕ}_{{b}^{′}} )} {e}^{- β {V}_{s} ( {ϕ}_{{b}^{′}} , {ϕ}_{{η}_{t}} )} {e}^{- β {V}_{η}}} , \\ \approx \frac{{e}^{\frac{{( {η}_{{t}_{j}} - β m ω {λ}_{s} )}^{2}}{2 β {m}^{3} {ω}^{3}}} {\prod }_{i \neq j} {e}^{\frac{{η}_{{t}_{i}}^{2}}{2 β {m}^{3} {ω}^{3}}}}{{\sum }_{i = 1}^{N} {e}^{\frac{{( {η}_{{t}_{j}} - β m ω {λ}_{s} )}^{2}}{2 β {m}^{3} {ω}^{3}}} {\prod }_{k \neq i} {e}^{\frac{{η}_{{t}_{k}}^{2}}{2 β {m}^{3} {ω}^{3}}}} , \\ = \frac{{e}^{\frac{{η}_{{t}_{j}}^{2}}{2 β {m}^{3} {ω}^{3}} - \frac{{λ}_{s} {η}_{{t}_{j}}}{{m}^{2} {ω}^{2}}} {\prod }_{i \neq j} {e}^{\frac{{η}_{{t}_{i}}^{2}}{2 β {m}^{3} {ω}^{3}}}}{{\sum }_{i = 1}^{N} {e}^{\frac{{η}_{{t}_{i}}^{2}}{2 β {m}^{3} {ω}^{3}} - \frac{{λ}_{s} {η}_{{t}_{i}}}{{m}^{2} {ω}^{2}}} {\prod }_{k \neq j} {e}^{\frac{{η}_{{t}_{k}}^{2}}{2 β {m}^{3} {ω}^{3}}}} ,\end{matrix} \qquad ( eq . 48 )$$

where in going from the first to second line, the property of the V(ϕ_{b}) potential is used and the dϕ_{η} integrals are evaluated. A coupling may be set such that λₛ=−m²ω² along with the condition that ηₜ_{ⱼ}²/(2βm³ω³)<<1 (for all j∈{1, . . . , N}), wherein the above simplifies to

$$\begin{matrix}{〈 {ϕ}_{{b}_{j}} 〉}_{th} = \frac{{e}^{{η}_{{t}_{j}}}}{{\sum }_{i = 1}^{N} {e}^{{η}_{{t}_{i}}}} \\ = Softmax ( {η}_{{t}_{i}} ) ,\end{matrix} \qquad ( eq . 49 )$$

which is the desired result. On the other hand, if the [symbol] oscillators are EOs with a time dependent mass or frequency, increasing mω after turning off their coupling with the intermediate estimator oscillators in FIG. 6 (e.g., intermediate oscillators 506 in FIG. 5A) can help ensure that the constraint ηₜ_{ⱼ}²/(2βm³ω³)<<1 is satisfied.

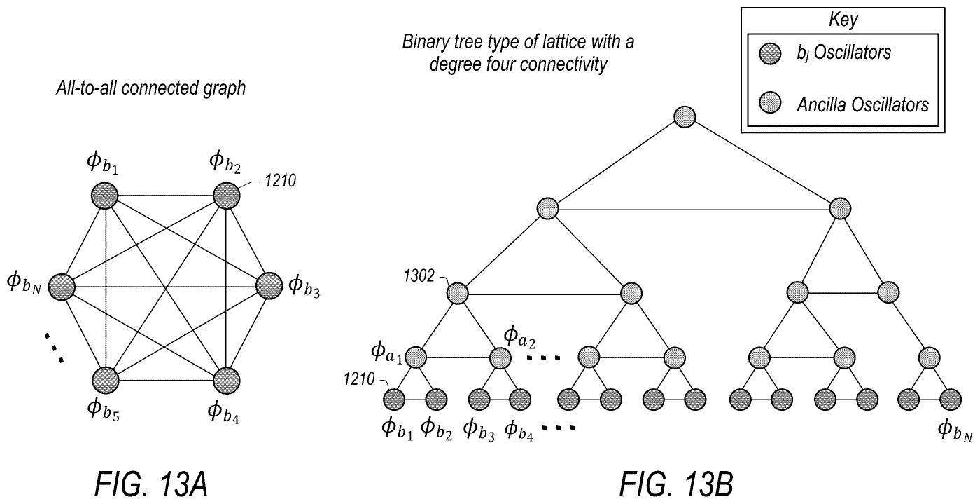

Thermodynamic chips 100, which may be a single thermodynamic chip or a set of connected thermodynamic chips, include oscillators that implement an energy-based model and an analog SoftMax gadget. For example, thermodynamic chip 100 implements energy-based model 1204 (e.g., linear layer 214 or dot product gadget network 602) that includes input oscillators 1206 and output oscillators 1208. There may also be hidden neurons (e.g., oscillators coupled to both the inputs and outputs, and which are coupled amongst each other) as shown in FIG. 31B. Also, thermodynamic chip 100 implements analog SoftMax gadget 1202 that includes input/output oscillators 1210 (and may optionally include additional ancilla oscillators, as shown in FIG. 13B). Note that for ease of explanation the couplings between input/output oscillators 1210 of analog SoftMax gadget 1202 are not shown in FIGS. 12A-12F, but it should be understood that the input/output oscillators 1210 may be configured in an all-to-all coupling arrangement as shown in FIG. 13A, or additional ancilla oscillators may be used to emulate an all-to-all coupling using a modified tree structure, as shown in FIG. 13B. While not shown, in some embodiments, energy-based model 1204 may include additional oscillators, such as non-visible neurons 3108 as shown in FIG. 31B. Also, energy-based model 1204 may include synapse oscillators (e.g. weights and bias oscillators), such as shown in FIGS. 32, 33, and 38.

The input/output oscillators 1210 of analog SoftMax gadget 1202 are configured, and initialized, in accordance with the engineered potential described above that ensures the input/output oscillators 1210 are dual well oscillators with well minima at zero and one, and further that the input/output oscillators 1210 are coupled in a configuration that ensures the overall sum of the input/output oscillators 1210 has an energy penalty for values that do not sum to one. This may be achieved by adjusting the A₁ and A₂ terms in the engineered potential V(ϕ_{b}_{₁}, . . . , ϕ_{b}_{_{N}})=A₁Σⱼ₌₁^{N}ϕ_{b}_{ⱼ}²(ϕ_{b}_{ⱼ}−1)²+A₂(Σⱼ₌₁^{N}ϕ_{b}_{ⱼ}−1)².

For example, inductor parameters, Josephson junction parameters, and capacitance parameters of the respective inductors, Josephson junctions and capacitors used to implement the respective input/output oscillators may be adjusted. For example, additional details regarding the components used to implement a respective oscillator, such as a respective input/output oscillator 1210 the analog SoftMax gadget 1202 are further discussed in FIG. 37. Also, the coupling strength between the input/output oscillators may be given by λₛ=−1/β, wherein β=1/K_{B}T, where K_{B} is the Boltzmann constant and T is temperature in Kelvin.

The energy-based model 1204 may thermodynamically evolve at time Ti prior to being coupled to analog SoftMax gadget 1202. For example, input data may be provided to energy-based model 1204 via input oscillators 1206 and the energy-based model may thermodynamically evolve such that output oscillators 1208 represent an output of the energy-based model 1204.

FIG. 12B illustrates the EBM and analog SoftMax gadget at a second moment in time, wherein the coupling has been performed, according to some embodiments.

At time T₂ the output oscillators 1208 of energy-based model 1204 may be coupled to the input/output oscillators 1210 of the analog SoftMax gadget 1202, for example via couplings 1212. Also, in some embodiments, relay oscillators may be used to relay the output values of energy-based model 1204 to the input/output oscillators 1210 of SoftMax gadget 1202. For example, FIG. 12D shows an arrangement with relay oscillators 1216. In such embodiments, the relay oscillators 1216 may first be coupled to output oscillators 1208 of energy-based model 1204, such that output values of the energy-based model are relayed to the relay oscillators 1216. The relay oscillators 1216 may then be coupled to the input/output oscillators 1210 of analog SoftMax gadget 1202. For example, the couplings 1212 may be couplings between relay oscillators 1216 and input/output oscillators 1210 (instead of couplings between output oscillators 1208 and input/output oscillators 1210). The couplings 1212 provide the input values e.g. ηⱼ, wherein the analog SoftMax gadget 1202 takes the argument ηⱼ encoded as position degrees of freedom (ϕ_{η}_{ⱼ}) of the output oscillators 1208 (or alternatively relay oscillators 1216) and returns the SoftMax result of this input argument, e.g. SoftMax(ηⱼ) in expectation value, wherein position degrees of freedom of the output oscillators of the SoftMax function at any given moment in time is represented by a one-hot encoded vector. Additional details regarding relay oscillator operation is provided below with regard to FIGS. 28-29. Also, additional details regarding how to determine synapse parameters (e.g., weights and biases) of an energy-based model, such as energy-based model 1204 are provided below with regard to FIGS. 32-33.

FIG. 12C illustrates the EBM and analog SoftMax gadget at a later moment in time, wherein the analog SoftMax gadget, coupled to the EBM, has thermodynamically evolved under an engineered potential of the analog SoftMax gadget such that the oscillators of the analog SoftMax gadget evolve to have values that encode a one-hot vector, which is the output of the SoftMax function when coupled with the output oscillators of the EBM, according to some embodiments.

At time T₃ the input/output oscillators 1210 of the analog SoftMax gadget 1202 have reached thermal equilibrium after evolving while being provided input thermodynamic information via couplings 1212. The input/output oscillators 1210 of the analog SoftMax gadget 1202 evolve based on the engineered potential which causes the input/output oscillators 1210 to reach a one-hot encoded vector state for the input/output oscillators 1210 at any given moment in time. Also, the measured expectation values of the input/output oscillators 1210 yield the result of the SoftMax function at thermal equilibrium. For example, the final values (V_{f}) of the input/output oscillators encode the one hot vector 1214 in their respective position degrees of freedom and measuring an expectation value of a given one of the input/output oscillators over a period of time at thermal equilibrium returns the SoftMax function result for that position of the input vector provided to the analog SoftMax gadget 1202.

FIG. 12D illustrates an example configuration wherein relay oscillators are used to provide an adjustable masses and/or frequencies that allow the output oscillators of the EBM to be treated as static when coupled with the analog SoftMax gadget, according to some embodiments.

As mentioned above, in some embodiments, input providing relay oscillators 1216 may be used to relay thermodynamic information to input/output oscillators 1210 of analog SoftMax gadget 1202. Additional details regarding the use of relay oscillators is provided in FIGS. 28-29. It should be understood that in some embodiments, the second energy-based model shown in FIGS. 28-29 could be an analog SoftMax gadget 1202. For example, the input providing relay oscillators 1216 may be used to hold respective output values of the output oscillators 1208 static. For example, input providing relay oscillators 1216 may be coupled to output oscillators 1208 with a small product of mass times frequency squared, such that a given input providing relay oscillator 2818 takes on a position degree of freedom value of a given output oscillator 1208. The mass and/or frequency values of the input providing relay oscillators 1216 may then be tuned to a larger value, such that the given input providing relay oscillator 1216 holds the relayed position degree of freedom value at a near static value while coupled to a given one of the input/output oscillators 1210 of the analog SoftMax gadget 1202.

FIG. 12E illustrates an additional example configuration wherein relay oscillators are used to provide adjustable masses and/or frequencies that allow the output oscillators of the EBM to be treated as static when coupled with the analog SoftMax gadget, and wherein additional relay gadgets are used to receive the result of the SoftMax function, implemented thermodynamically via the analog SoftMax gadget coupled to the EBM, wherein the additional relay gadgets store expectation values of the respective input/output oscillators of the analog SoftMax gadget, according to some embodiments.

In some embodiments, other relay oscillators may be used to accept the outputs of the input/output oscillators 1210 of the analog SoftMax gadget 1202. For example, single relay oscillators or relay gadgets comprising groups of relay oscillators may be coupled via couplings 1220 to input/output oscillators 1210 of analog SoftMax gadget 1202. For example, arrangements using single relay oscillators are shown in FIGS. 28-29. It should be understood that the first energy-based model discussed in FIGS. 28-29 could be an analog SoftMax gadget 1202, in some embodiments. In some embodiments, wherein the result receiving relay oscillator 1218 is a single relay oscillator, it may be used to sample the input/output oscillators 1210. In some embodiments, wherein the result receiving relay gadget 1218 is used, the result receiving relay gadget may include a group of relay oscillators configured to store expectation values of the input/output oscillators 1210 of analog SoftMax gadget 1202. For example, various configurations of relay gadgets are shown in FIGS. 30A-D and may be used as relay gadget 1218. It should be understood that in some embodiments, the first energy-based model discussed in FIGS. 30A-D may be an analog SoftMax gadget 1202.

FIG. 12F illustrates another example configuration wherein relay gadgets are used to receive the result of the SoftMax function, implemented thermodynamically via the analog SoftMax gadget coupled to the EBM, wherein the relay gadgets capture expectation values of the respective input/output oscillators of the analog SoftMax gadget, according to some embodiments.

Also, it should be noted that in some embodiments, relays or relay gadgets may be used to store output samples or expectation values of the input/output oscillators 1210 of analog SoftMax gadget 1202, without necessarily needing to use input providing relay oscillators, such as the input providing relay oscillators 1216 shown in FIGS. 12D and 1E.

FIG. 13A illustrates an example all-to-all coupling that may be used to couple input/output oscillators (<_{b}_{ⱼ}) of the analog SoftMax gadget to one another, according to some embodiments.

FIG. 13A shows an all-to-all connected graph which illustrates the coupling described by the potential in eq. 45. Having a high-degree connectivity graph for the potential in eq. 45 can be challenging for many hardware architectures. However, additional ancilla oscillators may be used to sparsify the graph. For instance, the graph may be converted into a binary tree, or a k-ary tree where k is the branching factor as illustrated in FIG. 13B.

In some embodiments, the relay oscillators 1210 of the analog SoftMax gadget 1202 may be coupled to one another in an all-to-all coupling as shown in FIG. 13A. However, in configurations with a large number of input/output oscillators, such an all-to-all configuration may be cumbersome to implement. Thus, as further described with regard to FIG. 13B, in some embodiments a constructive all-to-all coupling may be used, wherein additional ancilla oscillators are configured in a modified tree-structure to achieve a constructive all-to-all coupling between input/output oscillators 1210.

FIG. 13B illustrates another example coupling, wherein additional oscillators

$$( {ϕ}_{{a}_{j}^{( l )}} )$$

are used to emulate an all-to-all coupling between input/output oscillators (ϕ_{b}_{ⱼ}) of the analog SoftMax gadget, wherein the input/output oscillators (ϕ_{b}_{ⱼ}) and the additional oscillators

$$( {ϕ}_{{a}_{j}^{( l )}} )$$

have a reduced degree of connectivity as compared to input/output oscillators (ϕ_{b}_{ⱼ}) used in an all-to-all coupling for a similar sized array of input/output oscillators, such as shown in FIG. 13A, according to some embodiments.

FIG. 13B shows a binary tree type of lattice where the connectivity degree is four (since sibling nodes of a given parent are coupled to each other as well). Such a lattice is used to create the same constraints on the ϕ_{b}_{ⱼ} position degrees of freedom as in FIG. 13A. The oscillators 1210 correspond to the original ϕ_{b}_{ⱼ} oscillators and the ancilla oscillators 1302 correspond to the additional ancilla oscillators used to sparsify the connectivity graph.

In some embodiments, ancillas may be used to reduce the connectivity degree. For example, the potential used in eq. 45 requires an all to all coupling between the ϕ_{b}_{ⱼ} position degrees of freedom, as shown in FIG. 13A. The reason is due to the term proportional to (Σⱼ₌₁^{N}ϕ_{b}_{ⱼ}−1)² since expanding this term will result in a term proportional to Πⱼ₌₁^{N}ϕ_{b}_{ⱼ}. To reduce the degree of connectivity between the oscillators, ancillary oscillators may be added to form a graph resembling a k-ary tree (resembling since the graphs considered may have additional edges not found in a k-ary tree). In a k-ary tree, each node can have at most k children. When k=2, the resulting graph is a binary tree. An example is shown in FIG. 13B, where the graph has a binary tree structure, but is of degree four due to the coupling between sibling nodes. In some embodiments, couplings which satisfy the binary tree structure of degree four described above may be used. Such an architecture may be labeled as [symbol] where L>1 is the number of layers, and the superscript 4 indicated that the maximum connectivity degree of a given node is four. A similar analysis can be made when considering a k-ary tree for arbitrary k.

In some embodiments, the constraint imposed by the term A₂(Σⱼ₌₁^{N}ϕ_{b}_{ⱼ}−1)² can be achieved with a binary tree structure of degree four. For example, the position degree of freedom of the j'th ancilla oscillators in the l'th layer may be defined as ϕₐ_{ⱼ}^{(l)} (where j≥1). The layer containing the root node corresponds to l=1, the next layer corresponds to l=2 and so on. For the oscillator in the root node, the constraint A₂⁽¹⁾(ϕₐ_{₁}⁽¹⁾−1)² may be imposed for some large coupling parameter A₂⁽¹⁾. Such a constraint imposes a large energetic penalty if ϕₐ_{₁}⁽¹⁾ deviates from 1. Now in layer l, the position degrees of freedom of two sibling nodes may be labeled as

$${ϕ}_{{a}_{j , s}}^{( l )} and {ϕ}_{{a}_{( j + 1 ) , s}}^{( l )} .$$

The set of all siblings for the l>1 layer is labeled [symbol] Given two siblings

$${ϕ}_{{a}_{j , s}}^{( l )} and {ϕ}_{{a}_{( j + 1 ) , s}}^{( l )} .$$

the position degree of freedom of its parent node may be labeled as ϕₐ_{_{j,p}}^{(l-1)}. Given this notation, and for the [symbol] architecture, the following energy potential may be engineered

$$( eq . 50 )$$

$${V}_{{ℬ}_{ℒ}^{( 4 )}} = {{A}_{2}^{( 1 )} ( {ϕ}_{{a}_{1}}^{( 1 )} - 1 )}^{2} + {\sum }_{l = 2}^{L - 1} {\sum }_{j ∈ {𝒮}^{( l )}} {{A}_{2}^{( l )} ( {ϕ}_{{a}_{j , s}}^{( l )} + {ϕ}_{{a}_{( j + 1 ) , s}}^{( l )} - {ϕ}_{{a}_{j , p}}^{( l - 1 )} )}^{2} + {\sum }_{j ∈ {𝒮}^{( L )}} {{A}_{2}^{( L )} ( {ϕ}_{{b}_{j , s}}^{( L )} + {ϕ}_{{b}_{( j + 1 ) , s}}^{( L )} - {ϕ}_{{a}_{j , p}}^{( L - 1 )} )}^{2} ,$$

where in the last layer, the oscillators corresponding to the leaf nodes are the original Obj oscillators used for the Softmax gadget. The potential in eq. 50 adds an energetic penalty if the root node is not one. An energetic penalty is then added if the position degrees of freedom of the children of the root node don't sum to ϕₐ_{₁}⁽¹⁾ (which should be one). Such conditions are then added recursively until the leaf nodes are reached. Note that terms of the form

$${( {ϕ}_{{a}_{j , s}}^{( l )} + {ϕ}_{{a}_{( j + 1 ) , s}}^{( l )} - {ϕ}_{{a}_{j , p}}^{( l - 1 )} )}^{2}$$

require two sibling nodes to be coupled to each other (and not just to their parents), as is illustrated in FIG. 13B.

In some embodiments, the full potential in eq. 45 may be replaced with

$$( eq . 51 )$$

$$V ( {ϕ}_{{b}_{1}} , … , {ϕ}_{{b}_{N}} ) = {A}_{1} {\sum }_{j = 1}^{N} {{ϕ}_{{b}_{j}}^{2} ( {ϕ}_{{b}_{j}} - 1 )}^{2} + {V}_{{ℬ}_{L}^{( 4 )}} + {\sum }_{l = 2}^{L - 1} {\sum }_{j ∈ {𝒮}^{( l )}} {( {ϕ}_{{a}_{j , s}}^{( l )} )}^{2} {( {ϕ}_{{a}_{j , s}}^{( l )} - 1 )}^{2} + {( {ϕ}_{{a}_{1}}^{( 1 )} )}^{2} {( {ϕ}_{{a}_{1}}^{( 1 )} - 1 )}^{2} ,$$

where terms are added to the potential in eq. 51 to ensure that the oscillators ϕₐ_{₁}⁽¹⁾ and ϕₐ_{_{j,s}}^{(l)} take values that are zero or one. In some embodiments, a single coupling parameter may be used instead of the parameters A₁, A₂⁽¹⁾, A₂^{(l)} and so on. As long as such parameters are large enough, the energetic penalties will ensure that the ϕ_{b}_{ⱼ} oscillators take on the desired values.

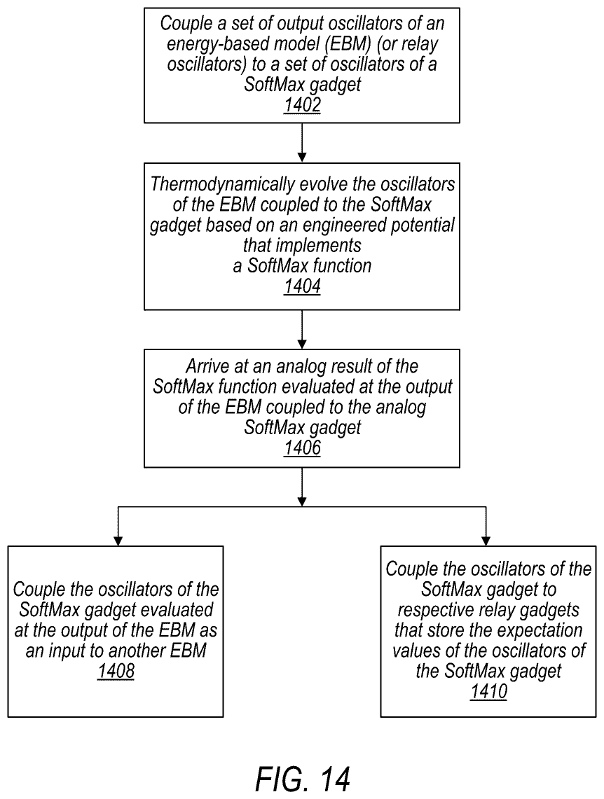

FIG. 14 is a flowchart illustrating a process for implementing a SoftMax function using an analog SoftMax gadget, according to some embodiments.

At block 1402, a set of output oscillators of an energy-based model (or relay oscillators) are coupled to a set of input/output oscillators of an analog SoftMax gadget. Then, at block 1404, the oscillators (including the input-output oscillators and ancilla oscillators (if used)) are allowed to thermally evolve, e.g. to reach a thermal equilibrium. This evolution is performed based on an engineered potential for the analog SoftMax gadget which creates energetic penalties that drive the oscillators to thermodynamically evolve to a one-hot encoded vector state (e.g., one input/output oscillator having a position degree of freedom value of one, and all other input/output oscillators having a position degree of freedom value of zero). For example, at block 1406 (after the thermal evolution) the input/output oscillators of the analog SoftMax gadget arrive at an analog result of the SoftMax function that comprises a one hot encoded vector at the input/output oscillators of the analog SoftMax gadget.

At block 1408, the input/output oscillators of the analog SoftMax gadget are coupled to another EBM or other device that is to receive the result of the SoftMax function. This could be another EBM, relay oscillators, measurement, etc.

As another alternative, at block 1410 the input/output oscillators of the analog SoftMax gadget are coupled to relay gadgets, such as shown in FIGS. 12E and 12F, wherein the relay gadgets have any of the configurations shown in FIGS. 30A-D. The relay gadgets store respective expectation values of the input/output oscillators of the analog SoftMax gadget.

### Swish Activation Function

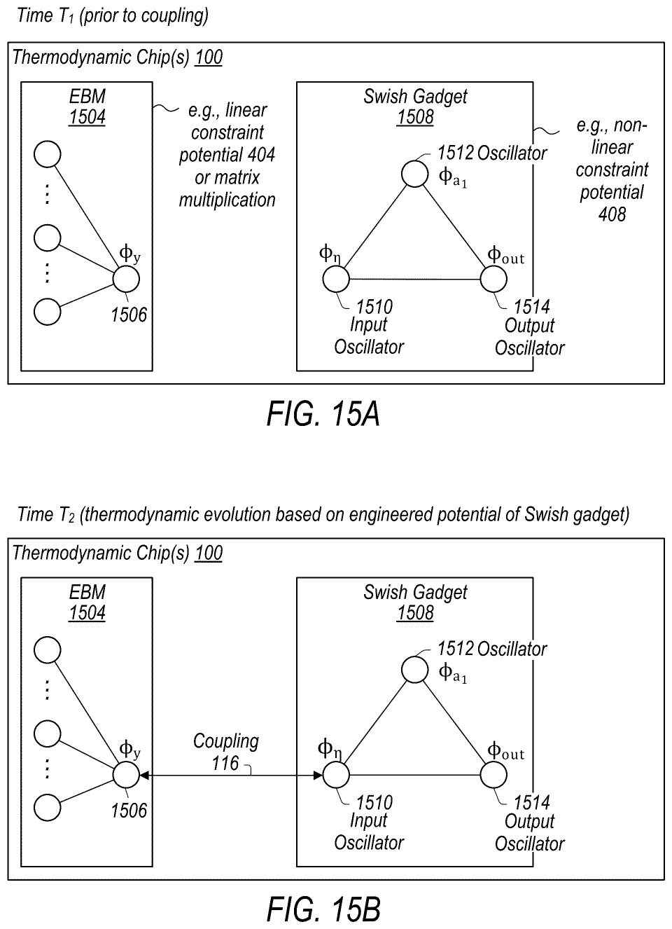

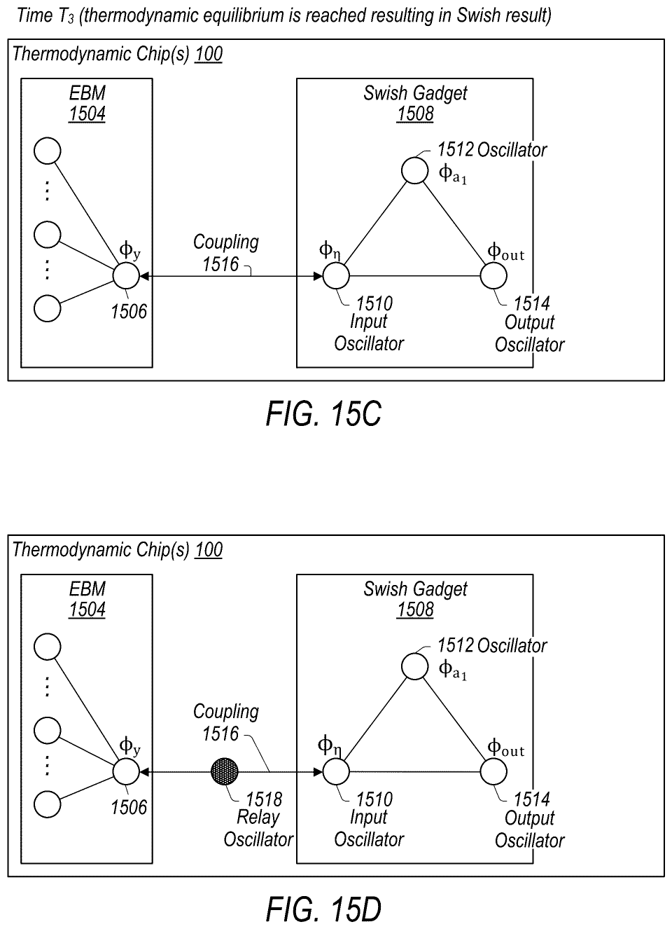

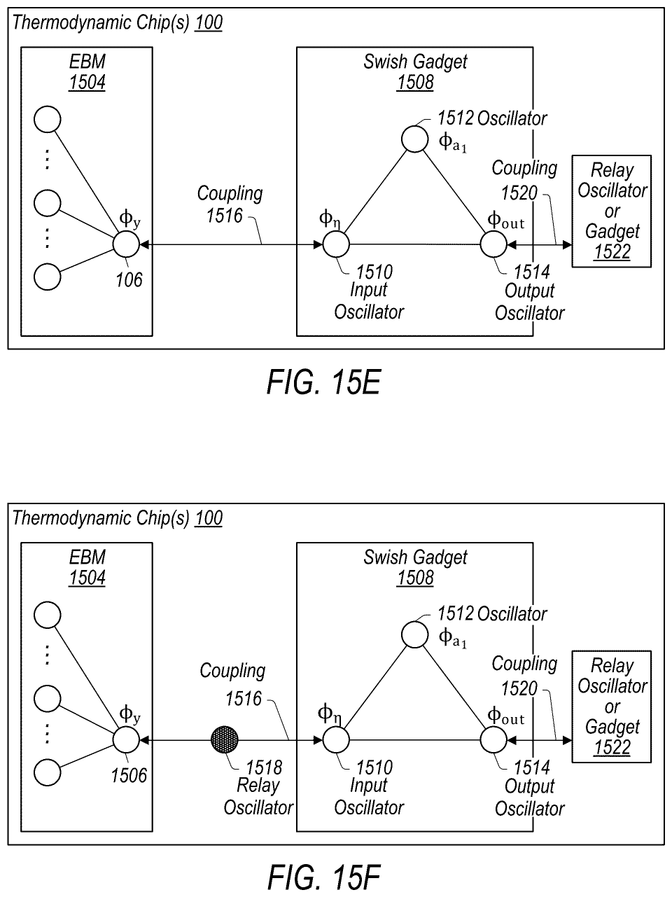

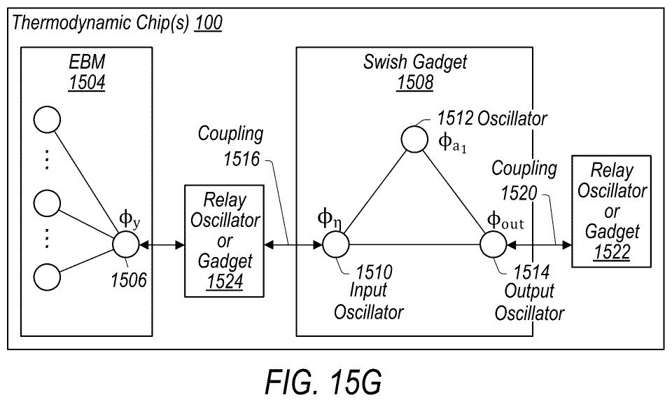

FIG. 15A is high-level diagram illustrating an energy-based model (EBM) implemented using a thermodynamic chip and an analog Swish gadget implemented using a thermodynamic chip, wherein the EBM and analog Swish gadget are shown at a first moment in time (e.g. prior to a coupling between oscillators of the Swish gadget and oscillators of the EBM), wherein the coupling (performed directly or via relay oscillators) provides input values for a Swish function that is performed thermodynamically, according to some embodiments.

In some embodiments a swish gadget 1508 (e.g., non-linear constraint potential 408) may comprise a set of oscillators of one or more thermodynamic chips configured to perform a Swish function. The set of oscillators may comprise an input oscillator 1510, an output oscillator 1514, and one or more additional oscillators (e.g., oscillator 1512). To perform the Swish function, the set of oscillators may be configured to obtain thermodynamic information on the input oscillator, couple to each other to implement an engineered potential, wherein the engineered potential thermodynamically implements the Swish function, and thermodynamically evolve based on the engineered potential. In some embodiments, the thermodynamic evolution based on the engineered potential causes the output oscillator to obtain a result of the Swish function based on input provided to the input oscillator.

The swish activation function may be defined by the formula

$$Swish ( η ) = η σ ( αη ) , \qquad ( eq . 52 )$$

where η is the input to the function, σ(η) is the sigmoid function which may be defined by

$$σ ( η ) = \frac{1}{1 + {e}^{- η}} , \qquad ( eq . 53 )$$

and α is a parameter that can be learned or set as a constant. When α is set as a constant, a typical choice is to use α=1.

In some embodiments, a potential energy function which implements the swish activation function in eq. 52 may be given by

$${V}_{swish} ( {ϕ}_{s} , {ϕ}_{y} , η ) = {λ}_{1} {{ϕ}_{s}^{2} ( {ϕ}_{s} - 1 )}^{2} + {λ}_{2} {ϕ}_{s} η + \frac{1}{2} {m}_{y} {ω}_{y}^{2} {ϕ}_{y}^{2} + {λ}_{3} {ϕ}_{y} {ϕ}_{s} η , \qquad ( eq . 54 )$$

where η may be treated as a constant. The output oscillator is labeled as ϕ_{y}. With the condition λ₁>>1, the expectation value of ϕ_{y} may be given by

$$( {ϕ}_{y} 〉 = - \frac{{λ}_{3} η}{{m}_{y} {ω}_{y}^{2}} \frac{1}{1 + {e}^{- \frac{β η}{2} ( - 2 {λ}_{2} + \frac{η {λ}_{3}^{2}}{{m}_{y} {ω}_{y}^{2}} )}} . \qquad ( eq . 55 )$$

If a coupling is set to

$${λ}_{3} = - {m}_{y} {ω}_{y}^{2} , {λ}_{2} = - \frac{1}{β}$$

and use the condition that

$${m}_{y} {ω}_{y}^{2} ≪ \frac{2}{β {η}^{2}} ,$$

then [symbol] ϕ_{y} [symbol] reduces to the swish activation function.

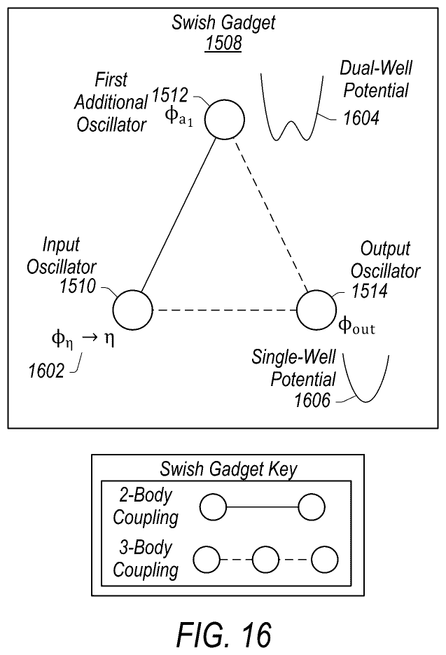

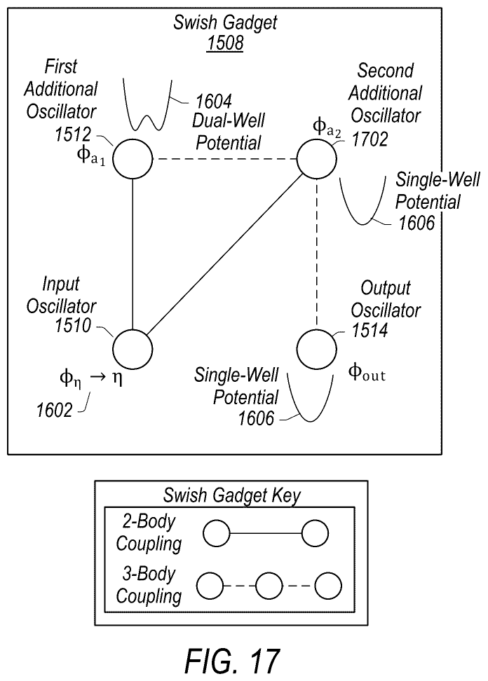

Thermodynamic chips 100, which may be a single thermodynamic chip or a set of connected thermodynamic chips, that include oscillators that implement an energy-based model and an analog Swish gadget. For example, thermodynamic chip 100 implements energy-based model 1504 (e.g., linear constraint potential 404 or matrix multiplication) that includes input oscillators and an output oscillator 1506. There may also be hidden neurons (e.g., oscillators coupled to both the inputs and outputs in one or more layers, and which are coupled amongst each other) as shown in FIG. 31B. EBM 1504 may be a component of a transformer neural network architecture such as described herein. Also, thermodynamic chip 100 implements analog Swish gadget 1508 that includes input oscillator 1510, output oscillator 1514, and additional oscillator 1512. Note that among possible arrangements of oscillators of the Swish gadget 1508, an embodiment of a Swish gadget with a first additional oscillator is shown in FIG. 16 and an embodiment of a Swish gadget with a first and second additional oscillators is shown in FIG. 17. While not shown, in some embodiments, energy-based model 1504 may include additional oscillators, such as non-visible neurons 3108 as shown in FIG. 31B. Also, energy-based model 1504 may include synapse oscillators (e.g. weights and bias oscillators), such as shown in FIGS. 32, 33, and 38.

The oscillators of analog Swish gadget 1508 (e.g., oscillators 1510, 1512, and 1514) are configured, and initialized, in accordance with an engineered potential such as described above are shown in more detail in FIGS. 16 and 17.

For example, inductor parameters, Josephson junction parameters, and capacitance parameters of the respective inductors, Josephson junctions and capacitors used to implement the respective oscillators may be adjusted. For example, additional details regarding the components used to implement a respective oscillator, such as a respective oscillator 1510, 1512, and 1514 of the analog Swish gadget 1508 are further discussed in FIG. 37. Also, the coupling strength between the oscillators may be given by λₛ=−1/β, wherein β=1/K_{B}T, where K_{B} is the Boltzmann constant and T is temperature in Kelvin.

The energy-based model 1504 may thermodynamically evolve at time Ti prior to being coupled to analog Swish gadget 1508. For example, input data may be provided to energy-based model (EBM) 1504 via one or more output oscillators of the energy-based model and the energy-based model may thermodynamically evolve such that output oscillator 1506 represent an output of the energy-based model 1504.

FIG. 15B illustrates the EBM and analog Swish gadget at a second moment in time, wherein a coupling to thermodynamically transfer an input value to an oscillator of the Swish gadget has been performed, according to some embodiments.

At time T₂ the output oscillator 1506 of energy-based model 1504 may be coupled to the input oscillator 1510 of the analog Swish gadget 1508, for example via coupling 1516. Also, in some embodiments, relay oscillators may be used to relay the output values of energy-based model 1504 to the input oscillator 1510 of Swish gadget 1508. For example, FIG. 15D shows an arrangement with relay oscillator 1518. In such embodiments, the relay oscillator 1518 may first be coupled to output oscillator 1506 of energy-based model 1504, such that output values of the energy-based model are relayed to the relay oscillator 1518. The relay oscillator 1518 may then be coupled to the input oscillator 1510 of analog Swish gadget 1508. For example, coupling 1516 may be coupling between relay oscillator 1518 and input oscillator 1510 (instead of couplings between output oscillators 106 and input oscillators 1510). The coupling 1516 may provide the input values e.g. η, wherein the analog Swish gadget 1508 takes the argument 1j encoded as position degrees of freedom (p) of the output oscillators 1506 (or alternatively relay oscillators 1518) and returns the Swish result of this input argument, e.g. Swish(I) in expectation value. Additional details regarding relay oscillator operation are provided below with regard to FIGS. 28-29. Also, additional details regarding how to determine synapse parameters (e.g., weights and biases) of an energy-based model, such as energy-based model 1504, are provided below with regard to FIGS. 32-33.

FIG. 15C illustrates the EBM and analog Swish gadget at a later moment in time, wherein the analog Swish gadget, uncoupled from the EBM, has thermodynamically evolved under an engineered potential of the analog Swish gadget such that respective oscillators of the analog Swish gadget evolve to have a value that encodes the output of the Swish function, according to some embodiments.

At time T₃ the oscillators of the analog Swish gadget 1508 have reached thermal equilibrium after evolving based on the input thermodynamic information and the engineered potential that implements the Swish function. The oscillators (e.g., oscillators 1510, 1512, and 1514) of the analog Swish gadget 1508 evolve based on the engineered potential which causes the output oscillator of the Swish gadget to obtain the result of the Swish function. Thus, the measured expectation values of the output oscillator 1514 yield the result of the Swish function as thermal equilibrium. For example, the final value of the output oscillator 1514 encodes the result of the Swish function in its position degree of freedom, and measuring an expectation value of the output oscillators over a period of time at thermal equilibrium returns the Swish function result for a given input provided to the analog Swish gadget 1508.

FIG. 15D illustrates an example configuration wherein a relay oscillator is used to provide an adjustable mass and/or frequency that allows the output oscillator of the EBM to be treated as static when coupled with the analog Swish gadget, according to some embodiments.

As mentioned above, in some embodiments, input providing relay oscillator 1518 may be used to relay thermodynamic information to input oscillator 1510 of analog Swish gadget 1508. Additional details regarding the use of relay oscillators are provided in FIGS. 28-29. It should be understood that in some embodiments, the second energy-based model shown in FIGS. 28-29 could be analog Swish gadget 1508. For example, the input providing relay oscillator 1518 may be used to hold output values of the output oscillator 1506 of EBM 1504 static. For example, input providing relay oscillator 1518 may be coupled to output oscillator 1506 with a small product of mass times frequency squared, such that input providing relay oscillator 1518 takes on a position degree of freedom value of output oscillator 1506. The mass and/or frequency values of the input providing relay oscillator 1518 may then be tuned to a larger value, such that the input providing relay oscillator 1518 holds the relayed position degree of freedom value at a near static value while coupled to input oscillator 1510 of the analog Swish gadget 1508.

FIG. 15E illustrates an additional example configuration wherein the output of the EBM is directly coupled to the input of the Swish gadget, and wherein a relay gadget is used to receive the result of the Swish function, implemented thermodynamically via the analog Swish gadget coupled to the EBM, wherein the relay gadget stores an expectation value of the respective input/output oscillators of the analog Swish gadget, according to some embodiments.

In some embodiments, other relay oscillators may be used to accept the outputs of output oscillator 1514 of the analog Swish gadget 108. For example, single relay oscillators or relay gadgets comprising groups of relay oscillators (e.g., relay oscillator or gadget 1522) may be coupled via couplings 1520 to output oscillators 1514 of analog Swish gadget 1508. For example, arrangements using single relay oscillators are shown in FIGS. 28-29. It should be understood that the first energy-based model discussed in FIGS. 28-29 could be an analog Swish gadget 1508, in some embodiments. In some embodiments, wherein the result receiving relay oscillator 1522 is a single relay oscillator, it may be used to sample the output oscillator 1514. In some embodiments, wherein the result receiving relay gadget 1522 is used, the result receiving relay gadget may include a group of relay oscillators configured to store expectation values of output oscillator 1514 of analog Swish gadget 1508. For example, various configurations of relay gadgets are shown in FIGS. 30A-D and may be used as relay gadget 1522. It should be understood that in some embodiments, the first energy-based model discussed in FIGS. 30A-D may be an analog Swish gadget 1506.

FIG. 15F illustrates another example configuration wherein a relay oscillator is used to provide an adjustable mass and/or frequency that allows the output oscillator of the EBM to be treated as static when coupled with the analog Swish gadget, and wherein a relay gadget is used to receive the result of the Swish function, implemented thermodynamically via the analog Swish gadget coupled to the EBM, wherein the relay gadget stores an expectation value of the respective input/output oscillators of the analog Swish gadget, according to some embodiments.

Also, it should be noted that in some embodiments, relays or relay gadgets may be used to store output samples or expectation values of the output oscillator 1514 of analog Swish gadget 1508, using a relay oscillator 1518 such as shown in FIG. 15F or without necessarily needing to use input providing relay oscillators, such as shown in FIG. 15E.

FIG. 15G illustrates another example of configuration wherein an additional relay gadget is used to provide one or more adjustable masses and/or frequencies that allow the output oscillator of the EBM to be treated as static when coupled with the analog Swish gadget, and wherein a relay gadget is used to receive the result of the Swish function, implemented thermodynamically via the analog Swish gadget coupled to the EBM, wherein the relay gadget stores an expectation value of the respective input/output oscillators of the analog Swish gadget, according to some embodiments.

Also, it should be noted that in some embodiments, relays or relay gadgets may be used to store output samples or expectation values of the output oscillator 1514 of analog Swish gadget 1508, using a relay gadget 1524, similar to relay gadget 1522, instead of relay oscillator 1518 as in FIGS. 15D and 15F.

FIG. 16 illustrates an example of a Swish gadget comprising an input oscillator treated as static, an additional oscillator with a dual-well potential, and an output oscillator with a single-well potential, wherein the couplings between the oscillators comprise a two-body coupling and a three-body coupling, according to some embodiments.

An example embodiment of Swish gadget 1508 is illustrated in FIG. 16. In such an embodiment, Swish gadget 1508 comprises input oscillator 1510 with positional degree of freedom ϕ_{η}, first additional oscillator 1512 with positional degree of freedom ϕₐ_{₁}, and output oscillator 1514 with positional degree of freedom ϕₒᵤₜ. Input oscillator ϕ_{η} 1510 can be configured to be held substantially fixed at input value η which is, for example, the output of EBM 1504. To hold input oscillator ϕ_{η} 1510 substantially fixed at η, the mass and or frequency of input oscillator ϕ_{η} 1510 may be adjusted relative to first additional oscillator 1512 and output oscillator 1514 such that a product of mass and frequency squared is much larger than a product of mass and frequency squared of either of the other oscillators. In such an embodiment, input oscillator ϕ_{η} 1510 may be similar to a relay oscillator such as described in FIGS. 28-29. In other embodiments, input oscillator ϕₙ 1510, first additional oscillator ϕₐ_{₁} 1512, and output oscillator ϕₒᵤₜ 1514 may respectively have fixed mass and frequencies, wherein the relative mass and frequencies of the oscillators are configured such that input oscillator ϕₙ is substantially static compared to the other oscillators. In such an embodiment, relay oscillator 1518 or relay gadget 1524 may be used to relay thermodynamic information (e.g., input η) from EBM 1504 to Swish gadget 1508.

The example Swish gadget 1508 in FIG. 16 illustrates example oscillators and couplings between oscillators of a Swish gadget 1508 that implement an engineered potential such as the engineered potential below. The engineered potential used in such an embodiment may be written as

$${V}_{s w i s h} ( {ϕ}_{s} , {ϕ}_{t} , η ) = {λ}_{1} {{ϕ}_{s}^{2} ( {ϕ}_{s} - 1 )}^{2} + {λ}_{2} {ϕ}_{s} η + \frac{1}{2} {m}_{t} {ω}_{t}^{2} {ϕ}_{t}^{2} + {λ}_{3} {ϕ}_{t} {ϕ}_{s} η$$

wherein ϕₛ is a first additional oscillator such as first additional oscillator ϕₐ_{₁} 1512, ϕₜ is an output oscillator such as output oscillator ϕₒᵤₜ 1514, and η is an input value such as obtained by input oscillator ϕₙ 1510, λ₁ is a first coupling parameter for ϕₛ, λ₂ is a second coupling parameter for ϕₛ and η, and λ₃ is a third coupling parameter for ϕₛ, η, and ϕₜ. Note that the potential V_{swish} immediately above is one example of a potential with oscillators and couplings that thermodynamically evolve to encode the output of a Swish function to an output oscillator. Other potentials may be used that substantially enable the oscillators to evolve thermodynamically, wherein the thermodynamic evolution encodes the output of a Swish function onto an oscillator. For example, the output oscillator of the Swish gadget 1508 that encodes the output of the Swish function may be extracted thermodynamically via a relay oscillator or gadget 1512 (e.g., by thermodynamically obtaining the expectation value of the output oscillator). Obtaining an expectation value is described in more detail in FIGS. 30A-D, wherein the Swish gadget 1508 may be understood to be represented by first energy-based model 2800.

In some embodiments such as shown in FIG. 16, input oscillator 1510 may be held substantially fixed at an input value 1602, wherein the input value is thermodynamic information that represents input to the Swish function. First additional oscillator 1512 may be an oscillator with a dual-well potential 1604, wherein an energetic penalty is implemented for positional degrees of freedom that are further away from binary values such as a 0 and 1. Output oscillator 1514 may be an oscillator with a single-well potential 1606, wherein an energetic penalty is implemented for positional degrees of freedom that are further away from a value such as 0. The oscillators that comprise Swish gadget 1508 may be coupled in a configuration that implements an engineered potential, wherein the engineered potential thermodynamically implements the Swish function. For example, the dual-well potential 1604 may be implemented to first additional oscillator 1512 with coupling parameter λ₁ that corresponds to the term λ₁ϕₛ²(ϕₛ−1)² in the above equation. A two-body coupling may be implemented between input oscillator 1510 and first additional oscillator 1512 with coupling parameter λ₂ that corresponds to the term λ₂ϕₛη in the above equation. Furthermore, a three-body coupling may be implemented between input oscillator 1510, first additional oscillator 1512, and output oscillator 1514 with coupling parameter λ₃ that correspond to the term λ₃ϕₜϕₛη in the above equation. Oscillators may be configured in hardware such as described in FIGS. 37-38.

FIG. 17 illustrates another example of a Swish gadget comprising an input oscillator treated as static, a first additional oscillator with a dual-well potential, a second additional oscillator with a single-well potential, and an output oscillator with a single-well potential, wherein the couplings between the oscillators comprise two two-body coupling and a three-body coupling, according to some embodiments.

Another example embodiment of Swish gadget 1508 is illustrated in FIG. 17. In such an embodiment, Swish gadget 1508 comprises input oscillator ϕ_{η} 1510, first additional oscillator ϕₐ_{₁} 1512, second additional oscillator ϕₐ_{₂} 1702 representing a multiplicative factor, and output oscillator ϕₒᵤₜ 1514. The example Swish gadget 1508 in FIG. 17 illustrates example oscillators and couplings between oscillators of a Swish gadget 1508 that implement an engineered potential such as the engineered potential below. The engineered potential used in such an embodiment may be written as

$${V}_{s w i s h} ( {ϕ}_{s} , {ϕ}_{t} , {ϕ}_{f} , η ) = {λ}_{1} {{ϕ}_{s}^{2} ( {ϕ}_{s} - 1 )}^{2} + {λ}_{2} {ϕ}_{s} η + \frac{1}{2} {m}_{t} {ω}_{t}^{2} {ϕ}_{t}^{2} + {λ}_{3} {ϕ}_{t} η + \frac{1}{2} {m}_{f} {ω}_{f}^{2} {ϕ}_{f}^{2} + {λ}_{4} {ϕ}_{s} {ϕ}_{t} {ϕ}_{f} ,$$

wherein ϕₛ is a first additional oscillator such as first additional oscillator ϕₐ_{₁} 1512, ϕₜ is a second additional oscillator such as second additional oscillator ϕₐ_{₂} 1702, ϕ_{f} is an output oscillator such as output oscillator ϕₒᵤₜ 1514, and η is an input value such as obtained by input oscillator ϕₙ 1510, λ₁ is a first coupling parameter for ϕₛ, λ₂ is a second coupling parameter for ϕₛ and η, λ₃ is a third coupling parameter for ϕₜ and η, and λ₄ is a fourth coupling parameter for ϕₛ, ϕₜ, and ϕ_{f}. Note that the potential V_{swish} immediately above is another example of a potential with oscillators and couplings that thermodynamically evolve to encode the output of a Swish function to an output oscillator. Other potentials may be used that substantially enable the oscillators to evolve thermodynamically, wherein the thermodynamic evolution encodes the output of a Swish function onto an oscillator. For example, the output oscillator 1514 of the Swish gadget 1508 that encodes the output of the Swish function may be extracted thermodynamically via a relay oscillator or gadget 1512 (e.g., by thermodynamically obtaining the expectation value of the output oscillator). Obtaining an expectation value is described in more detail in FIGS. 30A-D, wherein the Swish gadget 1508 may be understood to be represented by first energy-based model 2800.

In some embodiments such as shown in FIG. 17, input oscillator 1510 may be held substantially fixed at an input value 1602, wherein the input value is thermodynamic information that represents input to the Swish function. First additional oscillator 1512 may be an oscillator with a dual-well potential 1604, wherein an energetic penalty is implemented for positional degrees of freedom that are further away from binary values such as a 0 and 1. Second additional oscillator 1702 may be an oscillator with a single-well potential 1606, wherein an energetic penalty is implemented for positional degrees of freedom that are further away from a value such as 0. Output oscillator 1514 may be an oscillator with a single-well potential 1606, wherein an energetic penalty is implemented for positional degrees of freedom that are further away from a value such as 0. The oscillators that comprise Swish gadget 1508 may be coupled in a configuration that implements an engineered potential, wherein the engineered potential thermodynamically implements the Swish function. For example, the dual-well potential 1604 may be implemented to first additional oscillator 1512 with coupling parameter λ₁ that corresponds to the term λ₁ϕₛ²(ϕₛ−1)² in the above equation. A two-body coupling may be implemented between input oscillator 1510 and first additional oscillator 1512 with coupling parameter λ₂ that corresponds to the term λ₂ϕₛη in the above equation. Another two-body coupling may be implemented between input oscillator 1510 and second additional oscillator 1702 with coupling parameter λ₃ that corresponds to the term λ₃ϕₜη in the above equation. Furthermore, a three-body coupling may be implemented between first additional oscillator 1512, second additional oscillator 1702, and output oscillator 1514 with coupling parameter λ₄ that correspond to the term λ₄ϕₛϕₜϕ_{f} in the above equation. Oscillators may be configured in hardware such as described in FIGS. 37-38. Note that other potentials may use such as potentials with more or fewer oscillators and potentials with other coupling arrangements (e.g., four-body coupling) to thermodynamically implement the Swish function.

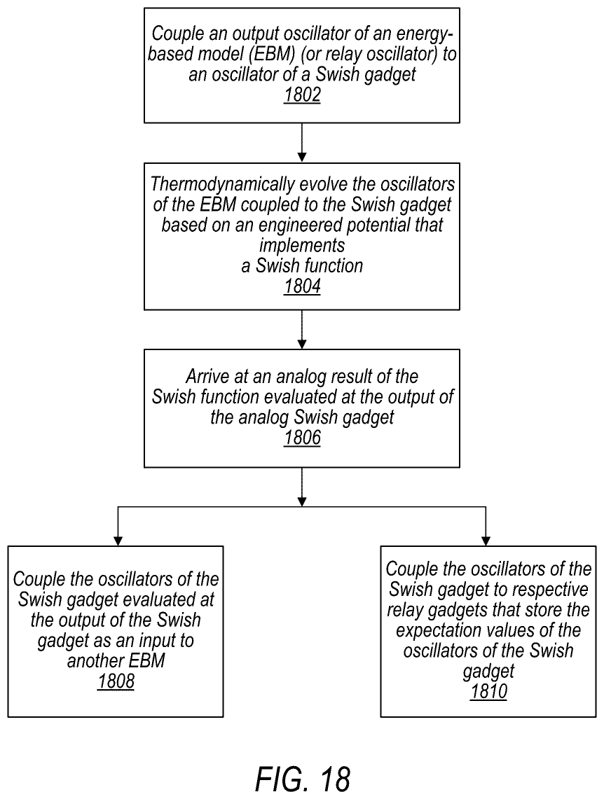

FIG. 18 is a flowchart illustrating a process for implementing a Swish function using an analog Swish gadget, according to some embodiments.

At block 1802, an output oscillator of an energy-based model (or relay oscillator) is coupled to an input oscillator of an analog Swish gadget. Then, at block 1804, the oscillators (including the input oscillator, output oscillator, and one or more additional oscillators (if used)) are allowed to thermally evolve, e.g. to reach a thermal equilibrium. This evolution is performed based on an engineered potential for the analog Swish gadget which creates energetic penalties that drive the oscillators to thermodynamically evolve to the output of the Swish function (e.g., an output oscillator having a thermodynamic information corresponding to the output of the Swish function). For example, at block 1806 (after the thermal evolution) the output oscillator of the analog Swish gadget arrives at an analog result of the Swish function.

At block 1808, the output oscillator of the analog Swish gadget is coupled to another EBM or other device that is to receive the result of the Swish function. This could be another EBM, relay oscillators, measurement, etc.

As another alternative, at block 1810 the output oscillator of the analog Swish gadget is coupled to a relay gadget, such as shown in FIGS. 15E, 15F and 15G, wherein the relay gadget can have any of the configurations shown in FIGS. 30A-D. The relay gadget stores respective expectation values of the output oscillator of the analog Swish gadget.

### Attention Layer

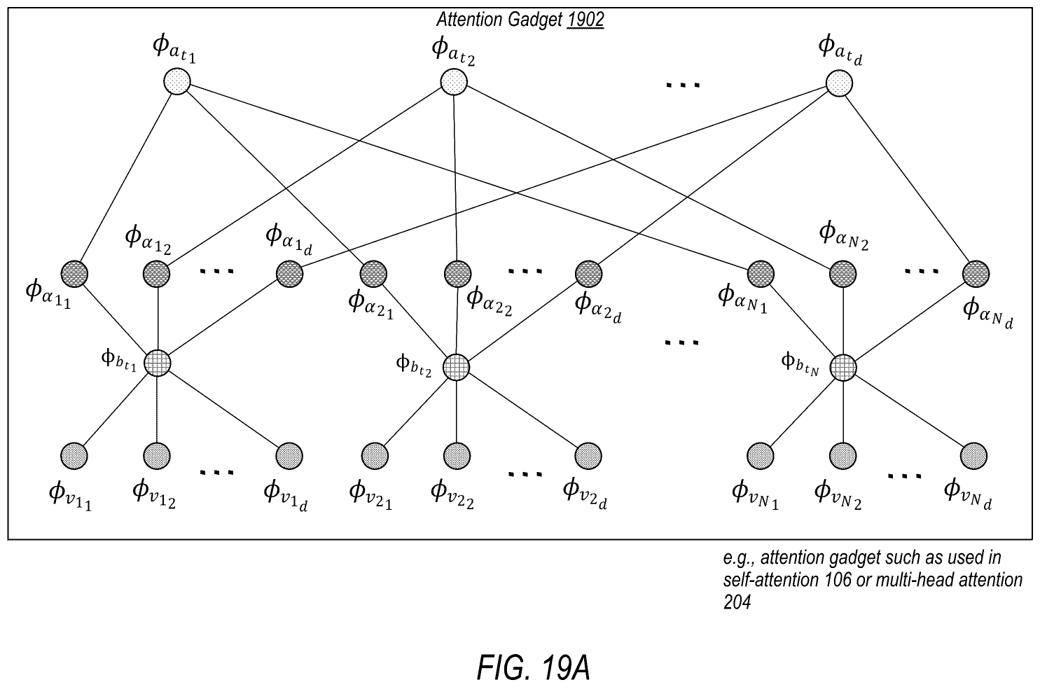

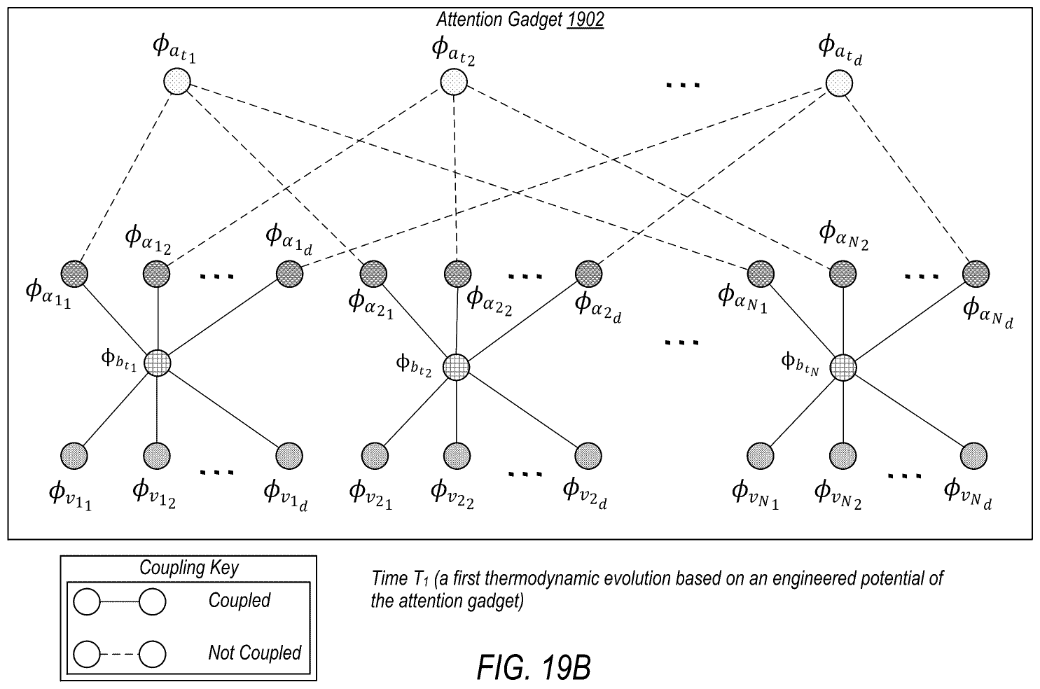

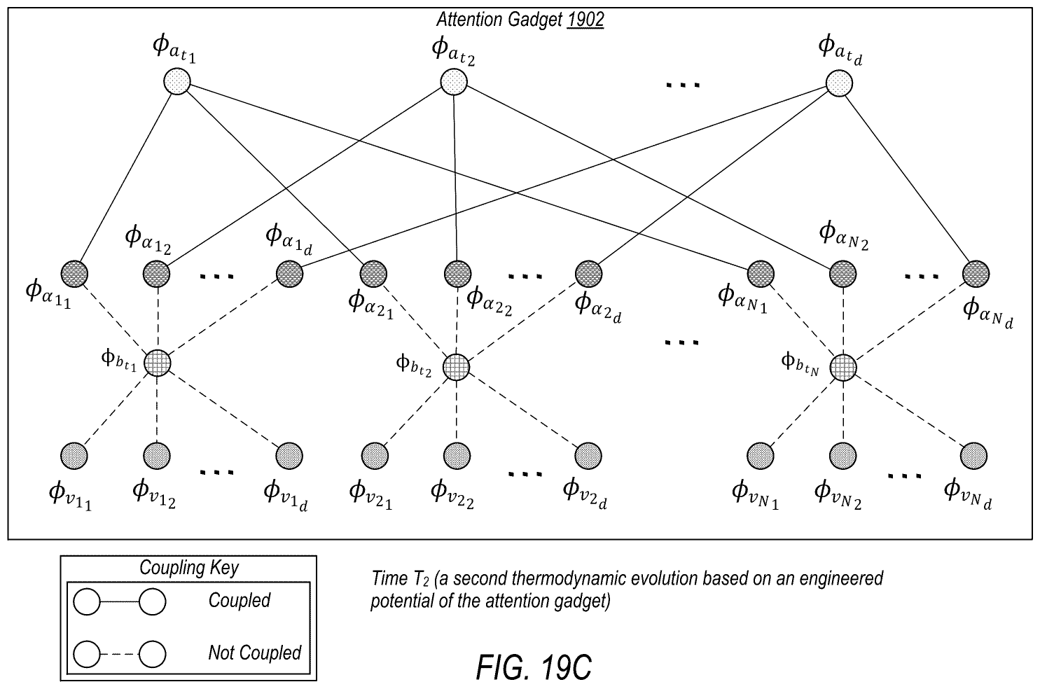

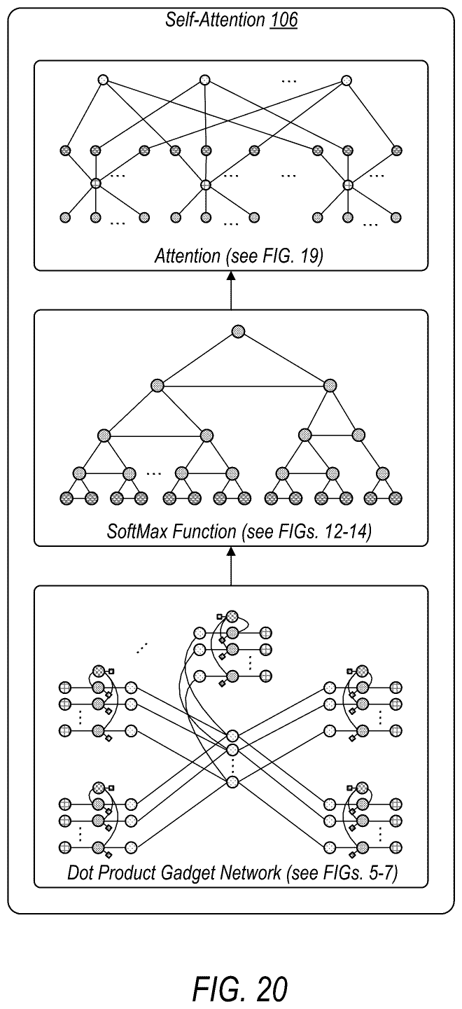

FIG. 19A illustrates an analog attention gadget implemented on one or more thermodynamic chips comprising oscillators, according to some embodiments.

In some embodiments, a component of a transformer neural network architecture may be an attention layer gadget. The attention layer gadget may comprise a SoftMax gadget (e.g., see FIGS. 12A-14) and a set of oscillators of one or more thermodynamic chips. Furthermore, the attention layer gadget may be configured to perform an attention operation. The attention operation may be performed by coupling the SoftMax gadget to the set of oscillators to implement an engineered potential, wherein the engineered potential thermodynamically implements the attention operation. Then a thermodynamic evolution may be based on the engineered potential. The thermodynamic evolution based on the engineered potential may cause output oscillators of the set of oscillators to obtain results of the attention operation.

FIG. 19A shows an example configuration of an attention gadget 1902 used to compute attn(t) from eq. 5 using coupled harmonic oscillators. The potential for the oscillators whose position degree of freedom is labeled ϕ_{b}_{₁} to ϕ_{b}_{_{N}} is described in FIGS. 12A-14 (see eq. 45 and eq. 51) and was used to create the SoftMax gadget (a subscript t is added to the b oscillators to indicate that they are used for the t'th attention layer). The full coupling between the oscillators labeled with the subscripts b, v and α is given in eq. 56. To get the full attention attn(t) for layer t, oscillators are added whose position degrees of freedom are labeled

$${ϕ}_{{a}_{{t}_{1}}} to {ϕ}_{{a}_{{t}_{d}}}$$

and which are coupled to the

$${ϕ}_{{α}_{{i}_{j}}}$$

oscillators as described in eq. 63 (note the “a” letter subscript versus the “α” Greek letter subscript). There may be a total of N blocks of the gadget presented in this figure, since t∈{1, . . . , N}.

In some embodiments, an attention layer may be obtained by coupling harmonic oscillators with those used in the SoftMax gadget described herein. For example, the average position of the coupled oscillator at thermal equilibrium may be given by eq. 5 and eq. 6.

In some embodiments, the position degree of freedom of the oscillator which encodes the k'th element of the vector vᵢ in eq. 3 may be labeled as

$${ϕ}_{{v}_{{i}_{k}}} .$$

Given this notation, the following potential may be utilized

$${V}_{a}^{( i )} = V ( {ϕ}_{b} ) + {λ}_{s} {\sum }_{j = 1}^{N} {ϕ}_{{b}_{j}} {ϕ}_{{η}_{{t}_{j}}} + \frac{1}{2} {m}_{α} {ω}_{α}^{2} {\sum }_{j = 1}^{d} {ϕ}_{{α}_{{i}_{j}}}^{2} + {λ}_{c} {ϕ}_{{b}_{i}} {\sum }_{k = 1}^{d} {ϕ}_{{v}_{{i}_{k}}} {ϕ}_{{α}_{{i}_{k}}} , \qquad ( eq . 56 )$$

where the oscillators ϕ_{ηt}_{ⱼ} may be approximately static at their equilibrium values since they are EO oscillators. Furthermore, the ϕᵥᵢ_{ⱼ} oscillators may be treated as EOs being approximately static at their equilibrium values given by the value vectors vᵢ_{ⱼ}. The term V(ϕ_{b}) in eq. 56 is given by eq. 45 (or alternatively eq. 51 if an ancillary system is used). The second term

$${λ}_{s} {\sum }_{j = 1}^{N} {ϕ}_{{b}_{j}} {ϕ}_{{η}_{{t}_{j}}}$$

is obtained from eq. 43. As such, the first two terms in Vₐ corresponds to the Hamiltonian used for the Softmax gadget. The oscillators whose position degrees of freedom are labeled ϕ_{α}_{ⱼ} are used to encode the resulting values of an attention layer, as will be demonstrated below. Lastly, the coupling term may be included between the three types of oscillators, which is given by

$${λ}_{c} {ϕ}_{{b}_{i}} {\sum }_{k = 1}^{d} {ϕ}_{{v}_{{i}_{k}}} {ϕ}_{{α}_{{i}_{k}}} .$$

Note that the superscript t is added to the b oscillators to indicate that such oscillators are used to construct the t'th attention layer.

Next, the expectation value of ϕ_{α}_{ⱼ} at thermal equilibrium may be computed. To simplify the notation, it may be defined that

$$V ( {ϕ}_{{α}_{i}} ) = \frac{1}{2} {m}_{α} {ω}_{α}^{2} {\sum }_{j = 1}^{d} {ϕ}_{{α}_{{i}_{j}}}^{2} , \qquad ( eq . 57 )$$

$${V}_{b} ( {ϕ}_{{η}_{t}} ) = V ( {ϕ}_{b} ) + {λ}_{s} {\sum }_{j = 1}^{N} {ϕ}_{{b}_{j}} {ϕ}_{{η}_{{t}_{j}}} . \qquad ( eq . 58 )$$

Thus, the expectation value at thermal equilibrium may be given by

$${〈 {ϕ}_{{α}_{{i}_{j}}} 〉}_{t h} = \frac{\int d {ϕ}_{b} d {ϕ}_{{α}_{i}} {ϕ}_{{α}_{{i}_{j}}} {e}^{- β {V}_{a}^{( i )}}}{\int d {ϕ}_{b} d {ϕ}_{{α}_{i}} {e}^{- β {V}_{a}^{( i )}}} = \frac{\int d {ϕ}_{b} {e}^{- β {V}_{b} ( {ϕ}_{{η}_{t}} )}}{\int d {ϕ}_{b} {e}^{- β {V}_{b ( {ϕ}_{{η}_{t}} )}}} \frac{\int d {ϕ}_{{α}_{i}} {ϕ}_{{α}_{{i}_{j}}} {e}^{- β ( V ( {ϕ}_{{α}_{i}} ) + {λ}_{c} {ϕ}_{{b}_{i}} {\sum }_{k = 1}^{d} {ϕ}_{{v}_{{i}_{k}} {ϕ}_{{α}_{{i}_{k}}}} )}}{\int d {ϕ}_{{α}_{i}} {e}^{- β ( V ( {ϕ}_{{α}_{i}} ) + {λ}_{c} {ϕ}_{{b}_{i}} {\sum }_{k = 1}^{d} {ϕ}_{{v}_{{i}_{k}} {ϕ}_{{α}_{{i}_{k}}}} )}} = {v}_{{i}_{j}} \frac{\int d {ϕ}_{b} {e}^{- β {V}_{b} ( {ϕ}_{{η}_{t}} )} {ϕ}_{{b}_{i}} {e}^{β {c}^{2} {m}_{a} {ω}_{a}^{2} {ϕ}_{{b}_{i}}^{2} {\sum }_{k = 1}^{d} {v}_{{i}_{k}}^{2} / 2}}{\int d {ϕ}_{b} {e}^{- β {V}_{b ( {ϕ}_{{η}_{t}} )}} {e}^{β {c}^{2} {m}_{a} {ω}_{a}^{2} {ϕ}_{{b}_{i}}^{2} {\sum }_{k = 1}^{d} {v}_{{i}_{k}}^{2} / 2}} \approx {v}_{{i}_{j}} \frac{{e}^{{η}_{{t}_{i}}} {e}^{β {c}^{2} {m}_{a} {ω}_{a}^{2} {\sum }_{k = 1}^{d} {v}_{{i}_{k}}^{2} / 2}}{{e}^{{η}_{{t}_{i}}} {e}^{β {c}^{2} {m}_{a} {ω}_{a}^{2} {\sum }_{k = 1}^{d} {v}_{{i}_{k}}^{2} / 2} + {\sum }_{j \neq i} {e}^{{η}_{{t}_{j}}}} \qquad ( eq . 59 )$$

where it is set that λ_{c}=−cm_{α}ω_{α}² for some constant c. The property of the SoftMax potential when going from the third to the fourth line in eq. 59 is used. In some embodiments, a regime where cm_{α}ω_{α}²/(mᵥωᵥ²)<<1 may be considered which is satisfied since the

$${ϕ}_{{v}_{{i}_{j}}}$$

oscillators are treated as EOs. Now to obtain the desired result, it may also be required that

$${c}^{2} {m}_{a} {ω}_{a}^{2} ≪ \frac{2 {k}_{B} T}{{\sum }_{k = 1}^{d} {v}_{{i}_{k}}^{2}} , \qquad ( eq . 60 )$$

where k_{B} is Boltzmann's constant and T is temperature. Such a condition ensures that

$${e}^{β {c}^{2} {m}_{a} {ω}_{a}^{2} {\sum }_{k = 1}^{d} {v}_{{i}_{k}}^{2} / 2} \approx 1 ,$$

in which case

$${〈 {ϕ}_{{α}_{{i}_{j}}} 〉}_{t h} = {α}_{i} ( t ) {v}_{{i}_{j}} , \qquad ( eq . 61 )$$

where the property that

$$\frac{{e}^{{η}_{{t}_{i}}}}{{\sum }_{j = 1}^{N} {e}^{{η}_{{t}_{j}}}} = \frac{{e}^{{k}_{i}^{T} {q}_{t}}}{{\sum }_{j = 1}^{N} {e}^{{k}_{j}^{T} {q}_{t}}} = {α}_{i} ( t ) , \qquad ( eq . 62 )$$

is used (see eq. 6 and the equilibrium values of the

$${ϕ}_{{η}_{{t}_{j}}}$$

oscillators in eq. 35).

To complete the computation for the t'th attention layer, the resulting vector of oscillators [symbol] ϕ_{α}_{ᵢ} [symbol] ₜₕ may be summed for all i∈{1, . . . , N}(see eq. 5). To do so, another set of oscillators may be added, where their position degrees of freedom may be labeled as ϕₐₜ_{ⱼ} for the t'th attention layer, and where j∈{1, . . . , d}. Such oscillators are coupled to the a oscillators and the potential energy may be written as

$${V}_{a ( t )}^{( j )} = \frac{1}{2} {m}_{{a}_{t}} {ω}_{{a}_{t}}^{2} {ϕ}_{{a}_{{t}_{j}}}^{2} + {λ}_{{t}_{j}} {ϕ}_{{a}_{{t}_{j}}} {\sum }_{k = 1}^{N} {ϕ}_{{α}_{{k}_{j}}} . \qquad ( eq . 63 )$$

With the Hamiltonian in eq. 63 and treating the ϕ_{αk}_{ⱼ} oscillators as approximately constant at their equilibrium values since they are EOs, the average position of the aₜ oscillators is given by

$$\begin{matrix}{〈 {ϕ}_{{a}_{{t}_{j}}} 〉}_{t h} = \frac{\int d {ϕ}_{{a}_{{t}_{j}}} {ϕ}_{{a}_{{t}_{j}}} {e}^{- β {V}_{a ( t )}^{( j )}}}{\int d {ϕ}_{{a}_{{t}_{j}}} {e}^{- β {V}_{a ( t )}^{( j )}}} \\ = - \frac{{λ}_{{t}_{j}}}{{m}_{{a}_{t}} {ω}_{{a}_{t}}^{2}} {\sum }_{k = 1}^{N} {ϕ}_{{α}_{{k}_{j}}}\end{matrix} \qquad ( eq . 64 )$$

Hence, in some embodiments, by setting λₜ_{ⱼ}=−mₐ_{ₜ}ωₐ_{ₜ}² a desired result is obtained. An illustration of the full attention gadget is shown in FIG. 19A. In some embodiments, from eq. 59 and eq. 64, the equilibrium values of the vector of oscillators

$$( {ϕ}_{{a}_{{t}_{1}}} , … , {ϕ}_{{a}_{{t}_{d}}} )$$

encodes attn(t)=Σᵢ₌₁^{N}αᵢ(t)vᵢ.

FIG. 19B illustrates the analog attention gadget of FIG. 19A, wherein respective ones of the oscillators undergo a first thermodynamic evolution based on one or more potentials of the attention gadget, according to some embodiments.

For example, in some embodiments, a first thermodynamic evolution may evolve according to the first two terms described in the potential given in eq. 56.

FIG. 19C illustrates the analog attention gadget of FIG. 19B, wherein respective ones of the oscillators undergo a second thermodynamic evolution based on one or more potentials of the attention gadget, wherein a result of an attention layer of a transformer neural network is thermodynamically obtained, according to some embodiments.

For example, a second thermodynamic evolution after the first thermodynamic evolution illustrated in FIG. 19B may introduce oscillators ϕₐ to couple to ϕ_{α}, such as given by the potential in eq. 56 and obtain a sum as indicated in eq. 64.

FIG. 20 illustrates a self-attention layer architecture of a transformer neural network implemented using one or more thermodynamic chips comprising oscillators, wherein the oscillators thermodynamically evolve according to one or more potentials to obtain an output of a self-attention layer, according to some embodiments.

In some embodiments, a self-attention 106 gadget may be used to implement a self-attention layer which forms one of the attention heads. For example, a self-attention 106 gadget may consist of three main components. The first is the dot product gadget network architecture described in FIGS. 5-7 which performs the dot product computations. The second unit creates the necessary potential which performs the SoftMax gadget described in FIGS. 12A-14. The third component combines the result of the SoftMax gadget with the oscillators encoding the vᵢ vectors to compute the output of the attention layer as described in FIG. 19A-C.

An illustration of all the components needed for a self-attention layer is shown in FIG. 20. In order to obtain a multi-head attention layer, the outputs of all the hN attention gadgets shown in FIG. 19A are concatenated. The concatenated oscillators are then used as input into the matrix multiplication gadget to multiply the oscillators by the matrix W^{O} specified in eq. 12.

An illustration of the complete multi-head attention layer is provided in FIG. 20-21. This layer integrates several key components: the dot product gadget network 602 for computing dot products, the SoftMax gadget 1202, and the attention gadget 1902, which combines the output of the SoftMax gadget with a matrix multiplication gadget 300 that encodes the vᵢ vectors using oscillators. To ensure consistency, a final linear layer, implemented via a matrix multiplication gadget 300, adjusts the output dimensions of all concatenated heads to match the input dimensions of the multi-head attention layer. As detailed in herein, EOs are employed to interconnect the various gadgets and components within them, addressing the constraints on the mass and frequency parameters of the oscillators.

FIG. 21 illustrates a multi-head attention layer architecture of a transformer neural network implemented using one or more thermodynamic chips comprising oscillators, wherein the oscillators thermodynamically evolve according to one or more potentials to obtain an output of a multi-head attention layer, according to some embodiments.

In some embodiments, a multi-head attention layer is obtained by concatenating all the heads, and using a matrix multiplication gadget the perform the multiplication by W^{O}. The concatenation step simply consists of concatenating all the

$${ϕ}_{{a}_{{t}_{j}}}$$

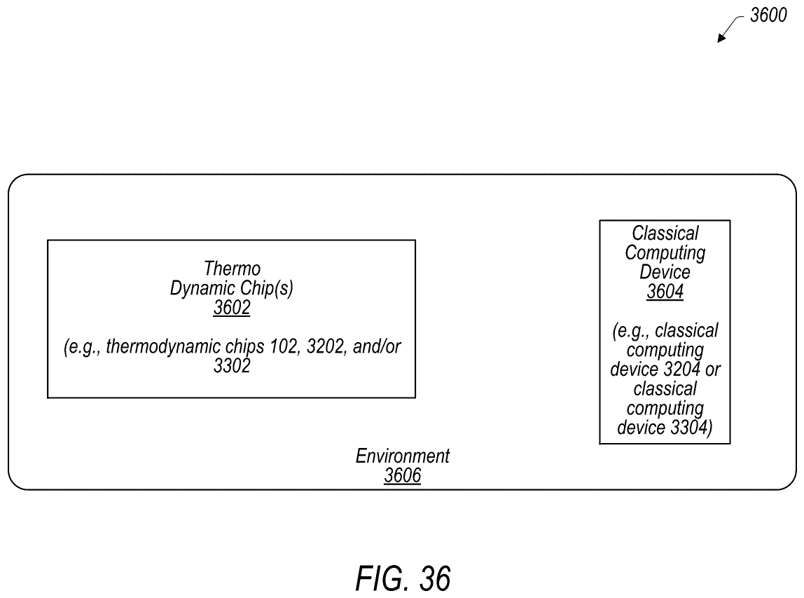

oscillators and using such oscillators as inputs to the matrix multiplication gadget such as in FIG. 36 with matrix elements given by W^{O}.

### Layer Normalization

FIG. 22 illustrates a plot of an example potential used to thermodynamically divide by a variance of input values, according to some embodiments.

In some embodiments, a potential may have the form of a cubic function such as illustrated in FIG. 22. An example of such an oscillator is described below for FIG. 24C and written in eq. 75.

FIG. 23 illustrates an analog layer normalization gadget implemented on one or more thermodynamic chips comprising oscillators, according to some embodiments.

In some embodiments, the layer normalization step described above can be implemented on a thermodynamic processor (see eq. 13). An example architecture used to implement the layer norm gadget is shown in FIG. 23-24D. Such a gadget may be implemented in several parts as described below.

In some embodiments, a layer normalization gadget 2302 (e.g., such as used in add & norm 108) may perform layer normalization in a transformer neural network architecture. For example, layer normalization gadget 2302 may have input oscillators 2304 that obtain thermodynamic data to be provided to the gadget. Mean oscillator 2306 with position degree of freedom ϕₛ is used to compute the mean of the input oscillators 2304, and to shift the average at equilibrium of the j'th position by [symbol] ϕⱼ [symbol] → [symbol] ϕⱼ [symbol] −μ where

$$μ = \frac{1}{N} {\sum }_{j = 1}^{N} 〈 {ϕ}_{j} 〉 .$$

The variance oscillator 2308 with position degree of freedom ϕᵥ is used to compute the variance, σ², given in eq. 15. Variance reciprocal oscillator 2310 with position degree of freedom ϕᵥ_{ᵣ} may be coupled to variance oscillator 2308 ϕᵥ in such a way that it reaches equilibrium at a value given by

$$\frac{1}{\sqrt{{σ}^{2} + ϵ}} .$$

Output oscillators 2312 may be used which have a three-body coupling between the original input oscillators 2304 and variance reciprocal oscillator 2310 ϕᵥ_{ᵣ}. Note that the oscillators ϕₛ, ϕᵥ and ϕᵥ_{ᵣ}, as well as the input oscillators 2304, are all used as EOs as part of the layer norm gadget protocol. As such, bias oscillators (illustrated as squares) may be optional, depending on the particular EO protocol being used.
Computing the Mean with Multiple EOs

FIG. 24A illustrates the analog layer normalization gadget of FIG. 23, wherein respective ones of the oscillators undergo a first thermodynamic evolution, based on one or more potentials of the layer normalization gadget, to obtain a mean value of input oscillator values, according to some embodiments.

In some embodiments the mean value of the input neurons 2304 may be stored to the layer norm gadget 2302. For example, an oscillator ϕₛ (e.g., mean oscillator 2306) may be introduced that may be used to store a mean thermodynamic data of thermodynamic data of input oscillators 2304. The mean oscillator 2306 ϕₛ may then be used to shift the expectation value of the input neurons (e.g., input oscillators 2304) by the mean.

Let {ϕ₁, . . . , ϕ_{N}} be the set of output oscillators from some previous gadget, wherein such oscillators may serve as input oscillators 2304 for layer normalization gadget 2302. It may be assume that the oscillator ϕⱼ∈{ϕ₁, . . . , ϕ_{N}} has an expectation value given by [symbol] ϕⱼ [symbol] =xⱼ, with mass m and frequency ω. The potential describing the coupling between the mean oscillator 2306 ϕₛ and the input oscillators 2304 ϕⱼ∈{ϕ₁, . . . , ϕ_{N}} may be written as

$${V}_{1}^{( ln )} = \frac{1}{2} {m}_{s} {ω}_{s}^{2} {ϕ}_{s}^{2} + {λ}_{1} ( t ) {\sum }_{j = 1}^{N} {( {ϕ}_{s} - \frac{1}{N} {ϕ}_{j} )}^{2} , \qquad ( eq . 65 )$$

where in eq. 65 the ϕⱼ input oscillators 2304 may be treated as static at the expectation value xⱼ since it may be assumed that mₛωₛ²<<mω². In what follows, ϕₛ may be treated as an EO, where its product mₛωₛ² will be increased after it is decoupled from all the ϕⱼ oscillators. In this case, the following may be written

$$\begin{matrix}〈 {ϕ}_{s} 〉 \approx \frac{\int d {ϕ}_{s} {ϕ}_{s} {e}^{- β {V}_{1}^{( ln )}}}{\int d {ϕ}_{s} {e}^{- β {V}_{1}^{( ln )}}} \\ \approx \frac{2 {λ}_{1} \frac{1}{N} {\sum }_{j = 1}^{N} {x}_{j}}{2 {λ}_{1} + {m}_{s} {ω}_{s}^{2}} .\end{matrix} \qquad ( eq . 66 )$$

Thus, by setting mₛωₛ²/(2λ₁)<<1, a desired result (e.g., a mean value of input oscillator thermodynamic data) may be obtained.

In some embodiments, after decoupling ϕₛ mean oscillator 2306 from the set of {ϕ₁, . . . , ϕ_{N}} input oscillators 2304 by turning λ₁(t) off, a product of mass and frequency squared of the mean oscillator 2306, mₛωₛ², may simultaneously be increased such that ϕₛ mean oscillator 2306 effectively becomes static at its expectation value, wherein the expectation value may be represented by

$$μ = \frac{1}{N} {\sum }_{j = 1}^{N} {x}_{j} .$$

Further, mₛωₛ² may be tuned such that mₛωₛ²>>mω². This allows the ϕₛ mean oscillator 2306 to perturb the {ϕ₁, . . . , ϕ_{N}} input oscillators 2304 while treating ϕₛ mean oscillator 2306 as static. Once mₛωₛ² has been tuned, the coupling between ϕₛ mean oscillator 2306 and the {ϕ₁, . . . , ϕ_{N}} input oscillators 2304 may be turned back on using a potential given by

$${V}_{2}^{( ln )} = \frac{1}{2} m {{ω}^{2} ( {ϕ}_{j} - {x}_{j} )}^{2} + {λ}_{2} ( t ) {( {c}_{1} {ϕ}_{j} - {c}_{2} {ϕ}_{s} )}^{2} , \qquad ( eq . 67 )$$

for some constants c₁ and c₂. Without loss of generality, the term

$$\frac{1}{2} m {{ω}^{2} ( {ϕ}_{j} - {x}_{j} )}^{2}$$

is included instead of considering the previous EO dynamics of ϕⱼ which leads it to remain static at xⱼ. The expected value for the [symbol] ϕⱼ [symbol] oscillator is now

$$\begin{matrix}〈 {ϕ}_{j} 〉 \approx \frac{\int d {ϕ}_{j} {ϕ}_{j} {e}^{- β {V}_{2}^{( ln )}}}{\int d {ϕ}_{j} {e}^{- {βV}_{2}^{( ln )}}} \\ = \frac{α}{1 + α} {x}_{j} + \frac{{c}_{2}}{{c}_{1} ( 1 + α )} μ ,\end{matrix} \qquad ( eq . 68 )$$

where it may be engineered that

$$α = \frac{{m}_{j} {ω}_{j}^{2}}{2 {λ}_{2} {c}_{1}^{2}} , \qquad ( eq . 69 )$$

with λ₂ being the max value of λ₂(t). ϕₛ may be treated as static at its equilibrium values given in eq. 66. Now if α>>1, eq. 68 simplifies to

$$\begin{matrix}〈 {ϕ}_{j} 〉 \approx {x}_{j} + \frac{{c}_{2}}{{c}_{1} α} μ \\ = {x}_{j} - μ ,\end{matrix} \qquad ( eq . 70 )$$

where in going from the first to the second line in eq. 70, the condition c₂=−c₁α may be set.

Finally, the {ϕ₁, . . . , ϕ_{N}} input oscillators 2304 may be decoupled from ϕₛ mean oscillator 2306 by setting λ₂(t) back to zero while simultaneously increasing the product of mω² such that the ϕⱼ oscillators become static at the equilibrium value given in eq. 70.

### Computing the Variance

FIG. 24B illustrates the analog layer normalization gadget of FIG. 24A, wherein respective ones of the oscillators undergo a second thermodynamic evolution, based on one or more potentials of the layer normalization gadget, to obtain a variance value of input oscillators, according to some embodiments.

The next step is to compute the variance

$${σ}^{2} = \frac{1}{N - 1} {\sum }_{j = 1}^{N} {( {x}_{j} - μ )}^{2} .$$

In doing so, a new variance oscillator 2308 ϕᵥ may be introduced which will act as an EO (e.g., a relay oscillator). Prior to coupling variance oscillator 2308 ϕᵥ to the {ϕ₁, . . . , ϕ_{N}} input oscillators 2304 shifted by the mean, the condition mᵥωᵥ²<<mω² may be set. The Hamiltonian describing the coupling between variance oscillator 2308 ϕᵥ and the {ϕ₁, . . . , ϕ_{N}} input oscillators 2304 shifted by the mean may be given by

$${V}_{3}^{( ln )} = \frac{1}{2} {m}_{v} {ω}_{v}^{2} {ϕ}_{v}^{2} + \frac{1}{2} m {ω}^{2} {\sum }_{j = 1}^{N} {( {ϕ}_{j} - ( {x}_{j} - μ ) )}^{2} - {λ}_{3} ( t ) {ϕ}_{v} {\sum }_{j = 1}^{N} {ϕ}_{j}^{2} . \qquad ( eq . 71 )$$

Now before calculating [symbol] ϕᵥ [symbol] , a subtlety in the estimator oscillator (EO) protocol due to the λ₃(t)ϕᵥΣⱼ₌₁^{N}ϕⱼ² term in eq. 71 which contains the quadratic term ϕⱼ². In some embodiments, the smaller the product mω², the more variance will be present in the state of the {ϕ₁, . . . , ϕ_{N}} input oscillators 2304 around its equilibrium value. For example, the potential in eq. 65 may be used to compute [symbol] ϕⱼ² [symbol] which is given by

$$\begin{matrix}〈 {ϕ}_{j}^{2} 〉 \approx \frac{\int d {ϕ}_{j} {ϕ}_{j}^{2} {e}^{- β {V}_{3}^{( ln )}}}{\int d {ϕ}_{j} {e}^{- β {V}_{3}^{( ln )}}} \\ = {( {x}_{j} + \frac{{λ}_{1}}{m {ω}^{2}} μ )}^{2} + \frac{1}{β m {ω}^{2}} \\ = {( {x}_{j} - μ )}^{2} + \frac{{k}_{B} T}{m {ω}^{2}} ,\end{matrix} \qquad ( eq . 72 )$$

where in going from the second to third line the condition λ=−mω² is set. Comparing with eq. 68, the addition of the term

$$- \frac{1}{β m {ω}^{2}}$$

in eq. 72 represents the variance. Further, in the limit of large mω² and small temperature, the variance term can be made to be very small. In what follows, since the ϕⱼ oscillators are EOs and treated as static due to a large mω² term, the replacement ϕⱼ→(xⱼ−μ) may be utilized.

Given the above, it may be written that

$$\begin{matrix}〈 {ϕ}_{v} 〉 \approx \frac{\int d {ϕ}_{v} {ϕ}_{v} {e}^{- β {V}_{3}^{( ln )}}}{\int d {ϕ}_{v} {e}^{- β {V}_{3}^{( ln )}}} \\ = \frac{{λ}_{3}}{{m}_{v} {ω}_{v}^{2}} {\sum }_{j = 1}^{N} {( {x}_{j} - μ )}^{2} \\ = \frac{1}{N - 1} {\sum }_{j = 1}^{N} {( {x}_{j} - μ )}^{2} = {σ}^{2} ,\end{matrix} \qquad ( eq . 73 )$$

where the condition

$${λ}_{3} = \frac{{m}_{v} {ω}_{v}^{2}}{N - 1}$$

is set. Lastly, note that other coupling terms are also possible. For instance, the following potential may be used

$${V}_{3}^{( ln )} = \frac{1}{2} {m}_{v} {ω}_{v}^{2} {ϕ}_{v}^{2} + \frac{1}{2} m {ω}^{2} {\sum }_{j = 1}^{N} {( {ϕ}_{j} - ( {x}_{j} - μ ) )}^{2} - {λ}_{3} ( t ) {( {ϕ}_{v} - c {\sum }_{j = 1}^{N} {ϕ}_{j}^{2} )}^{2} , \qquad ( eq . 74 )$$

for some constant c. Repeating the same calculation that lead to eq. 73, a desired result may be obtained with the condition that mᵥωᵥ²/(2λ₃)<<1 and c=1/(N−1).

After reaching thermal equilibrium, the coupling between 0, variance oscillator 2308 and the {ϕ₁, . . . , ϕ_{N}} input oscillators 2304 may be turned off, and mᵥωᵥ² of the variance oscillator 2308 may be tuned to ensure that σᵥ variance oscillator 2308 remains static at the equilibrium value given in eq. 73.

### Dividing by the Variance

FIG. 24C illustrates the analog layer normalization gadget of FIG. 24B, wherein respective ones of the oscillators undergo a third thermodynamic evolution, based on one or more potentials of the layer normalization gadget, to obtain a reciprocal of the variance value of the input oscillators, according to some embodiments.

Consider a potential of the form

$${V}_{4}^{( ln )} = {A}_{1} {ϕ}_{{v}_{r}}^{3} ( {ϕ}_{v} + ϵ ) - {A}_{2} {ϕ}_{{v}_{r}} , \qquad ( eq . 75 )$$

where σᵥ variance oscillator 2308 is treated as a constant at its equilibrium value σ² since it is a EO. An example of the potential energy in eq. 75 is plotted in FIG. 22. E (in units of position) may be added which is a small positive constant. The oscillator ϕᵥ_{ᵣ} variance reciprocal oscillator 2310 may be used to store the value 1/\sqrt{σ²}. A local minima of V₃⁽¹⁾ is given at

$${ϕ}_{{v}_{r}} = \pm \frac{{A}_{2}}{3 {A}_{1}} \frac{1}{\sqrt{{σ}^{2} + ϵ}} . \qquad ( eq . 76 )$$

wherein the condition λ₂=3A₁ may be set. As illustrated in FIG. 22, for large enough A₁ and σᵥ_{ᵣ} variance reciprocal oscillator 2310 initialized at zero, the probability that σᵥ_{ᵣ} variance reciprocal oscillator 2310 converges to the local minima may be close to 1. As such, it may be choose that A₁>>1 and σᵥ_{ᵣ} variance reciprocal oscillator 2310 may be initialized to zero prior to coupling σᵥ_{ᵣ} variance reciprocal oscillator 2310 to σᵥ variance oscillator 2308. Since σᵥ variance oscillator 2308 is an EO, it may be assumed that the condition mᵥ_{ᵣ}ωᵥ_{ᵣ}²<<mᵥωᵥ² a is set and the variance oscillator 2308 σᵥ may be treated as static at its equilibrium value. The integral in computing the expectation value of P variance reciprocal oscillator 2310 may be written as

$$\begin{matrix}〈 {ϕ}_{{v}_{r}} 〉 \approx \frac{\int d {ϕ}_{{v}_{r}} {ϕ}_{{v}_{r}} {e}^{- β {V}_{4}^{( ln )} ( {ϕ}_{{v}_{r}} )}}{\int d {ϕ}_{{v}_{r}} {e}^{- β {V}_{4}^{( ln )} ( {ϕ}_{{v}_{r}} )}} \\ \approx \frac{1}{\sqrt{{σ}^{2}}} \frac{{e}^{- β {V}_{4}^{( ln )} ( \frac{1}{\sqrt{{σ}^{2} + ϵ}} )}}{{e}^{- β {V}_{4}^{( ln )} ( \frac{1}{\sqrt{{σ}^{2} + ϵ}} )}} \\ = \frac{1}{\sqrt{{σ}^{2} + ϵ}} ,\end{matrix} \qquad ( eq . 77 )$$

since the probability of finding σᵥ_{ᵣ} variance reciprocal oscillator 2310 away from the local minima is exponentially small.

After reaching its thermal equilibrium value, σᵥ_{ᵣ} variance reciprocal oscillator 2310 may decoupled from σᵥ variance oscillator 2308. The term mᵥ_{ᵣ}107 ᵥ_{ᵣ}² may simultaneously be tuned using the EO formalism to ensure that the σᵥ_{ᵣ} variance reciprocal oscillator 2310 can be treated as static as needed in the step below.

Note that from a hardware perspective, it may be more natural to consider the following potential

$${V}_{4}^{( ln )} = {A}_{1} {ϕ}_{{v}_{r}}^{4} ( {ϕ}_{v} + ϵ ) - \frac{1}{2} {m}_{{v}_{r}} {ω}_{{v}_{r}}^{2} {ϕ}_{{v}_{r}}^{2} , \qquad ( eq . 78 )$$

due to the quadratic and quartic terms. Such a potential has a local minimum at 0, and global minima at

$${ϕ}_{{v}_{r}} = \pm \sqrt{\frac{\frac{1}{2} {m}_{{v}_{r}} {ω}_{{v}_{r}}^{2}}{2 {A}_{1} ( {σ}^{2} + ϵ )}} , \qquad ( eq . 79 )$$

where again σᵥ variance oscillator 2308 may be treated as static at its equilibrium value σ². By setting

$$\frac{1}{2} {m}_{{v}_{r}} {ω}_{{v}_{r}}^{2} = 2 {A}_{1} , \qquad ( eq . 80 )$$

a desired result may be obtained if σᵥ_{ᵣ} variance reciprocal oscillator 2310 is initialized at some large positive value, and A₁ is large (since in this case σᵥ_{ᵣ} variance reciprocal oscillator 2310 will quickly reach equilibrium on the right-side of the double well potential). However, since σᵥ_{ᵣ} variance reciprocal oscillator 2310 is an EO with

$$\frac{1}{2} {m}_{{v}_{r}} {ω}_{{v}_{r}}^{2} ≪ \frac{1}{2} {m}_{v} {ω}_{v}^{2} ,$$

a careful choice of parameters is required to ensure that the constraint in eq. 80 is satisfied with large A₁.

### Storing the Final Layer Norm Result

FIG. 24D illustrates the analog layer normalization gadget of FIG. 24C, wherein respective ones of the oscillators undergo a fourth thermodynamic evolution, based on one or more potentials of the layer normalization gadget, to obtain results of a layer normalization layer of a transformer neural network on output oscillators, according to some embodiments.

The final step involves coupling the variance reciprocal oscillators 2310 σᵥ_{ᵣ} and input oscillators 2304 {ϕ₁, . . . , ϕ_{N}} to final output oscillators 2310 of the layer norm gadget 2302 which may be labeled {ϕ_{c}_{₁}, . . . , ϕ_{c}_{_{N}}}. To do so, the potential

$${V}_{t h b} = \frac{1}{2} {m}_{c} {ω}_{c}^{2} {\sum }_{j = 1}^{N} {ϕ}_{{c}_{j}}^{2} + {λ}_{4} ( t ) {ϕ}_{{v}_{r}} {\sum }_{j = 1}^{N} {ϕ}_{j} {ϕ}_{{c}_{j}} , \qquad ( eq . 81 )$$

may be used where the oscillators σᵥ_{ᵣ} and {σ₁, . . . , ϕ_{N}} are treated as static. It may be assumed in some embodiments that the conditions m_{c}ω_{c}²<<mω² and m_{c}ω_{c}²<<mᵥ_{ᵣ}ωᵥ_{ᵣ}² are met. At equilibrium, the final output oscillators of the layer norm gadget may be written as

$$\begin{matrix}〈 {ϕ}_{{c}_{j}} 〉 \approx \frac{\int d {ϕ}_{{c}_{1}} … d {ϕ}_{{c}_{N}} {ϕ}_{{c}_{j}} {e}^{- β {V}_{thb}}}{\int d {ϕ}_{{c}_{1}} … d {ϕ}_{{c}_{N}} {e}^{- β {V}_{thb}}} \\ \approx - \frac{{λ}_{4} ( t )}{{m}_{c} {ω}_{c}^{2}} 〈 {ϕ}_{{v}_{r}} 〉 〈 {ϕ}_{j} 〉 \\ = - \frac{{λ}_{4} ( t )}{{m}_{c} {ω}_{c}^{2}} \frac{{x}_{j} - μ}{\sqrt{{σ}^{2} + ϵ}} .\end{matrix} \qquad ( eq . 82 )$$

By setting the max value of λ₄=−m_{c}ω_{c}², a desired result of the layer norm gadget on the output oscillators {ϕ_{c}_{₁}, . . . , ϕ_{c}_{_{N}}} may be obtained. Note that the following potential may also be used

$${V}_{thb}^{( 2 )} = \frac{1}{2} {m}_{c} {ω}_{c}^{2} {\sum }_{j = 1}^{N} {ϕ}_{{c}_{j}}^{2} + {λ}_{4} ( t ) {( {ϕ}_{{v}_{r}} {\sum }_{j = 1}^{N} {ϕ}_{j} - {ϕ}_{{c}_{j}} )}^{2} . \qquad ( eq . 83 )$$

In this case, the final output oscillators of the layer norm gadget may be written as

$$\begin{matrix}〈 {ϕ}_{{c}_{j}} 〉 \approx \frac{2 {λ}_{4}}{2 {λ}_{4} + {m}_{c} {ω}_{c}^{2}} 〈 {ϕ}_{{v}_{r}} 〉 〈 {ϕ}_{j} 〉 \\ = \frac{2 {λ}_{4}}{2 {λ}_{4} + {m}_{c} {ω}_{c}^{2}} \frac{{x}_{j} - μ}{\sqrt{{σ}^{2} + ϵ}} .\end{matrix} \qquad ( eq . 84 )$$

Note that if 2λ₄>m_{c}ω_{c}², a desired result may be obtained.

In some embodiments, the potentials considered in above may use time dependent pulses. Such pulses are used to turn on and off the desired couplings between the relevant oscillators (such that EO methods may be applied), and that the derived values for the coupling strengths represent the max values of said pulses while the relevant oscillators are coupled. An illustration of the entire layer norm gadget is shown in FIG. 23-24D.

Multi-Head Attention Layer with Add and Layer Norm

FIG. 25 illustrates a plurality of matrix multiplication gadgets thermodynamically obtaining a plurality of matrix multiplication resultant vectors to be provided as input to a dot product gadget network, wherein dot products between one of the plurality of matrix resultant vectors and respective other ones of the plurality of matrix resultant vectors are obtained on output oscillators of the dot product gadget network, according to some embodiments.

In some embodiments, thermodynamic input to the self-attention 106 (e.g., see FIG. 20) is illustrated in FIG. 25. FIG. 25 illustrates matrix multiplication gadgets (e.g., matrix multiplication gadget 300) used to create oscillators encoding the vectors qₜ and kₜ and how they are coupled to the dot product gadget network 602.

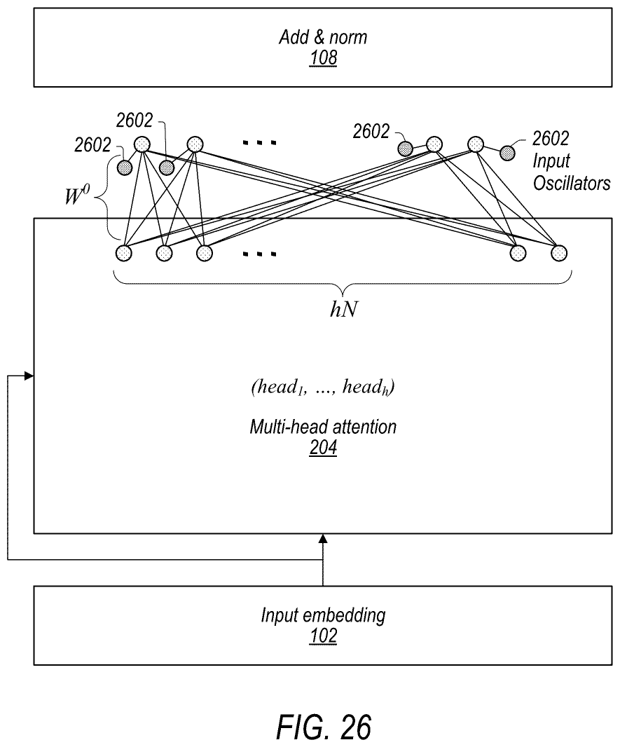

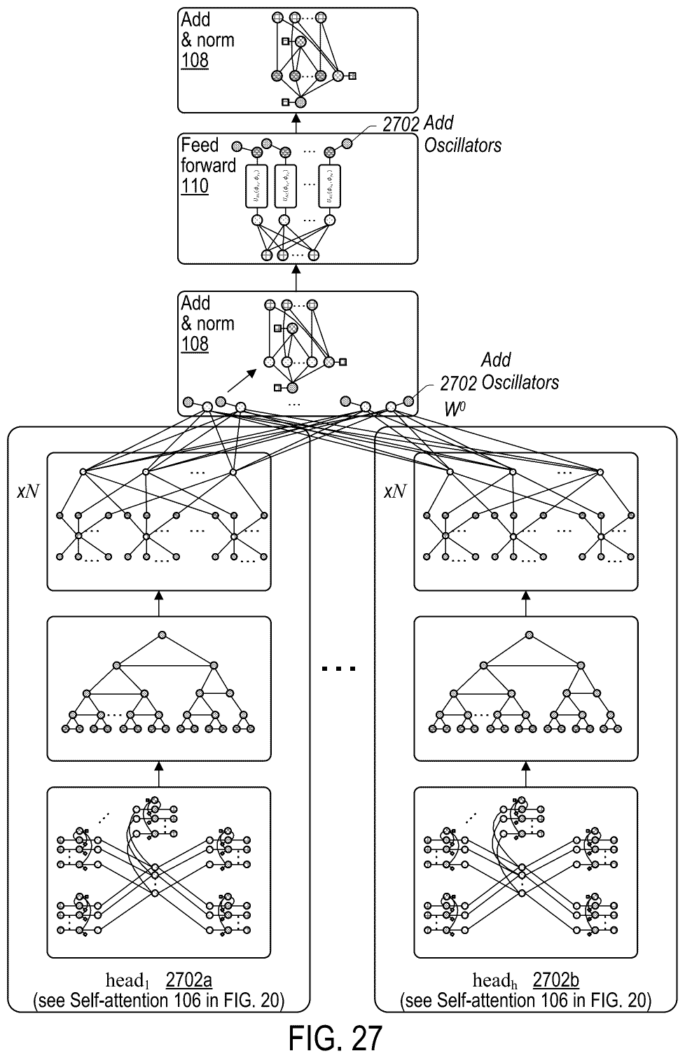

FIG. 26 illustrates an add and norm layer of a transformer neural network implemented using one or more thermodynamic chips comprising oscillators, wherein the add and norm layer is performed using output of a multi-head attention layer, according to some embodiments.

In some embodiments, an add and layer norm steps may be utilized at the output of the multi-head attention layer of a transformer neural network. In some embodiments, the add scheme may be implemented through a residual connection, where the input neurons to the multi-head attention layer are added to the output of the multi-head attention layer. In FIG. 26, the values of the input neurons are encoded in the position degree of freedom of the input oscillators 2602, and such input oscillators 2602 are coupled to the outputs of the multi-head attention layer. After the system reaches equilibrium, the layer norm gadget as described herein may be implemented.

### Add Layer

In some embodiments, after implementing the multi-head attention layer, the input may be added to the multi-head attention layer (i.e. the oscillators encoding values of the matrix X given in eq. 1, or the oscillators encoding output from the previous encoder block) to the output of the multi-head attention layer. Such an operation is also known as a residual connection, which is used in deep neural networks to help them train faster and achieve better results. The oscillators which are clamped to the elements of X (or to the outputs from the previous encoder block) may be directly coupled to the output oscillators of a multi-head attention unit. Such an operation may require long range connectivity. As such, in some embodiments, additional oscillators may be used which are clamped to the values of the matrix X or the previous outputs and which are located at the output of the self-attention unit, as is shown in FIG. 26. Such oscillators are represented by the 2602 oscillators in the figure. To encode the inputs (or the outputs of the previous encoder block) to such oscillators while avoiding long range connections, a chain of Eos may be used, with each set of EOs in the chain clamped to the relevant inputs such that they copy the input state to the final input oscillators 2602 in FIG. 26.

In some embodiments, a coupling potential may be used for adding the word embedding matrix of eq. 1 to the output of the multi-head attention layer. Without loss of generality, EOs whose position degrees of freedom

$${ϕ}_{{x}_{{i}_{j}}}$$

may be used to encode the j'th component of xᵢ at thermal equilibrium. In some embodiments, a clamping term of the form

$${{λ}_{c} ( {ϕ}_{{x}_{{i}_{k}}} - {x}_{{i}_{k}} )}^{2}$$

may be implemented to ensure that such oscillators are clamped to the embedding matrix. Note that in a fully analogue implementation of the EO, such a clamping term is unnecessary because the EO reaches thermal equilibrium at the desired value, and the product of its mass and frequency is increased after being decoupled to treat the oscillator as static. The potential may then be

$${V}_{Add}^{( i )} = \frac{1}{2} {m}_{x} {ω}_{x}^{2} {\sum }_{k = 1}^{d} {ϕ}_{{x}_{{i}_{k}}}^{2} + {λ}_{c} {\sum }_{k = 1}^{d} {( {ϕ}_{{x}_{{i}_{k}}} - {x}_{{i}_{k}} )}^{2} + \frac{1}{2} {m}_{{a}_{t}} {ω}_{{a}_{t}}^{2} {\sum }_{k = 1}^{d} {ϕ}_{{a}_{{i}_{k}}}^{2} - {m}_{{a}_{t}} {ω}_{{a}_{t}}^{2} {\sum }_{k = 1}^{d} {ϕ}_{{a}_{{i}_{k}}} {\sum }_{j = 1}^{N} {ϕ}_{{α}_{{j}_{k}}} - {λ}_{x {\sum }_{k = 1}^{d}} {ϕ}_{{a}_{{i}_{k}}} \qquad ( eq . 85 )$$

where in addition to the potential in eq. 63, a linear coupling may be added between the

$${ϕ}_{{x}_{{i}_{k}}}$$

oscillators representing the word embedding (or output of the previous encoder block) and the

$${ϕ}_{{a}_{{i}_{k}}}$$

oscillators. To avoid confusion, note that the

$${ϕ}_{{a}_{{i}_{k}}}$$

oscillators are distinct from the

$${ϕ}_{{α}_{{i}_{k}}}$$

oscillators (note the “a” and “α” subscripts). Using the potential in eq. 85, the equilibrium position for

$${ϕ}_{{a}_{{i}_{k}}}$$

may be given by

$$( eq . 86 )$$

$$〈 {ϕ}_{{a}_{{i}_{k}}} 〉 = \frac{2 {λ}_{c} {x}_{{i}_{k}}}{2 {λ}_{c} - {m}_{{a}_{t}} {ω}_{{a}_{t}}^{2} + {m}_{x} {ω}_{x}^{2}} + ( 1 + \frac{{m}_{{a}_{t}} {ω}_{{a}_{t}}^{2}}{2 {λ}_{c} - {m}_{{a}_{t}} {ω}_{{a}_{t}}^{2} + {m}_{x} {ω}_{x}^{2}} ) {\sum }_{j = 1}^{N} {ϕ}_{{α}_{{j}_{k}}} ,$$

where the condition λₓ=mₐ_{ₜ}ωₐ_{ₜ}² may be set. Furthermore, the

$${ϕ}_{{α}_{{j}_{k}}}$$

oscillators may be treated as static. If the condition 2λ_{c}>>mₐ_{ₜ}ωₐ_{ₜ}² and 2λ_{c}>mₓωₓ² are implemented, eq. 86 simplifies to

$$\begin{matrix}〈 {ϕ}_{{a}_{{i}_{k}}} 〉 \approx {x}_{{i}_{k}} + ( 1 + \frac{{m}_{{a}_{t}} {ω}_{{a}_{t}}^{2}}{2 {λ}_{c}} ) {\sum }_{j = 1}^{N} {ϕ}_{{α}_{{j}_{k}}} \\ \approx {x}_{{i}_{k}} + {\sum }_{j = 1}^{N} {ϕ}_{{α}_{{j}_{k}}} .\end{matrix} \qquad ( eq . 87 )$$

Comparing eq. 87 with eq. 64, the input xᵢ_{ₖ} has been added to the output of the multi-head attention layer.

### Layer Normalization

After adding the input to the multi-head attention layer to its output, the final step is to perform layer normalization. The protocol for layer normalization is described above and an illustration is shown in FIG. 26B. The oscillators

$${ϕ}_{{a}_{{i}_{k}}}$$

are used as the input oscillators in FIG. 23-24D.

### Mean Field Backwards Propagation for Training the Transformer Network

FIG. 27 illustrates an encoder block architecture of a transformer neural network implemented using one or more thermodynamic chips comprising oscillators, wherein multiple head attention layers, two add and norm layers and a feed forward layer are utilized, according to some embodiments.

FIG. 27 illustrates an example of a full encoder block architecture, where each component is illustrated with its implementation on a thermodynamic processor. The bottom portion of the figure illustrates the multi-head attention (e.g., with head₁ 2702a through headₕ 2702b), with the dot product gadget network 602 shown in FIG. 6, the SoftMax gadget 1202 in FIGS. 12A-14 and the attention layer shown in FIG. 19A-C. The add oscillators 2702 coupled to the outputs perform the add layer, and the layer norm block is shown in FIG. 23-24D. Finally, the feedforward network shown in FIG. 4 may be implemented, which consists of a matrix multiplication followed by some activation function which may be labeled with the potential U_{NL}. The figure concludes with another add and norm layer.

In some embodiments, a full encoder block of a transformers architecture, implemented on a thermodynamic processor, is shown in FIG. 27. The transformer architecture can be trained using mean-field forwards and backwards propagation steps. For example, consider potential energy functions of EBM blocks which have learnable parameters. Further, for both EBMs with and without parameters in the transformer architecture presented above, expectation values are used for the output of a given block to be used as inputs to the next block.

FIG. 28A illustrates additional details of a relay gadget implemented using a thermodynamic chip, wherein the relay gadget is configured to relay thermodynamic information between a first energy-based model (EBM) and a second energy-based model (EBM), such as an analog Swish gadget, according to some embodiments.

For example, FIG. 28A is high-level diagram illustrating a first energy-based model (EBM) implemented using a thermodynamic chip, a second energy-based model (EBM) implemented using a thermodynamic chip, and a relay gadget implemented using a thermodynamic chip, wherein the relay gadget is configured to relay thermodynamic information between the first energy-based model (EBM) and the second energy-based model (EBM), according to some embodiments.

In some embodiments, a relay oscillator gadget, such as relay oscillator gadget 2818, receives thermodynamic information from an input source, such as oscillator 2806, and relays the thermodynamic information to an output destination, such as oscillator 2808. In some embodiments, the oscillator 2806 may be an output oscillator 2806 of a first energy-based model (EBM) 2800 (e.g., a given layer of a transformer neural network) and the oscillator 2808 may be an input oscillator 2808 of a second energy-based model (EBM) 2802 (e.g., a next layer of the transformer neural network). In some embodiments, the thermodynamic information being relayed from the output oscillator 2806 to the input oscillator 2808 may be a position degree of freedom. As such, FIG. 28A shows an output position degree of freedom (ϕ_{y}) of the output oscillator 2806 and an input position degree of freedom (ϕₓ) of the input oscillator 2808, as well as a relay position degree of freedom (ϕᵣ) of the relay oscillator 2818 and a bias position degree of freedom (ϕ_{b}) of the bias oscillator 2812. Additionally, controller 2814 is shown, which may be an on-chip controller. Controller 2814 causes pulses to be emitted in a time dependent manner to orchestrate coupling of the relay oscillator 2818 to the output oscillator 2806, coupling of the relay oscillator 2818 to the bias oscillator 2812, adjustment of a mass or frequency of the relay oscillator 2818, and a coupling of the relay oscillator 2818 to the input oscillator 2808. In some embodiments, the controller 2814 may be pre-programmed to emit the relevant pulses and control signals in a time dependent sequence in order to execute a relay operation.

An example Hamiltonian of the coupled system shown in FIG. 28A is given by:

$${H}_{fan} = \frac{{π}_{r}^{2}}{2 {m}_{r} ( t )} + \frac{{π}_{y}^{2}}{2 {m}_{y}} + \frac{{π}_{x}^{2}}{2 {m}_{x}} + \frac{{π}_{b}^{2}}{2 {m}_{b}} + \frac{1}{2} {m}_{r} ( t ) {ω}_{r}^{2} ( t ) {ϕ}_{r}^{2} + \frac{1}{2} {m}_{b} {ω}_{b}^{2} {ϕ}_{b}^{2} + \frac{1}{2} {m}_{y} {{ω}_{y}^{2} ( {ϕ}_{y} - {y}_{e} )}^{2} + \frac{1}{2} {m}_{x} {ω}_{x}^{2} {ϕ}_{x}^{2} + {λ}_{A} ( t ) {( {ϕ}_{y} - {ϕ}_{r} )}^{2} + {λ}_{B} ( t ) {ϕ}_{b} {ϕ}_{r} + {λ}_{X} ( t ) {ϕ}_{r} {ϕ}_{X}$$

Note that the terms in the Hamiltonian including the λ_{A}, λ_{B}, and λₓ terms describe the coupling between the relay oscillators and the other three oscillators, e.g., the output oscillator 2806, the bias oscillator 2812, and the input oscillator 2808. Also, note that all three coupling terms are time dependent, based on the λ_{A}, λ_{B}, and λ_{X} pulses controlled by controller 2814. Additionally, note that the mass (or the frequency) of the relay oscillator 2818 is time dependent, where the mass (or frequency) of the relay oscillator is also controlled by controller 2814.

More particularly, the controller 2814 emits pulses λ_{A} to couple the position degree of freedom (ϕ_{y}) of the output oscillator 2806 to the position degree of freedom (ϕᵣ) of the relay oscillator 2818. This coupling may remain turned on for some time. Then, once the coupling between the position degree of freedom (ϕ_{y}) of the output oscillator 2806 and the position degree of freedom (ϕᵣ) of the relay oscillator 2818 is turned off, the controller 2814 causes pulses λ_{B} to be emitted to couple the position degree of freedom (ϕᵣ) of the relay oscillator 2818 to the position degree of freedom (ϕ_{b}) of the bias oscillator 2812, and simultaneously emits control signals to cause the mass of the relay oscillator 2818 to be increased (or alternatively emits control signals to cause the oscillation frequency of the relay oscillator 2818 to be tuned, for example decreased). When coupled to the relay oscillator 2818, the bias position degree of freedom (ϕ_{b}) of the bias oscillator 2812 acts as a bias to the relay oscillator 2818 and helps to ensure that the relay position degree of freedom (ϕᵣ) of the relay oscillator 2818 maintains its equilibrium value (that it has acquired from the output oscillator 2806). After the relay oscillator 2818 has reached an appropriately large mass (or tuned frequency), the controller 2814 causes pulses λ_{X} to be emitted to couple the position degree of freedom (ϕᵣ) of the relay oscillator 2818 (having the increased mass or tuned frequency) to the position degree of freedom (ϕ_{X}) of the input oscillator 2808. Also, in some embodiments, the controller 2814 may cause pulses λ_{X} and pulses λ_{B} to be emitted at the same time, such that the relay oscillator 2818 is coupled to the bias oscillator 2812 simultaneously with being coupled to the input oscillator 2808. Note that in the illustration shown in FIG. 28A either of EBMs 2800 or 2802 may be an analog Swish gadget 1508 (or any other layer or component or gadget such as described herein for a transformer neural network architecture), that is to say the input to the relay oscillator may come from the analog Swish gadget 1508 (or any other layer or component or gadget such as described herein for a transformer neural network architecture) or the destination of the information being relayed may be the Swish gadget 1508 (or any other layer or component or gadget such as described herein for a transformer neural network architecture). FIG. 28A is illustrating a more general case for the relay gadget where the inputs and outputs are general EBMs, but it should be understood that the analog Swish gadget is a particular implementation of an EBM having an engineered potential that implements the Swish function.

In some embodiments the following pulse shapes may be used for λ_{A}, λ_{B}, and λ_{X}. Though in some embodiments, other suitable pulse shapes may be used.

$${λ}_{A} ( t ) = {λ}_{A} ( σ ( {k}_{A} ( t - {t}_{1} ) ) - σ ( {k}_{A} ( t - {t}_{2} ) ) )$$

$${λ}_{B} ( t ) = - {λ}_{B} σ ( {k}_{B} ( t - {t}_{1}^{( B )} ) ) + {λ}_{0}^{( B )}$$

$${λ}_{X} ( t ) = {λ}_{X} σ ( {k}_{X} ( t - {t}_{1}^{( X )} ) ) + {λ}_{0}^{( X )}$$

where σ(t) is the sigmoid function:

$$σ ( t ) = \frac{1}{1 + {e}^{- t}} .$$

In some embodiments, λ_{A}, λ_{B}, and λ_{X}, as well as k_{A}, k_{B}, and k_{X} may be tuned to improve results. Also, times, t₁, t₂, t₁^{(B)} and t₁^{(X)} may be tuned.

Without loss of generality, the position degree of freedom of the output oscillator 2806 (ϕ_{y}) is considered to have an equilibrium value (yₑ) (after energy-based model 2800 has evolved for some time and reached a thermal equilibrium). Also, the position degree of freedom (ϕ_{y}) of the output oscillator 2806 is considered to have a potential given by

$$\frac{1}{2} {m}_{y} {{ω}_{y}^{2} ( {ϕ}_{y} - {y}_{e} )}^{2} .$$

It should be noted in practice that the output oscillator 2806 may be coupled to various other oscillators of the first energy-based model 2800 (as shown in FIG. 28A) which would cause it to have the yₑ equilibrium value. Thus, to be more comprehensive,

$$\frac{1}{2} {m}_{y} {{ω}_{y}^{2} ( {ϕ}_{y} - {y}_{e} )}^{2}$$

may be replaced by a potential term that takes into account these couplings, such as

$$\frac{1}{2} {m}_{y} {{ω}_{y}^{2} ( {ϕ}_{y} - {y}_{e} )}^{2} + {\sum }_{j} {λ}_{Y}^{( j )} {φ}_{y} {φ}_{j}$$

$$or$$

$$\frac{1}{2} {m}_{y} {{ω}_{y}^{2} ( {φ}_{y} - {y}_{e} )}^{2} + {λ}_{Y} {\sum }_{j} {{λ}_{Y}^{( j )} ( {φ}_{y} - {φ}_{j} )}^{2} ,$$

where the ϕⱼ degrees of freedom are degrees of freedom of other oscillators in the first energy-based model 2800 that are coupled to the position degree of freedom (ϕ_{y}) of the output oscillator 2806. However, this difference (or said another way, simplification) manifests itself in a slightly different value for the equilibrium value (yₑ), or depending on the couplings, may result in the same yₑ equilibrium value. But this simplification does not affect the equilibrium results of the relay oscillator 2818. A similar issue applies to the input oscillator 2808, which is also coupled to other oscillators of the second energy-based model 2802. Also, in some embodiments, multiple relay oscillators 2810 may be coupled to multiple input oscillators (e.g. additional input oscillators in addition to input oscillator 2808). Note that the relay oscillator 2818 and the relay gadget 2804 (e.g., relay gadget 1522 or 1524) impart the equilibrium value of the output oscillator to the input oscillator, such that the position degree of freedom (ϕ_{X}) of the input oscillator 2808 inherits the same equilibrium value as the position degree of freedom (ϕ_{y}) of the output oscillator 2806, e.g. the position it had when first coupled to the relay oscillator 2818 of the relay gadget 2804. As such, thermodynamic information is relayed from the output oscillator 2806 to the input oscillator 2808 while remaining in a thermodynamic state. For example, analog information is passed between the first energy-based model 2800 and the second energy-based model 2802 without requiring a measurement by a classical computing device. Further note, this is done in an analog way (as opposed to a digitization that would take place during readout and re-initialization).

For a system undergoing Langevin dynamics, the equation of motion of a given oscillator (k) is given by:

$$\frac{d {φ}_{k} ( t )}{d t} = \frac{\partial {H}_{fan}}{\partial {π}_{k}}$$

$$\frac{{π}_{k} ( t )}{dt} = - γ {π}_{k} ( t ) - \frac{\partial {H}_{fan}}{\partial {φ}_{k}} {\vert}_{t} + \sqrt{2 {m}_{k} γ {k}_{B} T} \frac{{dW}_{t}}{dt}$$

where φ denotes the position degree of freedom of the oscillator and π denotes the momentum degree of freedom of the oscillator. Using the Hamiltonian for the coupled system shown in FIG. 28A (which is given further above) and the equations of motion for position and momentum given directly above, the equations of motions for the relay oscillator 2818, output oscillator 2806, the bias oscillator 2812, and the input oscillator 2808, are respectively given by:

Equation of motion for the relay oscillator:

$${m}_{r} ( t ) \frac{{d}^{2} {ϕ}_{γ}}{d {t}^{2}} + \frac{d {m}_{r} ( t )}{dt} \frac{d {ϕ}_{r}}{dt} + γ {m}_{r} ( t ) \frac{d {ϕ}_{r}}{d t} = \text{} - ( - 2 {λ}_{A} ( t ) ( {ϕ}_{y} - {ϕ}_{r} ) + {λ}_{B} ( t ) {ϕ}_{b} + {λ}_{X} ( t ) {ϕ}_{x} + {m}_{r} ( t ) {ω}_{r}^{2} {ϕ}_{r} ) + \sqrt{2 {m}_{r} ( t ) {k}_{B} T} \frac{{dW}_{t}^{( r )}}{dt}$$

$$or$$

$${m}_{r} ( t ) \frac{{d}^{2} {φ}_{r}}{d {t}^{2}} + \frac{d {m}_{r} ( t )}{dt} \frac{d {φ}_{r}}{dt} + γ {m}_{r} ( t ) \frac{d {φ}_{r}}{d t} = \text{} - ( - 2 {λ}_{A} ( t ) ( {φ}_{y} - {φ}_{r} ) - 2 {λ}_{B} ( t ) ( {φ}_{b} - {φ}_{r} ) + 2 {λ}_{X} ( t ) ( {φ}_{r} - {φ}_{x} ) + {m}_{r} ( t ) {ω}_{r}^{2} {φ}_{r} ) + \sqrt{2 {m}_{r} ( t ) {k}_{B} T} \frac{d {W}_{t}^{( r )}}{dt}$$

Depending on whether there is a linear or quadratic coupling.

Equation of motion for the output oscillator:

$${m}_{y} \frac{{d}^{2} {φ}_{y}}{d {t}^{2}} + γ {m}_{y} \frac{d {φ}_{y}}{d t} = - ( {λ}_{A} ( t ) {φ}_{y} + {m}_{y} {ω}_{y}^{2} ( {φ}_{y} - {φ}_{c} ) ) + \sqrt{2 {m}_{y} {k}_{B} T} \frac{d {W}_{t}^{( y )}}{d t}$$

$$Or$$

$${m}_{y} \frac{{d}^{2} {φ}_{y}}{d {t}^{2}} + γ {m}_{y} \frac{d {φ}_{y}}{d t} = \text{} - ( 2 {λ}_{A} ( t ) ( {φ}_{y} - {φ}_{r} ) + {m}_{y} {ω}_{y}^{2} ( {φ}_{y} - {φ}_{c} ) ) + \sqrt{2 {m}_{y} {k}_{B} T} \frac{d {W}_{t}^{( y )}}{d t}$$

Depending on whether there is a linear or quadratic coupling.

Equation of motion for the bias oscillator:

$${m}_{b} \frac{{d}^{2} {φ}_{b}}{d {t}^{2}} + γ {m}_{b} \frac{d {φ}_{b}}{d t} = - ( {λ}_{B} ( t ) {φ}_{r} + {m}_{b} {ω}_{b}^{2} {φ}_{b} ) + \sqrt{2 {m}_{b} {k}_{B} T} \frac{d {W}_{t}^{( b )}}{d t}$$

$$Or$$

$${m}_{b} \frac{{d}^{2} {φ}_{b}}{d {t}^{2}} + γ {m}_{b} \frac{d {φ}_{b}}{d t} = - ( - 2 {λ}_{B} ( t ) ( {φ}_{r} - {φ}_{b} ) + {m}_{b} {ω}_{b}^{2} {φ}_{b} ) + \sqrt{2 {m}_{b} {k}_{B} T} \frac{d {W}_{t}^{( b )}}{d t}$$

Depending on whether there is a linear or quadratic coupling.

Equation of motion for the input oscillator:

$${m}_{x} \frac{{d}^{2} {φ}_{x}}{d {t}^{2}} + γ {m}_{x} \frac{d {φ}_{x}}{d t} = - ( {λ}_{X} ( t ) {φ}_{r} + {m}_{x} {ω}_{x}^{2} {φ}_{x} ) + \sqrt{2 {m}_{x} {k}_{B} T} \frac{d {W}_{t}^{( x )}}{d t}$$

$$Or$$

$${m}_{x} \frac{{d}^{2} {φ}_{x}}{d {t}^{2}} + γ {m}_{x} \frac{d {φ}_{x}}{d t} = - ( - 2 {λ}_{X} ( t ) ( {φ}_{r} - {φ}_{x} ) + {m}_{x} {ω}_{x}^{2} {φ}_{x} ) + \sqrt{2 {m}_{x} {k}_{B} T} \frac{d {W}_{t}^{( x )}}{d t}$$

Depending on whether there is a linear or quadratic coupling.

Also, the time dependent mass of the relay oscillator 2818 is given by:

$${m}_{r} ( t ) = {m}_{f}^{( r )} σ ( {k}_{r} ( t - {t}_{r} ) ) + {m}_{r} .$$

FIG. 28B is a high-level diagram similar to FIG. 28A, wherein the relay gadget does not include a bias oscillator, according to some embodiments.

In some embodiments, such as when the relay oscillator is configured to have a controllable time-dependent mass, the use of a bias oscillator may be omitted. For example, if the product of mass times frequency squared of a first oscillator is much larger than the product of mass times frequency of a second oscillator (that is coupled to the first oscillator) the position degree of freedom of the first oscillator (having the larger value for the product of mass times frequency squared) may be treated as a constant. Thus, for embodiments, wherein the mass of the relay oscillator can be increased such that the product of mass times frequency squared of the relay oscillator is sufficiently large, it may not be necessary to further use a bias oscillator.

More particularly, consider two oscillators (oscillator a and oscillator b) with position degrees of freedom ϕₐ and ϕ_{b}. Suppose that ϕ_{b} has equilibrium value b_{c}. Assume ϕ_{b} is a constant and consider the Hamiltonian:

$${H}_{1} = \frac{1}{2} {m}_{a} {ω}_{a}^{2} {ϕ}_{a}^{2} + λ {ϕ}_{a} {b}_{c}$$

In this case, the expectation value of φₐ at thermal equilibrium is given by:

$$〈 {ϕ}_{a} 〉 = \frac{\int a {e}^{- β {H}_{1}} d a}{\int {e}^{- β {H}_{1}} d a} = \frac{λ {b}_{c}}{{m}_{a} {ω}_{a}^{2}}$$

Choosing λ=−mₐωₐ², it gives [symbol] ϕₐ [symbol] =b_{c}.

Also, considering the dynamics of ϕ_{b}. The Hamiltonian is:

$${H}_{2} = \frac{1}{2} {m}_{a} {ω}_{a}^{2} {ϕ}_{a}^{2} + \frac{1}{2} {m}_{b} {{ω}_{b}^{2} ( {ϕ}_{b} - {b}_{c} )}^{2} + λ {ϕ}_{a} {ϕ}_{b}$$

Moreover, using, H, [symbol] ϕₐ [symbol] is give by:

$$〈 {φ}_{a} 〉 = \frac{\int a {e}^{− β {H}_{2}} da db}{\int {e}^{− β {H}_{2}} da db} = − \frac{λ {b}_{c}}{{m}_{a} {ω}_{a}^{2} − \frac{{λ}^{2}}{{m}_{b} {ω}_{b}^{2}}} = \frac{{b}_{c}}{1 − \frac{{m}_{a} {ω}_{a}^{2}}{{m}_{b} {ω}_{b}^{2}}}$$

where λ is set such that λ=−mₐωₐ². Note that if mₐωₐ². <<m_{b}ω_{b}², then [symbol] ₐ [symbol] ≈b_{c}. As such as long as the mass times frequency squared of the oscillator a having position degree of freedom ϕₐ is much less than the mass times frequency squared of the oscillator b having position degree of freedom ϕ_{b}, the position degree of freedom ϕ_{b} can be treated as a constant, with the constant being the thermal equilibrium value of ϕ_{b}.

Said another way, if the product of mass times frequency squared of the relay oscillator 2818 is increased to be sufficiently large, then the inherited equilibrium value acquired from the output oscillator 2806 can be treated as a constant, while held by the relay oscillator 2818. Also, as long as the product of mass times frequency squared of the relay oscillator 2818 is sufficiently large as compared to the corresponding value of mass times frequency squared of the input oscillator 2808, the position degree of freedom of the relay oscillator may be treated as a constant, such that it relays the held equilibrium value acquired from the output oscillator 2806 of the first EBM 2800 to the input oscillator 2808 of the second EBM 2802.

Note that the relay oscillators used in the relay gadget configurations shown in FIGS. 30A-D include bias oscillators. However, in some embodiments, similar configurations may be used that do not include bias oscillators. For example, relay oscillators as shown in FIG. 7A or as shown in FIG. 7B may be used to construct the relay gadgets shown in FIGS. 30A-D.

FIG. 29 is a high-level flowchart illustrating a process of relaying thermodynamic information between an output oscillator, such as of a first energy-based model (EBM), and an input oscillator, such as of an analog Swish gadget, according to some embodiments.

At block 2900 a relay oscillator is initialized, wherein the relay oscillator is positioned such that it has connectivity to an output oscillator, such as output oscillator 2806 of energy-based model 2800, and has connectivity to an input oscillator, such as input oscillator 2808 of energy-based model 2802. Additionally, a bias oscillator is initialized, wherein the bias oscillator has connectivity to the relay oscillator. For example, bias oscillator 2812 may be initialized and is positioned in a way that it can be coupled to relay oscillator 2818.

At block 2902, the first energy-based model comprising the output oscillator, such as energy-based model 2800 that includes output oscillator 2806, is enabled to undergo thermal evolution such that the energy-based model evolves according to Langevin dynamics. The evolution may be enabled to occur for an amount of time such that the first energy-based model reaches a thermal equilibrium. As an example, the first energy-based model may represent a trained model that is configured to perform inference, and at least some oscillators of the first energy-based model may be clamped to input data, wherein inference results are represented by other oscillators of the first energy-based model subsequent to the thermal evolution. For example, output oscillator 2806 may represent the results of a computation performed by the energy-based model 2800 that are to be relayed as input data to the second energy-based model 2802.

At block 2904, once the oscillators of the first energy-based model (e.g. energy-based model 2800) have reached thermal equilibrium, the controller 2814 initiates pulses (e.g. λ_{A}(t) pulses) to cause the output oscillator 2806 to be coupled to the relay oscillator (e.g. relay oscillator 2818).

At block 2906, the controller 2814 initiates additional pulses (e.g., λ_{B}(t) pulses) that cause the relay oscillator to be coupled to the bias oscillator. Recall that initially the relay oscillator 2818 may have a small mass and/or frequency combination, e.g., small relative to the product of mass times frequency squared of the output oscillator 2806. Because the relay oscillator has a small product of mass times frequency squared, the relay oscillator more readily takes on the position of the output oscillator (for example, as opposed to the relay oscillator pulling the output oscillator to take on the relay oscillator's position). However, due to the relatively small mass times frequency squared of the relay oscillator, if left alone the relay oscillator would quickly lose the recently inherited position, inherited from the output oscillator. To avoid this, the relay oscillator is coupled to the bias oscillator 2812 at or near the same time as the relay oscillator is un-coupled from the output oscillator 2806. The relay oscillator may also be coupled to the bias oscillator at or near the same time it is coupled to the input oscillator 2808. Coupling the relay oscillator to the bias oscillator helps the relay oscillator to maintain the acquired thermal information (e.g., position degree of freedom, or, in some embodiments, momentum degree of freedom) the relay oscillator has acquired from the output oscillator. Also, while coupled to the bias oscillator and prior to being coupled to the input oscillator of the next EBM, a mass and/or frequency of the relay oscillator is adjusted.

For example, at block 2908, the controller 2814 causes control signals to be emitted that cause the mass (or frequency) of the relay oscillator to be adjusted. The mass of the relay oscillator may be proportional to capacitance of a circuit used to implement the relay oscillator; a Cooper-pair box arrangement may be used to implement a time dependent capacitance in the circuit (e.g. where the capacitance corresponds to mass). In such embodiments, the controller 2814 is configured to emit control signals to cause the Cooper-pair box to increase the capacitance of the relay oscillator circuit. However, in other embodiments, mass may be kept constant, but instead frequency of the relay oscillator may be adjustable as a result of a time-dependent flux element of a circuit used to implement the relay oscillator. For example, a current inducing flux element may be added to the relay oscillator circuit. In such embodiments, controller 2814 may emit control signals that cause the flux of the relay oscillator to be tuned (where flux corresponds to frequency). In some embodiments blocks 2906 and 2908 are performed concurrently.

At block 2910, the controller 2814 initiates another set of one or more pulses (e.g., Ax(t) pulses) to couple the relay oscillator to the input oscillator, such as input oscillator 2808. The bias oscillator 2812 may remain coupled to the relay oscillator 2818 when the relay oscillator 2818 is coupled to the input oscillator 2808. Note that since the relay oscillator has had its mass (and/or frequency) adjusted prior to the coupling to the input oscillator, and since the relay oscillator remains coupled to the bias oscillator, the relay oscillator has a large value of the product of mass times frequency squared relative to the input oscillator and therefore causes the input oscillator to take on the position of the relay oscillator, which corresponds to the position of the output oscillator. In this way, the relay gadget 2804 relays analog oscillator degree of freedom information (e.g. thermodynamic information) from the output oscillator to the input oscillator, without having to convert the thermodynamic information into classical form.

In some embodiments, a relay gadget, such as relay gadget 2804, may perform steps similar to those described in FIG. 29 in order to relay position degree of freedom thermodynamic information, momentum degree of freedom thermodynamic information, and/or force/acceleration degree of freedom thermodynamic information.

In some embodiments, a relay gadget, such as relay gadget 2804 may be used to store thermodynamic information, for example in the relay oscillator 2818. Also, in some embodiments, multiple relay gadgets may be used to form a thermodynamic network between thermodynamic components. Also, in some embodiments, a relay gadget may be used to perform conditional sampling, such as Gibbs sampling.

FIG. 30A is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

In some embodiments, it is desired to transfer an expectation value of one energy-based model (EBM) to another EBM, such as from an output of a transformer neural network layer gadget to an input of another EBM. In some embodiments an instantaneous sample value may be transferred from an output oscillator of one EBM (such as from the output oscillator 1514 of analog Swish gadget 1508) to an input oscillator of another EBM. The instantaneous sample value of an output oscillator of a given EBM will follow a probability distribution associated with the potential well of the output oscillator and couplings of the output oscillator with the one or more oscillators belonging to the first EBM. An instantaneous sample value of the state of the output oscillator may be any possible value within the bounds of the potential well and respective couplings. In some instances, the instantaneous sample value of the output oscillator may be far off from the expectation value (e.g. due to thermodynamic fluctuations, anharmonic potentials, multiple well potentials, the coupling between the output oscillator with other oscillators belonging to a shared EBM, or a combination of factors). Furthermore, the output oscillator of an EBM may hop between wells of a potential, thus the expectation value may not be a probable outcome of an instantaneous sample of the output oscillator. To avoid these issues, in some embodiments expectation values may be stored instead of sample values and relayed as inputs to other EBMs.

In some embodiments, to enable an expectation value of an output of an EBM to be used as an input to a subsequent EBM in a fully analogue fashion (e.g. without the use of measurements), two or more relay oscillators may be used. In some embodiments, an expectation value is derivable from one or more sample values. In some embodiments, relay oscillators may be oscillators which may be arranged between the output of a given EBM and the input of an additional EBM in such a way that their state may be configured to take on a sample value of the output oscillators of a given EBM. In some embodiments, sample values may be collected in such a way (e.g. spatial or temporal arrangement of relay oscillators as described below) that a close approximation of an expectation value of an output of a given EBM may be represented on one or more relay oscillators. Classical controllers may be used to turn the couplings on and off between the output oscillators and relay oscillators, between respective relay oscillators, as well as to make the masses and frequencies of the relay oscillators time dependent. Nevertheless, measurements may not be required, and the timing of the operations may be computed during a compilation step.

In some embodiments, a relay gadget may include a group of one or more relay oscillators and an additional relay oscillator. One or more relay oscillators of the group of relay oscillators may be coupled to an output oscillator of a first EBM. The one or more relay oscillators may be coupled in such a way that respective sample values of the output oscillator of the first EBM, wherein the output oscillator has progressed through thermodynamic evolution, may be stored on respective ones of the relay oscillators of the first group of one or more relay oscillators. An additional relay oscillator may be coupled to one or more of the relay oscillators, wherein the coupling enables the additional relay oscillator to take on an expectation value of the output oscillator, wherein the expectation value is derivable based at least in part on the sample values. In some embodiments, bias oscillators may be used. In some embodiments, bias oscillators may not be used. For simplicity, embodiments are given with bias oscillators, but it should be understood that is some embodiments bias oscillators may not be used for each relay oscillator of a relay gadget, however, that does not limit the embodiments to only one way or the other.

In some embodiments, thermodynamic information is relayed from a first energy-based model (EBM) 2800 to a second energy-based model (EBM) 2802 via relay gadget 2804. The thermodynamic information of EBM 2800 is outputted via output oscillator 2806 and inputted into input oscillator 2808 via relay gadget 2804. The thermodynamic information may include, for example, samples of thermodynamic equilibrium of output oscillator 2806, or the expectation value of the output oscillator 2806. The expectation value is at least derivable based on samples values of the output oscillator 2806. Output oscillator 2806 may be governed by a potential wherein the potential follows a single-well potential, double-well potential, multi-well potential, or any generic potential that may be engineered. The output oscillator 2806 may also be coupled to other oscillators belonging to EBM 2800. For example, output oscillator 2806 may be output oscillator 1514 of analog Swish gadget 1508.

In some embodiments, an expectation value of one or more degrees of freedom of output oscillator 2806 may be influenced by a potential of output oscillator 2806 as well as couplings between output oscillator 2806 and one or more oscillators belonging to first energy-based model 2800. Potentials governing the dynamics of the output oscillator 2806 may have multiple wells. With generic arbitrary potentials (e.g. multiple wells) and coupling between output oscillator 2806 and one or more oscillators belonging to first energy-based model 2800, the position degrees of freedom of the output oscillators can hop between wells. As described herein, a relay gadget provides a solution to approximate an expectation value of the output oscillator. For example, using an approximated expectation value in forwards and backwards propagation may provide better results than using a sample value, as the expectation value better represents the state of the oscillator whose degree of freedom value is being relayed to a second oscillator.

Relay gadget 2804 comprises a group of relay oscillators 3002 and an additional relay oscillator 3008. The group of relay oscillators 3002 comprises one or more relay oscillators arranged with respective bias oscillators (e.g., relay oscillator 3004 arranged with bias oscillator 3006). As described later, relay oscillators in oscillator group 3002 may be configured and coupled in various ways (e.g. temporally and spatially) to transfer thermodynamic information. The additional relay oscillator 3008 may be connected to bias oscillator 3004. As discussed later, the additional relay oscillator 3008 may be configured and coupled in various ways to transfer thermodynamic information. For example, the group of relay oscillators 3002 transfers thermodynamic information to additional relay oscillator 3008 via coupling. Coupling may be controlled by on-chip classical controller 2814.

Output oscillator 2806 is coupled to the one or more relay oscillators of the group of relay oscillators 3002 via on-chip classical controller 2814. On-chip classical controller 2814 may send a pulse or a group of pulses to cause couplings between oscillators (e.g., coupling between output oscillator 2806 and relay oscillator 3004) or relay oscillators like 3004 and a bias oscillator like 3006 via pulses. Coupling is represented by lines and oscillators may be coupled or not coupled. When coupling is on, parameters of respective coupled oscillators affect the other oscillator it is coupled to. Couplings between oscillators within the group of relay oscillators 3002 are not expressly shown in FIG. 30 to emphasize that the coupling may take different configurations (e.g. temporal or spatial configurations as detailed below). Nevertheless, on-chip classical controller 2814 may cause a first set of one or more pulses to be emitted through controller connection, wherein the first set of pulses couples one or more relay oscillators of the group of relay oscillators 3002 to the output oscillator 2806 (e.g., turn on coupling). The on-chip classical controller 2814 is further configured to cause a second set of one or more pulses to be emitted through a path, wherein the second set of pulses couples one or more relay oscillators of the group of relay oscillators 3002 to the additional relay oscillator 3008 (e.g., turn on coupling). The on-chip classical controller 2814 is further configured to cause a third set of one or more pulses to be emitted, wherein the third set of pulses couples the additional relay oscillator 3008 to the input oscillator 2808 (e.g., turn on coupling).

In some embodiments, an additional relay oscillator 3008 takes on an expectation value of an output oscillator 2806 based at least in part on a coupling or couplings between a group of relay oscillators 3002, wherein respective relay oscillators of group 3002 comprise respective sample values of the output oscillator 2806. The additional relay oscillator 3008 may take on the expectation value of output oscillator 2806 based at least on respective sample values taken on by respective relay oscillators. Furthermore, additional relay oscillator 3008 may transfer the taken on expectation value to input oscillator 2808 via controller 2814 causing coupling to turn on.

FIG. 30B is a high-level diagram illustrating a spatial analogue relay gadget, wherein respective ones of relay oscillators of a group of relay oscillators are configured to store respective sample values of an output oscillator, according to some embodiments.

In some embodiments, controller 2814 sends a first set of one or more pulses wherein the first set of pulses causes output oscillator 2806 of first energy-based model (EBM) 2800 to be coupled to at least one or more relay oscillators {ϕᵣ_{₁}, ϕᵣ_{₂}, . . . ϕᵣ_{_{N}}}, in the group of relay oscillators 3002. The group of relay oscillators 3002 comprises a plurality of relay oscillators, wherein respective relay oscillators {ϕᵣ_{₁}, ϕᵣ_{₂}, . . . ϕᵣ_{_{N}}}, are configured to store a sample of the output oscillator 2806 based at least in part on respective couplings between the respective ones of the relay oscillators (e.g., 3004) of the group of relay oscillators 3002 and the output oscillator 2806. The on-chip classical controller 2814 is further configured to cause another set of one or more pulses to be emitted, wherein the other set of pulses turns off the respective couplings between the output oscillator 2806 and the respective ones of the relay oscillator of the group of relay oscillators 3002 at different times. This may allow different samples of the output oscillator 2806 to be stored on the respective ones of the relay oscillators {ϕᵣ_{₁}, ϕᵣ_{₂}, . . . ϕᵣ_{_{N}}}.

On-chip classical controller 2814 may be further configured to cause a second set of one or more pulses to be emitted, wherein the second set of pulses turns on the coupling between respective ones of the relay oscillators with sample values of the output oscillator 2806 to an additional relay oscillator 3008. The coupling is configured to transfer an approximation of the expectation value of output oscillator 2806 based at least in part on the sample values stored on respective relay oscillators in the first group of relay oscillators 3002. Once the additional relay oscillator 3008 is tuned to the expectation value of output oscillator 2806, controller 2814 may cause a set of one or more pulses that may cause the additional relay oscillator 3008 to be coupled to input oscillator 2808. For ease of illustration a version that includes bias oscillators is shown. However, it should be understood that in some embodiments bias oscillators may be omitted.

FIG. 30C is a high-level diagram illustrating a temporal analogue relay gadget, wherein a group of relay oscillators comprises a single relay oscillator, according to some embodiments.

In some embodiments, the group of relay oscillators 3002 comprises a single relay oscillator 3004. The single relay oscillator 3004 is configured to store a sample of the output oscillator 2806 based at least in part on the coupling between the single relay oscillator 3004 and the output oscillator 2806. The coupling between output oscillator 2806 and single relay oscillator 3004 is caused by a first set of one or more pulses emitted from on-chip classical controller 2814. The on-chip classical controller 2814 is configured to cause a second set of one or more pulses to be emitted, wherein the second set of pulses causes the single relay oscillator 3004 to be coupled to additional relay oscillator 3008. The sequence of emitting the first set of pulses and then emitting the second set of pulses may be repeated numerous times. Each instance the sequence of the sequential sets of pulses is emitted, the position of additional relay oscillator 3008 is incrementally adjusted. Each adjustment may converge the additional relay oscillator 3008 to the expectation value of output oscillator 2806. For ease of illustration a version that includes bias oscillators is shown. However, it should be understood that in some embodiments bias oscillators may be omitted.

FIG. 30D is a high-level diagram illustrating a series analogue relay gadget, wherein a group of relay oscillators comprises a plurality of relay oscillators arranged in series, according to some embodiments.

For example, FIG. 30D shows a drawing of a series analogue relay gadget 2804. The group of relay oscillators 3002 comprises a plurality of relay oscillators {ϕᵣ_{₁}, ϕᵣ_{₂}, . . . } (e.g. relay oscillator 3004a, 3004b, 3004c) arranged one after another in series. Each relay oscillator has a product of mass and frequency squared. The first relay oscillator 3004a, ϕᵣ_{₂}, has the smallest product of mass and frequency squared. The next relay oscillator 3004b, ϕᵣ_{₂}, has a product of mass and frequency squared larger than the previous relay oscillator 3004a, ϕᵣ_{₁}. This trend of increasing the product of mass and frequency squared continues for each subsequent relay oscillator in the group of relay oscillators 3002. As last in the chain of relay oscillators, the additional relay oscillator 3008 has the largest product of mass and frequency squared. The couplings between relay oscillators and the coupling between the output oscillator 2806 and the first relay oscillator 3004a, ϕᵣ_{₁}, may be turned on at the same time and allowed to evolve thermodynamically according to Langevin dynamics. Once coupling is initiated, each successive relay oscillator takes continuous samples of the previous oscillator it is coupled to. Furthermore, each successive relay oscillator may be a closer approximation of the expectation value of the output oscillator 2806. In this manner, additional relay oscillator 3008 approximates an expectation value of input oscillator 2806. At this point, coupling between the additional relay oscillator 3008 and input oscillator 2808 may be turned on and the thermodynamic information may be transferred to input oscillator 2808. The number of relay oscillators and the timing of coupling may be chosen beforehand and optimized for a desired precision or accuracy of the expectation value of the output relay oscillator. For ease of illustration a version that includes bias oscillators is shown. However, it should be understood that in some embodiments bias oscillators may be omitted.

FIG. 31A illustrates example couplings between visible neurons of an energy-based model (EBM), according to some embodiments.

In some embodiments, input neurons and output neurons of an energy-based model, such as visible neurons 3102 and visible neurons 3104, may be directly linked via connected edges 3106. As shown in FIG. 31A, a given visible neuron 3102 of the five shown in the figure is connected, via edges 3106, to each of the respective three visible neurons 3104. A person having ordinary skill in the art should understand that FIG. 31A is meant to represent example embodiments of a graph architecture implemented using a thermodynamic chip that may be applied and that specific numbers of visible neurons 3102 and/or visible neurons 3104 shown in the figure are not meant to be restrictive. Additional configurations combining more/less visible neurons 3102 and/or visible neurons 3104 are also encompassed by the discussion herein. In addition, recall that neurons are logical representations of physical oscillators, such that, when describing neurons in FIGS. 31A and 31B, it should be understood that neurons and edges are implemented using oscillators and couplings.

FIG. 31B illustrates example couplings between visible neurons and non-visible neurons (e.g., hidden neurons) of an energy-based model (EBM), according to some embodiments.

In some embodiments, FIG. 31B may resemble additional example embodiments of an energy-based model architecture implemented using a thermodynamic chip. As shown in the figure, additional non-visible neurons 3108 may be used, which are respectively coupled, via edges 3106, to both visible neurons 3102 and to visible neurons 3104. Note that while the non-visible neurons are “not visible” from the perspective of inputs and outputs, the non-visible neurons may each correspond to a given oscillator. In addition, it may be noted that, in some embodiments that make use of non-visible neurons, no direct connections, via edges 3106, may be implemented between visible neurons 3102 and visible neurons 3104, but rather connections are routed firstly via non-visible neurons 3108, as shown in FIG. 31B. Couplings between visible and non-visible neurons may be additionally referred to herein as “layers” of a given energy-based model architecture that is implemented using a thermodynamic chip, according to some embodiments.

FIG. 32 is a high-level diagram illustrating a process of determining weights and biases to be used in an energy-based model (EBM), wherein the weights and biases are determined using measurement values for synapse oscillators, according to some embodiments.

As shown in FIG. 32, in a first evolution, visible neurons of an energy-based model implemented on a thermodynamic chip 3202 may be clamped to input data. For example, multiple mini-batches of input data may be clamped to visible neurons for multiple evolutions used to generate a first set of measurements used to compute a positive phase term. For example, the measurements may be used by classical computing device 3204 to compute the positive phase term.

Also, in a second (or other subsequent) evolution, the visible neurons may remain unclamped, such that the visible neuron oscillators are free to evolve along with the synapse oscillators during the second (or other subsequent) evolution. Measurements may also be taken and used by the classical computing device 3204 to compute a negative phase term.

Additionally, the positive and negative phase terms computed based on the first and second sets of measurements (e.g., clamped measurements and un-clamped measurements) may be used to calculate updated weights and biases.

This process may be repeated, with the determined updated weights and biases used as initial weights and biases for a subsequent iteration. In some embodiments, inferences generated using the updated weights and biases may be compared to training data to determine if the energy-based model has been sufficiently trained. If so, the model may transition into a mode of performing inferences using the learned weights and biases.

If not sufficiently trained, the process may continue with additional iterations of determining updated weights and biases.

FIG. 33 is a high-level diagram illustrating a process of determining weights and biases to be used in an energy-based model (EBM), wherein the weights and biases are computed using a classical computing device, according to some embodiments.

In some embodiments, updated weights and bias values may be computed iteratively by classical computing device 3304 based on inference measurements from thermodynamic chip 3302. For example, inference values may be compared to training data values, and new weights and biases may be iteratively computed until the inference values closely correspond to the training data. As can be seen in FIG. 33, in some embodiments the synapse oscillator may be omitted as degrees of freedom of the energy-based model. For example, when a classical computing device is used to iteratively determine the weight and bias values.

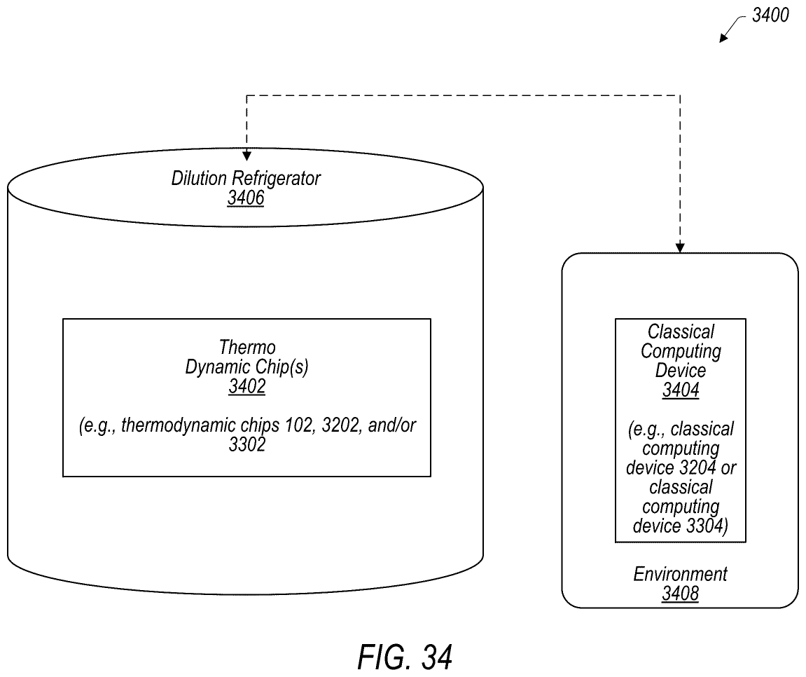

FIG. 34 is high-level diagram illustrating an example neuro-thermodynamic computer comprising a thermodynamic chip (e.g., that implements multiple energy-based models (EBMs) and a relay gadget) included in a dilution refrigerator and coupled to a classical computing device in an environment external to the dilution refrigerator, according to some embodiments.

In some embodiments, a neuro-thermodynamic computing system 3400 (as shown in FIG. 34) may be used to implement the various embodiments shown in FIGS. 1-33 and may include one or more thermodynamic chip(s) 3402 placed in a dilution refrigerator 3406. In some embodiments, classical computing device 3404 may control temperature for dilution refrigerator 3406, and/or perform other tasks, such as helping to drive a pulse drive to change respective hyperparameters of the given system and/or perform measurements, such as those shown in FIGS. 1-33. Also, the classical computing device 3404 may perform other simple computing operations, such as are needed to determine updated weights and biases.

In some embodiments, classical computing device 3404 may include one or more devices such as a field-programmable gate array (FPGA), an application specific integrated circuit (ASIC), and/or other devices that may be configured to interact and/or interface with a thermodynamic chip within the architecture of neuro-thermodynamic computer 3400. For example, such devices may be used to tune hyperparameters of the given thermodynamic system, etc. as well as perform part of the calculations necessary to determine updated weights and biases. In some embodiments, the classical computing device 3404 may be placed in an environment 3406 outside of the dilution refrigerator 3406.

As shown in FIG. 34, in embodiments where more than one thermodynamic chip is used with a relay gadget, multiple ones of the thermodynamic chips and the relay gadget may be placed in the same dilution refrigerator 3406.

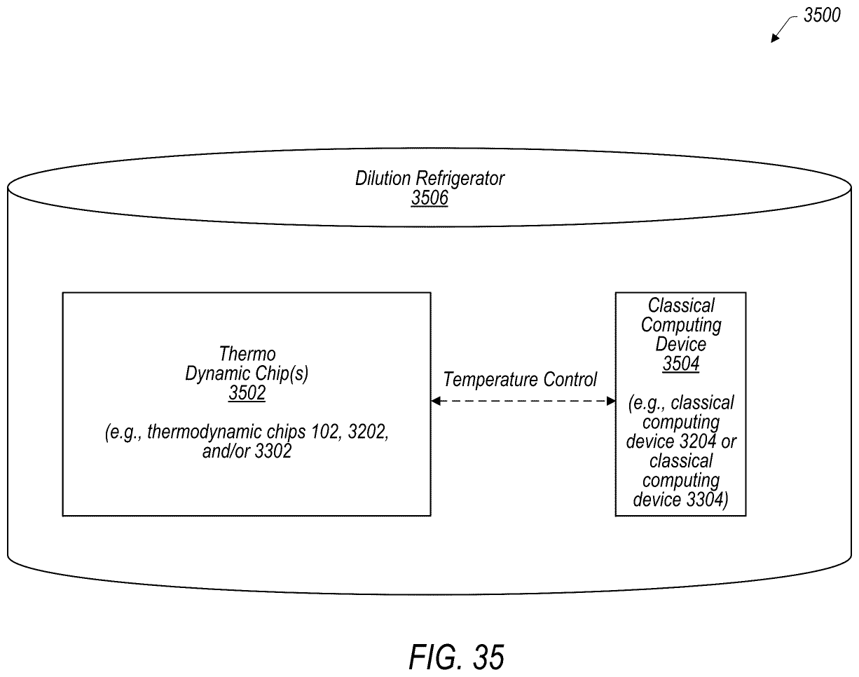

FIG. 35 is high-level diagram illustrating an example neuro-thermodynamic computer comprising a thermodynamic chip (e.g., that implements multiple energy-based models (EBMs) and a relay gadget) included in a dilution refrigerator and coupled to a classical computing device that is also included in the dilution refrigerator, according to some embodiments.

As another alternative, in some embodiments, a classical computing device used in a neuro-thermodynamic computer, such as in neuro-thermodynamic computer 3500, may be included in a dilution refrigerator with the thermodynamic chip. For example, neuro-thermodynamic computer 3500 includes both thermodynamic chip 3502 and classical computing device 3504 in dilution refrigerator 3506.

FIG. 36 is high-level diagram illustrating an example neuro-thermodynamic computer comprising one or more thermodynamic chips (e.g., that implement respective energy-based models (EBMs) and a relay gadget) coupled to a classical computing device in an environment other than a dilution refrigerator, according to some embodiments.

Also, in some embodiments, a neuro-thermodynamic computer, such as neuro-thermodynamic computer 3600, may be implemented in an environment other than a dilution refrigerator. For example, neuro-thermodynamic computer 3600 includes thermodynamic chip(s) 3602 and classical computing device 3604, in environment 3606. In some embodiments, environment 3606 may be temperature controlled and, the classical computing device (or other device) may control the temperature of environment 3606 in order to achieve a given level of evolution according to Langevin dynamics.

FIG. 37 is a high-level diagram illustrating oscillators included in a substrate of the thermodynamic chip and mapping of the oscillators to logical neurons of the thermodynamic chip, according to some embodiments.

In some embodiments, a substrate 3702 may be included in a thermodynamic chip, such as any one of the thermodynamic chips described above. Oscillators 3704 of substrate 3702 may be mapped in a logical representation 3752 to neurons 3754, as well as weights and biases (shown in FIG. 38). In some embodiments, oscillators 3704 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 3704. In some embodiments, the oscillators 3704 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 37 for oscillator 3704. However, in some embodiments, generally speaking various non-linear flux loops may be used to implement the oscillators 3704, such as those having single-well potential, double-well potential, or various other potentials, such as a potential somewhere between a single-well potential and a double-well potential.

FIG. 38 is an additional high-level diagram illustrating oscillators included in a substrate of the thermodynamic chip mapped to logical neurons, weights, and biases of a given neuro-thermodynamic computing system, according to some embodiments.

While weights and biases are not shown in FIG. 37 for ease of illustration, respective ones of the visible neurons 3754 of FIG. 37 may each have an associated bias, and edges connecting the neurons 3754 may have associated weights. Each of the weights and biases may be mapped to oscillators in the thermodynamic chip, as well as the visible (and non-visible) neurons being mapped to oscillators in the thermodynamic chip. For example, FIG. 38 shows a portion of a thermodynamic chip, wherein weights and biases associated with a given neuron 3854 are shown. For example, bias 3856 may be a bias value for visible neuron 3854 and weights 3858 and 3860 may be weights for edges formed between visible neuron 3854 and other visible neurons of the thermodynamic chip. As shown in FIG. 38, each of the chip elements (visible neuron 3854, bias 3856, weight 3858, and weight 3860) may be mapped to separate ones of oscillators 3804. This may allow the visible neurons (and/or hidden neurons), weights, and biases to have independent degrees of freedom within a given thermodynamic chip that can separately evolve.

In some embodiments, oscillators associated with weights and biases, such as bias 3856 and weights 3858 and 3860, may be allowed to evolve during a training phase and may be held nearly constant during an inference phase. For example, in some embodiments, larger “masses” may be used for the weights and biases such that the weights and biases evolve more slowly than the visible neurons. This may have the effect of holding the weight values and the bias values nearly constant during an evolution phase used for generating inference values.

### Illustrative Computer System

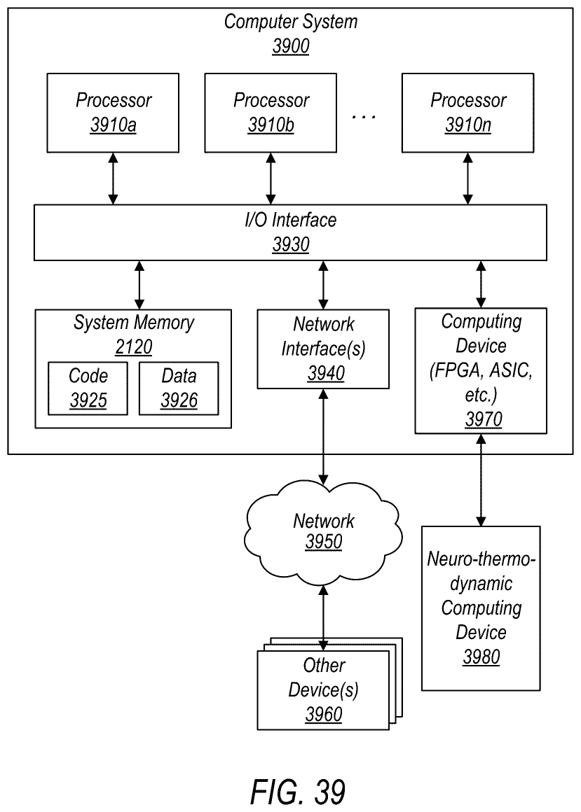

FIG. 39 is a block diagram illustrating an example computer system that may be used in at least some embodiments. In some embodiments, the computing system shown in FIG. 39 may be used, at least in part, to implement any of the techniques described above in FIGS. 1-38. Furthermore, computer system 3900 may be configured to interact and/or interface with self-learning neuro-thermodynamic computing device 3980, according to some embodiments.

In the illustrated embodiment, computer system 3900 includes one or more processors 3910 coupled to a system memory 3920 (which may comprise both non-volatile and volatile memory modules) via an input/output (I/O) interface 3930. Computer system 3900 further includes a network interface 3940 coupled to I/O interface 3930. Classical computing functions may be performed on a classical computer system, such as computing computer system 3900.

Additionally, computer system 3900 includes computing device 3970 coupled to thermodynamic chip 3980. In some embodiments, computing device 3970 may be a field programmable gate array (FPGA), application specific integrated circuit (ASIC) or other suitable processing unit. In some embodiments, computing device 3970 may be a similar computing device as described in FIGS. 1-38, such as classical computing devices 3204. In some embodiments, neuro thermodynamic computing device 3980 may be a similar neuro thermodynamic computing device as described in FIGS. 1-38, such as neuro thermodynamic computing devices implemented using thermodynamic chip(s) 100.

In various embodiments, computer system 3900 may be a uniprocessor system including one processor 3910, or a multiprocessor system including several processors 3910 (e.g., two, four, eight, or another suitable number). Processors 3910 may be any suitable processors capable of executing instructions. For example, in various embodiments, processors 3910 may be general-purpose or embedded processors implementing any of a variety of instruction set architectures (ISAs), such as the x86, PowerPC, SPARC, or MIPS ISAs, or any other suitable ISA. In multiprocessor systems, each of processors 3910 may commonly, but not necessarily, implement the same ISA. In some implementations, graphics processing units (GPUs) may be used instead of, or in addition to, conventional processors.

System memory 3920 may be configured to store instructions and data accessible by processor(s) 3910. In at least some embodiments, the system memory 3920 may comprise both volatile and non-volatile portions; in other embodiments, only volatile memory may be used. In various embodiments, the volatile portion of system memory 3920 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 3920 as code 3925 and data 3926.

In some embodiments, I/O interface 3930 may be configured to coordinate I/O traffic between processor 3910, system memory 3920, computing device 3970, and any peripheral devices in the computer system, including network interface 3940 or other peripheral interfaces such as various types of persistent and/or volatile storage devices. In some embodiments, I/O interface 3930 may perform any necessary protocol, timing or other data transformations to convert data signals from one component (e.g., system memory 3920) into a format suitable for use by another component (e.g., processor 3910). In some embodiments, I/O interface 3930 may include support for devices attached through various types of peripheral buses, such as a variant of the Peripheral Component Interconnect (PCI) bus standard or the Universal Serial Bus (USB) standard, for example. In some embodiments, the function of I/O interface 3930 may be split into two or more separate components, such as a north bridge and a south bridge, for example. Also, in some embodiments some or all of the functionality of I/O interface 3930, such as an interface to system memory 3920, may be incorporated directly into processor 3910.

Network interface 3940 may be configured to allow data to be exchanged between computing device 3900 and other devices 3960 attached to a network or networks 3950, such as other computer systems or devices. In various embodiments, network interface 3940 may support communication via any suitable wired or wireless general data networks, such as types of Ethernet network, for example. Additionally, network interface 3940 may support communication via telecommunications/telephony networks such as analog voice networks or digital fiber communications networks, via storage area networks such as Fibre Channel SANs, or via any other suitable type of network and/or protocol.

In some embodiments, system memory 3920 may represent one embodiment of a computer-accessible medium configured to store at least a subset of program instructions and data used for implementing the methods and apparatus discussed in the context of FIG. 1 through FIG. 38. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 3900 via I/O interface 3930. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 3900 as system memory 3920 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 3940. Portions or all of multiple computing devices such as that illustrated in FIG. 39 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system, comprising:
one or more thermodynamic chips, comprising oscillators, wherein:
respective ones of the oscillators are configured to be coupled with one another in one or more configurations that correspond to one or more engineered potentials, wherein the coupling implements components of a transformer neural network architecture,
wherein the transformer neural network architecture comprises:
a set of input oscillators of the oscillators of the one or more thermodynamic chips configured to receive input thermodynamic data to be processed via a trained transformer neural network thermodynamically orchestrated using the components of the transformer neural network; and
a set of output oscillators of the oscillators of the one or more thermodynamic chips configured to provide output thermodynamic data that has been transformed via the trained transformer neural network based on relationships in the thermodynamic input data.

2. The system of claim 1, wherein the components of the transformer neural network architecture comprise two or more of:
a matrix multiplication gadget;
a dot product gadget;
a layer norm gadget; or
an activation function gadget.

3. The system of claim 1, wherein the components of the transformer neural network architecture comprise a matrix multiplication gadget comprising:
a set of oscillators of the oscillators of the one or more thermodynamic chips configured to perform matrix multiplication, the set of oscillators comprising:
input vector component oscillators;
matrix component oscillators; and
output vector component oscillators,
wherein to perform the matrix multiplication, the set of oscillators are configured to:
obtain thermodynamic data on the input vector component oscillators;
perform one or more couplings of respective ones of the input vector component oscillators with respective ones of the output vector component oscillators to implement an engineered potential, wherein the engineered potential thermodynamically implements the matrix multiplication; and
perform one or more thermodynamic evolutions based on the engineered potential,
wherein the one or more thermodynamic evolutions based on the engineered potential causes the output vector component oscillators to obtain results of the matrix multiplication encoded as thermodynamic data based on the thermodynamic data provided to the input vector component oscillators.

4. The system of claim 1, wherein the components of the transformer neural network architecture comprise a dot product gadget comprising:
a set of oscillators of the oscillators of the one or more thermodynamic chips configured to perform a dot product, the set of oscillators comprising:
vector component oscillators;
additional vector component oscillators;
intermediate oscillators; and
an output oscillator,
wherein to perform the dot product, the set of oscillators are configured to:
obtain thermodynamic data, corresponding to a vector, on the vector component oscillators;
obtain additional thermodynamic data, corresponding to another vector, on the additional vector component oscillators;
couple to each other to implement an engineered potential, wherein the engineered potential thermodynamically implements the dot product between the vector component oscillators and the other set of vector component oscillators; and
thermodynamically evolve based on the engineered potential,
wherein the thermodynamic evolution based on the engineered potential causes the output oscillator to obtain a result of the dot product based on the thermodynamic data provided to the vector component oscillators and the additional thermodynamic data provided to the other vector component oscillators.

5. The system of claim 1, wherein the components of the transformer neural network architecture comprise a layer norm gadget comprising:
a set of oscillators of the oscillators of the one or more thermodynamic chips configured to perform a layer normalization, the set of oscillators comprising:
input oscillators;
output oscillators; and
intermediate oscillators,
wherein to perform the layer normalization, the set of oscillators are configured to:
obtain thermodynamic data on the input oscillators;
couple to each other to implement an engineered potential, wherein the engineered potential thermodynamically implements the layer normalization; and
thermodynamically evolve based on the engineered potential,
wherein the thermodynamic evolution based on the engineered potential is configured to cause:
a mean oscillator of the intermediate oscillators to obtain a mean value, encoded as thermodynamic data, of respective position degree of freedom of the input oscillators and shift each input oscillator by the mean value;
a variance oscillator of the intermediate oscillators to obtain a variance value, encoded as thermodynamic data, of the respective position degree of freedom of the input oscillators; and
the output oscillators to obtain a result of the layer normalization based on the thermodynamic data provided to the input oscillators and the mean value and variance value.

6. The system of claim 1, wherein the components of the transformer neural network architecture comprise an activation function gadget comprising:
a sigmoid gadget;
a SoftMax gadget; or
a swish activation gadget.

7. The system of claim 6, wherein the transformer neural network architecture comprises a sigmoid gadget comprising:
a set of oscillators of the oscillators of the one or more thermodynamic chips configured to perform a sigmoid function, the set of oscillators comprising:
an input oscillator; and
an output oscillator;
wherein to perform the sigmoid function, the set of oscillators are configured to:
obtain thermodynamic information on the input oscillator;
couple to each other to implement an engineered potential, wherein the engineered potential thermodynamically implements the sigmoid function; and
thermodynamically evolve based on the engineered potential,
wherein the thermodynamic evolution based on the engineered potential is configured to cause the output oscillator to obtain a result of the sigmoid function based on input provided to the input oscillator.

8. The system of claim 6, wherein the transformer neural network architecture comprises a SoftMax gadget comprising:
a first set of oscillators of the oscillators of the one or more thermodynamic chips; and
a second set of oscillators of the oscillators of the one or more thermodynamic chips, the second set of oscillators configured to perform a SoftMax function, wherein to perform the SoftMax function, the second set of oscillators are configured to:
couple to the first set of oscillators, wherein the first set of oscillators have a first set of respective values; and
thermodynamically evolve based on a given engineered potential for the second set of oscillators, wherein the given engineered potential thermodynamically implements the SoftMax function.

9. The system of claim 6, wherein the transformer neural network architecture comprises a swish gadget comprising:
a set of oscillators of the oscillators of the one or more thermodynamic chips configured to perform a Swish function, the set of oscillators comprising:
an input oscillator;
an output oscillator; and
one or more additional oscillators,
wherein to perform the Swish function, the set of oscillators are configured to:
obtain thermodynamic information on the input oscillator;
couple to each other to implement an engineered potential, wherein the engineered potential thermodynamically implements the Swish function; and
thermodynamically evolve based on the engineered potential,
wherein the thermodynamic evolution based on the engineered potential causes the output oscillator to obtain a result of the Swish function based on input provided to the input oscillator.

10. The system of claim 1, wherein the transformer neural network architecture comprises an attention gadget comprising:
a SoftMax gadget; and
a set of oscillators of the oscillators of the one or more thermodynamic chips,
wherein the attention gadget is configured to perform an attention operation, wherein to perform the attention operation, the attention gadget is configured to:
couple the SoftMax gadget to the set of oscillators to implement an engineered potential, wherein the engineered potential thermodynamically implements the attention operation; and
thermodynamically evolve based on the engineered potential,
wherein the thermodynamic evolution based on the engineered potential causes output oscillators of the set of oscillators to obtain results of the attention operation.

11. The system of claim 1, wherein the transformer neural network architecture comprises a feed forward gadget comprising:
a set of oscillators of the oscillators of the one or more thermodynamic chips configured to perform a feed forward network, the set of oscillators comprising:
input oscillators;
output oscillators; and
additional oscillators,
wherein to perform the feed forward network, the set of oscillators are configured to:
obtain thermodynamic data on the input oscillators;
couple to each other to implement an engineered potential, wherein the engineered potential thermodynamically implements the feed forward network; and
thermodynamically evolve based on the engineered potential,
wherein the thermodynamic evolution based on the engineered potential causes the output oscillators to obtain a result of the feed forward network based on the thermodynamic data provided to the input oscillators.

12. The system of claim 1, wherein the transformer neural network architecture comprises an add layer gadget comprising:
a set of oscillators of the oscillators of the one or more thermodynamic chips configured to perform an add layer operation,
wherein to perform the add layer operation, the set of oscillators are configured to:
obtain thermodynamic data, based on input thermodynamic data to a given layer of the transformer neural network architecture;
obtain additional thermodynamic data, based on output thermodynamic data from the given layer of the transformer neural network architecture;
couple to each other to implement an engineered potential, wherein the engineered potential thermodynamically implements the add layer operation; and
thermodynamically evolve based on the engineered potential,
wherein the thermodynamic evolution based on the engineered potential causes respective ones of the set of oscillators to obtain a result of the add layer operation based on the thermodynamic data and additional thermodynamic data.

13. A method, comprising:
implementing one or more components of a transformer neural network architecture using one or more thermodynamic chips, wherein the one or more thermodynamic chips comprise oscillators comprising:
a set of input oscillators configured to obtain input thermodynamic data to be processed via a trained transformer neural network thermodynamically orchestrated using the components of the transformer neural network; and
a set of output oscillators configured to provide output thermodynamic data that has been transformed via the trained transformer neural network based on relationships in the thermodynamic input data;
providing output to determine inference values for the trained transformer neural network.

14. The method of claim 13, wherein the one or more components of the transformer neural network architecture comprise two or more of:
a matrix multiplication gadget;
a dot product gadget;
a layer norm gadget; or
an activation function gadget.

15. The method of claim 13, wherein to implement the one or more components of the transformer neural network architecture, the method comprises:
obtaining thermodynamic data on a set of input vector component oscillators, wherein the set of input vector component oscillators represent components of an input vector;
performing one or more couplings of respective ones of the set of input vector component oscillators with respective ones of a set of output vector component oscillators to implement an engineered potential, wherein:
the set of output vector component oscillators represent components of an output vector; and
the engineered potential thermodynamically implements a matrix multiplication; and
performing one or more thermodynamic evolutions based on the engineered potential,
wherein the one or more thermodynamic evolutions based on the engineered potential causes the set of output vector component oscillators to obtain results of the matrix multiplication, encoded as thermodynamic data, based on the thermodynamic data provided to the set of input vector component oscillators.

16. The method of claim 13, wherein to implement the one or more components of the transformer neural network architecture, the method comprises:
obtaining thermodynamic data, corresponding to a vector, on a set of vector component oscillators;
obtaining additional thermodynamic data, corresponding to another vector, on another set of vector component oscillators;
performing one or more couplings of both sets of vector component oscillators and an output oscillator to an intermediate set of oscillators to implement an engineered potential, wherein the engineered potential thermodynamically implements a dot product between the vector component oscillators and the other set of vector component oscillators; and
performing one or more thermodynamic evolutions based on the engineered potential,
wherein the one or more thermodynamic evolutions based on the engineered potential causes the output oscillator to obtain a result of the dot product based on the thermodynamic data provided to the vector component oscillators and the additional thermodynamic data provided to the other vector component oscillators.

17. The method of claim 13, wherein to implement the one or more components of the transformer neural network architecture, the method comprises:
obtaining thermodynamic data on component input oscillators of a set of oscillators of the oscillators of the one or more thermodynamic chips;
coupling the set of oscillators to each other to implement an engineered potential, wherein the engineered potential thermodynamically implements layer normalization; and
thermodynamically evolving based on the engineered potential,
wherein the thermodynamic evolution based on the engineered potential causes output oscillators of the set of oscillators to obtain a result of the layer normalization based on the thermodynamic data provided to the input oscillators.

18. The method of claim 13, wherein the one or more components of the transformer neural network architecture comprise an activation function gadget comprising:
a sigmoid gadget;
a SoftMax gadget; or
a swish activation gadget.

19. The method of claim 18, wherein to implement the activation function gadget, the method comprises:
obtaining thermodynamic information on an input oscillator of a set of oscillators of the oscillators of the one or more thermodynamic chips;
coupling the set of oscillators to each other to implement an engineered potential, wherein the engineered potential thermodynamically implements a sigmoid function; and
performing one or more thermodynamic evolutions based on the engineered potential,
wherein the one or more thermodynamic evolutions based on the engineered potential causes an output oscillator of the set of oscillators to obtain a result of the sigmoid function based on input provided to the input oscillator.

20. The method of claim 18, wherein to implement the activation function gadget, the method comprises:
coupling a set of output oscillators of the oscillators of the one or more thermodynamic chips to a set of SoftMax oscillators of the oscillators of the one or more thermodynamic chips implementing a SoftMax gadget; and
performing one or more thermodynamic evolutions based on an engineered potential for the set of SoftMax oscillators, wherein the engineered potential thermodynamically implements a SoftMax function; and
providing thermodynamic output to obtain probabilities corresponding to SoftMax function.

21. The method of claim 18, wherein to implement the activation function gadget, the method comprises:
obtaining thermodynamic information on an input oscillator of a set of oscillators of the oscillators of the one or more thermodynamic chips;
coupling the set of oscillators to each other to implement an engineered potential, wherein the engineered potential thermodynamically implements a Swish function; and
performing one or more thermodynamic evolutions based on the engineered potential,
wherein the one or more thermodynamic evolutions based on the engineered potential causes the output oscillator to obtain a result of the Swish function based on input provided to the input oscillator.

22. The method of claim 13, wherein to implement the one or more components of the transformer neural network architecture, the method comprises:
coupling a SoftMax gadget to a set of oscillators of the oscillators of one or more thermodynamic chips to implement an engineered potential, wherein the engineered potential thermodynamically implements an attention operation; and
thermodynamically evolving based on the engineered potential,
wherein the thermodynamic evolution based on the engineered potential causes output oscillators of the set of oscillators to obtain results of the attention operation.

23. The method of claim 13, wherein to implement the one or more components of a transformer neural network architecture, the method comprises:
obtaining thermodynamic data on input oscillators of the oscillators of the one or more thermodynamic chips;
coupling respective ones of the oscillators of one or more thermodynamic chips to each other to implement an engineered potential, wherein the engineered potential thermodynamically implements a feed forward network; and
thermodynamically evolving based on the engineered potential,
wherein the thermodynamic evolution based on the engineered potential causes the output oscillators to obtain a result of the feed forward network based on the thermodynamic data provided to the input oscillators.

24. The method of claim 13, wherein to implement the one or more components of the transformer neural network architecture, the method comprises:
obtaining thermodynamic data, based on input thermodynamic data for a given layer of the transformer neural network architecture, on a set of oscillators of the oscillators of the one or more thermodynamic chips;
obtaining additional thermodynamic data, based on output thermodynamic data from the given layer of the transformer neural network architecture, on another set of oscillators of the oscillators of the one or more thermodynamic chips;
coupling the set of oscillators and the other set of oscillators to each other to implement an engineered potential, wherein the engineered potential thermodynamically implements an add layer operation; and
thermodynamically evolving based on the engineered potential,
wherein the thermodynamic evolution based on the engineered potential causes respective ones of the oscillators of the one or more thermodynamic chips to obtain a result of the add layer operation based on the thermodynamic data and additional thermodynamic data.

25. One or more non-transitory, computer-readable, storage media storing program instructions, that when executed on or across one or more processors, cause the one or more processors to:
initiate one or more thermodynamic chips to implement one or more components of a transformer neural network, wherein the one or more thermodynamic chips comprise oscillators;
cause the oscillators of the thermodynamic chips to thermodynamically evolve according to one or more engineered potentials, wherein the one or more engineered potentials implement the one or more components of the transformer neural network; and
cause the oscillators to be measured after evolving thermodynamically to determine inference values for a transformer neural network.
